(19) United States
(12) Patent Application Publication
(10) Pub. No.: US 2014/0189010 A1
(43) Pub. Date: Jul. 3, 2014

(54) SCRAPBOOKING

(71) Applicant: ThymeVine LLC, McLean, VA (US)

(72) Inventors: Ian Brown, Fairfax, VA (US); Robert Newgen, McLean, VA (US)

(21) Appl. No.: 14/092,000

(22) Filed: Nov. 27, 2013

Related U.S. Application Data
(63) Continuation-in-part of application No. 13/907,375, filed on May 31, 2013.
(60) Provisional application No. 61/730,189, filed on Nov. 27, 2012.
(60) Provisional application No. 61/777,161, filed on Mar. 12, 2013.

(51) Int. Cl. H04L 29/06

(52) U.S. Cl. CPC H04L 65/403
USPC 709/204

(57) ABSTRACT

A scrapbooking social network that enables a digital scrapbook to be crowd-designed by a posting device and social network user devices with which that posting device has a pre-defined relationship. A social network user device assigns a closeness rating to a plurality of user devices within that social network user devices' scrapbooking social network. The social network user device also assigns a share level to each scrapbook entry posted thereby. A social network share level assigned to a scrapbook post is based on actual content sensitivity, and permits each shared scrapbook post to be viewed/edited by other social network user devices based on their assigned closeness rating. Social network user devices with a closeness rating equal to or higher than a share level setting assigned to scrapbook entry can view/edit that scrapbook entry. Social network user devices can contribute simultaneously, or at least separately, to a scrapbook entry.

The present application claims priority from U.S. Provisional 61/730,189 filed Nov. 27, 2012, entitled “Scrapbooking”; and from U.S. Provisional 61/777,161 filed Mar. 12, 2013, entitled “Scrapbooking”; and is a continuation-in-part of U.S. application Ser. No. 13/907,375 filed May 31, 2013, entitled “Shared Level Networking”, the entirety of all of which are expressly incorporated herein by reference.

### BACKGROUND OF THE INVENTION

1. Field of the Invention

This invention relates generally to communications. More particularly, it relates to communication systems in general and messaging systems in particular, with respect to the managed sharing of data between member devices on a social network.

2. Background of Related Art

A social network is a web based platform based on a social network server(s) that is typically accessible by a web browser on a desktop computer, laptop computer, or mobile device (e.g., smartphone). Conventional social networks include, e.g., www.ancestry.com, www.facebook.com, and www.myheritage.com.

Some social networking servers allow a user device to share a post with connected members by requiring the user device to categorize other connected user accounts into predefined groups. Screen content, such as a post, photo, or other information, may then be filtered for access by the other connected member devices, based on an access designation assigned to the predefined groups.

Thus, when sharing a post with connected and non-connected member devices on a conventional social network server, sharing of information is based on a quantitative measure of the categorization of the labeled group or groups in which the other connected user is placed. The quantitative approach to the sharing of a post, photo, or other information is dependent on an access level assigned to a given user-to-group relationship. With conventional social network servers, altering a group designation for a connected user device to which a posting user might wish to include or exclude from a given post, photo, or other information also affects the active status of prior accessible shared content for that other connected user device.

### SUMMARY

In accordance with the principles of the present invention, a method of crowd-designing a digital scrapbook with social network user devices to which a posting device has a pre-defined relationship, comprises accepting a closeness rating assigned via the posting device for each of a plurality of social network user devices, accepting a scrapbook post and an assigned share level setting from the posting device, and permitting only those social network user devices assigned a closeness rating at or above the share level setting assigned to the scrapbook post, to view and/or edit that scrapbook post. In accordance with the principles of the present invention, a share level setting is assigned to a scrapbook post based on the sensitivity of content embedded in the post.

In accordance with the principles of the present invention, multiple logged in social network user devices can contribute simultaneously, or at least separately, to a scrapbook entry.

In accordance with the principles of the present invention, a method of sharing a digital scrapbook post with social network user devices to which a posting device has a pre-defined relationship, comprises accepting a closeness rating assigned via the posting device for each of a plurality of social network user devices, accepting a scrapbook post and an assigned share level setting from the posting device, and sharing the scrapbook post with only those social network user devices assigned a closeness rating at or above the share level setting assigned to the scrapbook post.

In accordance with the principles of the present invention, a method of sharing a digital scrapbook with social network user devices to which a posting device has a pre-defined relationship, comprises accepting one or more share groups, comprised of social network user devices from a posting device, accepting a scrapbook post and an assigned share group from the posting device, and sharing the scrapbook post with only those social network user devices defined in the share group. In accordance with the principles of the present invention, a posting device can edit a share group to alter a set of social network user devices permitted to view and/or access a digital scrapbook, while still maintaining an active status of prior viewable content to all social network user devices still defined in that group.

### BRIEF DESCRIPTION OF THE DRAWINGS

Features and advantages of the present invention will become apparent to those skilled in the art from the following description with reference to the drawings, in which:

FIGS. 1 and 1A to 1F show an entity relationship diagram for the architectural structure of an exemplary embodiment of a social network share level network system, in accordance with the principles of the present invention.

FIG. 2 shows exemplary levels of social network share level in a social network share level network in accordance with the principles of the present invention.

FIG. 3 shows an exemplary user device interface for establishing a social network share level via a closeness-in-relationship rating, in accordance with the principles of the present invention.

FIG. 4 shows an exemplary user device interface to set a social network share level when connecting, in accordance with the principles of the present invention.

FIG. 5 shows an exemplary user device interface to establish a social network share level for an established relationship between two networked entities, in accordance with the principles of the present invention.

FIG. 6 shows an exemplary user device interface to display and permit management of a social network share level for networked entities with which a user has a relationship, in accordance with the principles of the present invention.

FIG. 7 shows an exemplary user device interface for displaying an exemplary updated layout of setting social network share level, in accordance with the principles of the present invention.

FIG. 8 shows an exemplary user device interface for establishing a social network share level in an application for posting on a given shared server, in accordance with the principles of the present invention.

FIG. 9 shows an exemplary user device interface for establishing a social network share level of a posting to a common group of shared networked entities, in accordance with the principles of the present invention.

FIGS. 10A to 10E show a grab images, or grab it, feature of shared networking, in accordance with the principles of the present invention.

FIGS. 11A and 11A-1 to 11A-4, 11B and 11B-1 to 11B-4 show the architectural structure of an exemplary embodiment of a scrapbook networking feature, in accordance with the principles of the present invention.

FIGS. 11C and 11C1 to 11C6 show the architectural structure of another exemplary embodiment of a scrapbook networking feature, in accordance with the principles of the present invention.

FIG. 12 depicts an exemplary graphical user interface for a scrapbook cover title entry feature of scrapbooking, in accordance with the principles of the present invention.

FIG. 13 depicts an exemplary graphical user interface for a scrapbook background customization feature of scrapbooking, in accordance with the principles of the present invention.

FIG. 14 depicts an exemplary scrapbook cover page, in accordance with the principles of the present invention.

FIG. 15 depicts an exemplary graphical user interface for an edit toolbar for scrapbooking, in accordance with the principles of the present invention.

FIG. 16 depicts an exemplary graphical user interface for a cover title modification feature of scrapbooking, in accordance with the principles of the present invention.

FIG. 17 depicts an exemplary graphical interface for an add a page feature of scrapbooking, in accordance with the principles of the present invention.

FIG. 18 depicts an exemplary graphical interface for an add a note feature of scrapbooking, in accordance with the principles of the present invention.

FIG. 19 depicts an exemplary note on a scrapbook page, in accordance with the principles of the present invention.

FIG. 20 depicts an exemplary graphical user interface for an add text feature of scrapbooking, in accordance with the principles of the present invention.

FIG. 21 depicts exemplary text on a scrapbook page, in accordance with the principles of the present invention.

FIG. 22 depicts an exemplary graphical user interface for a change theme feature of a scrapbooking, in accordance with the principles of the present invention.

FIG. 23 depicts an exemplary border applied to a page of a scrapbook, in accordance with the principles of the present invention.

FIGS. 24A to 24C depict an exemplary color applied to an entire scrapbook, in accordance with the principles of the present invention.

FIG. 25 depicts an exemplary graphical user interface for a deleting page of scrapbooking, in accordance with the principles of the present invention.

FIG. 26 depicts an exemplary graphical user interface for a customization toolbox for scrapbooking, in accordance with the principles of the present invention.

FIG. 27 depicts an exemplary graphical user interface for an add a gallery image feature of scrapbooking, in accordance with the principles of the present invention.

FIGS. 28A and 28B depict an exemplary graphical user interface for an add a storythyme entry feature of scrapbooking, in accordance with the principles of the present invention.

FIGS. 29A and 29B depict an exemplary graphical user interface for an add a calendar icon feature of scrapbooking, in accordance with the principles of the present invention.

FIG. 30 depicts an exemplary graphical user interface for an add a vault image feature of scrapbooking, in accordance with the principles of the present invention.

FIG. 31 depicts an exemplary graphical user interface for an add a clipart image feature of scrapbooking, in accordance with the principles of the present invention.

FIG. 32 depicts an exemplary graphical interface for an item edit toolbar, in accordance with the principles of the present invention.

FIG. 33 depicts an exemplary graphical user interface for a preview and arrange feature of scrapbooking, in accordance with the principles of the present invention.

FIG. 34 depicts an exemplary auto-save message displayed on a scrapbook user device interface, in accordance with the principles of the present invention.

FIG. 35 depicts an exemplary graphical user interface for an assign a share level setting feature of scrapbooking, in accordance with the principles of the present invention.

FIG. 36 shows an exemplary graphical user interface for an add a description feature for scrapbooking, in accordance with the principles of the present invention.

FIG. 37 shows an exemplary graphical user interface for a view full post feature of scrapbooking, in accordance with the principles of the present invention.

### DETAILED DESCRIPTION OF ILLUSTRATIVE EMBODIMENTS

The present inventors have realized that conventional social network servers do not qualitatively address the value of privacy and sensitivity associated with content embedded in a shared post, photo, or other information. In accordance with conventional technology, a social network user device can share a post with multiple groups of users (and an individual user can be associated with multiple user groups simultaneously) by assigning an appropriate access designation to the post. A social network user device can also change an access designation assigned to a post to alter a set of social network user devices permitted to view that post. Unfortunately, conventional social network servers do not have the capability to enable social network user devices to alter a group access designation assigned to a post, and still maintain an active status of prior viewable content for only specific social network user devices defined in the group. Currently, there is no social network server that enables a post, photo, or other information, to be shared based on the qualitative measure of content embedded in the post. Rather, conventional social network servers share user content based on a categorization of an audience group permitted to view or otherwise access a post, photo, etc., uploaded by a social network user device.

In accordance with the principles of the present invention, a qualitative measure of privacy is defined for a post, photo, etc., vis-a-vis each other social network user to which a poster has a defined relationship. This qualitative measure of privacy enables connected social network user devices to view shared content, regardless of a change to a quantitative measure used to categorize a connected social network user device's status, such as being designated as a member of a given group that might not otherwise conventionally have access to that post, photo, etc. In accordance with the present invention, a qualitative measure is independent of any quantitative measure.

The present invention provides a qualitative “social network share level” for each post, photo, etc., uploaded by a given social network user device. The social network share level is based on actual content sensitivity, and permits each shared post, photo, or other information to be viewed by other social network user devices based on a social network share level, or “closeness rating” assigned to each device. A closeness rating assigned to a social network user device is inclusive and based on a social network share level set by the poster when making a post, photo, or other information. The social network share level establishes individually which connected social network user device(s) to which the poster has an established relationship may have access to the shared post, photo, information, etc.

The disclosed embodiments of social network sharing are based on a social network server built with a LAMP infrastructure (Linux, Apache, MySQL, and PHP) utilizing YII framework. The communication and sharing level, in accordance with the present invention, is an interactive electronic solution that emulates real life social communication, via digital devices, e.g., laptop computers, smartphones, etc. The interactive electronic solution enables the sharing of data, photos, links, and/or other information between established and pre-defined social network user devices, grouped as a family, work group, or other social unit. The disclosed social network server, referred to herein as ThymeVine™, infuses the sharing of data, photos, links, or other information, with a fully flexible and individual social network share level, that provides a sharing social network user device with the ability to fully customize access to their content. By using a social network share level, a social network user device can apply full sensitivity to the privacy of each post, photo, etc., uploaded thereby.

In accordance with the principles of the present invention, a social network share level is a measure applied to each and every post, photo, or other information posted by a social network user device. A social network share level assigned to a post, photo, or other information enables a social network server to determine which other social network user devices are permitted to view that post, photo, or other information. In particular, a social network share level is a qualitative measure that is used to rate the sensitivity and privacy of the content of a post. A social network share level is different from a conventional quantitative measure assigned to a post based on the designated access level of a group to which other social network user devices belong.

The inventive social network share level is applied over two areas to achieve a proper qualitative versus quantitative effect. In particular, a social network share level is first applied as a designation of a closeness rating between two connected (i.e., associated) social network user devices. A closeness rating defined between two connected social network user devices can preferably be changed at any given time.

It is important to note that the designation of a social network share level between two associated social network user devices, vis-a-vis one another, not be disclosed to one another social network user devices. When a social network user device uses a social network share level to share a post over Thymevine™, the social network share level is used to determine which social network members are permitted to view that post.

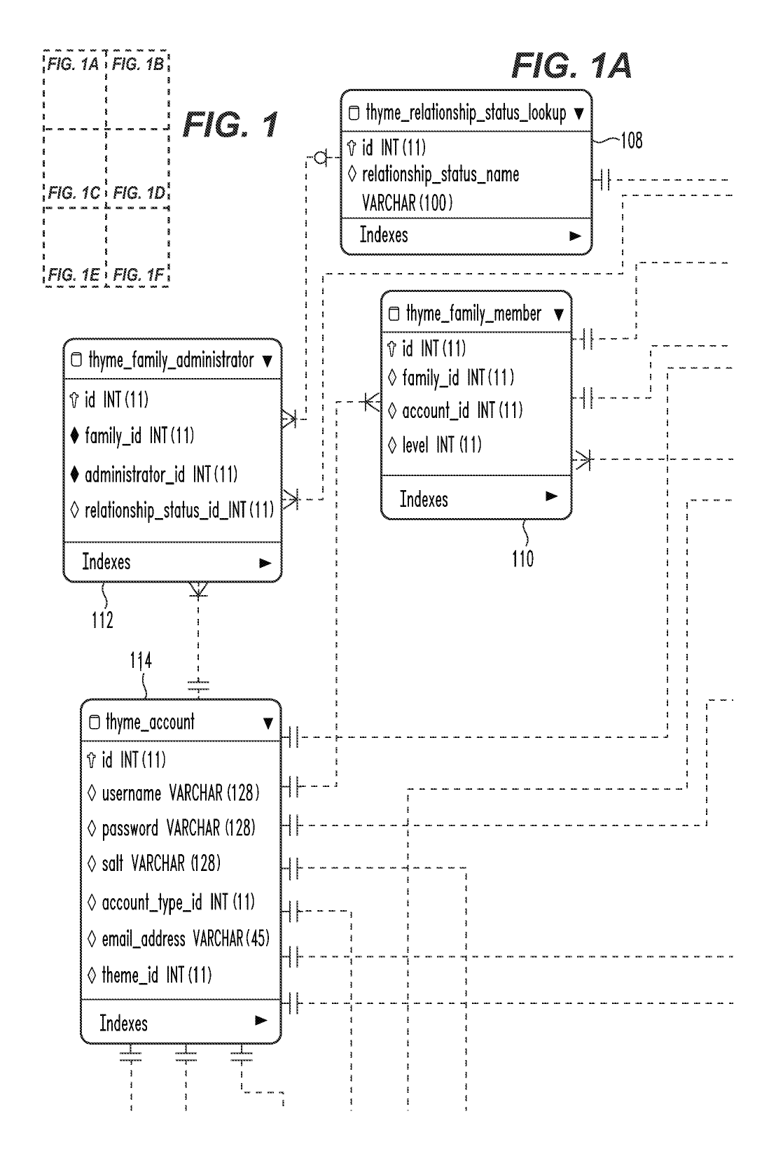

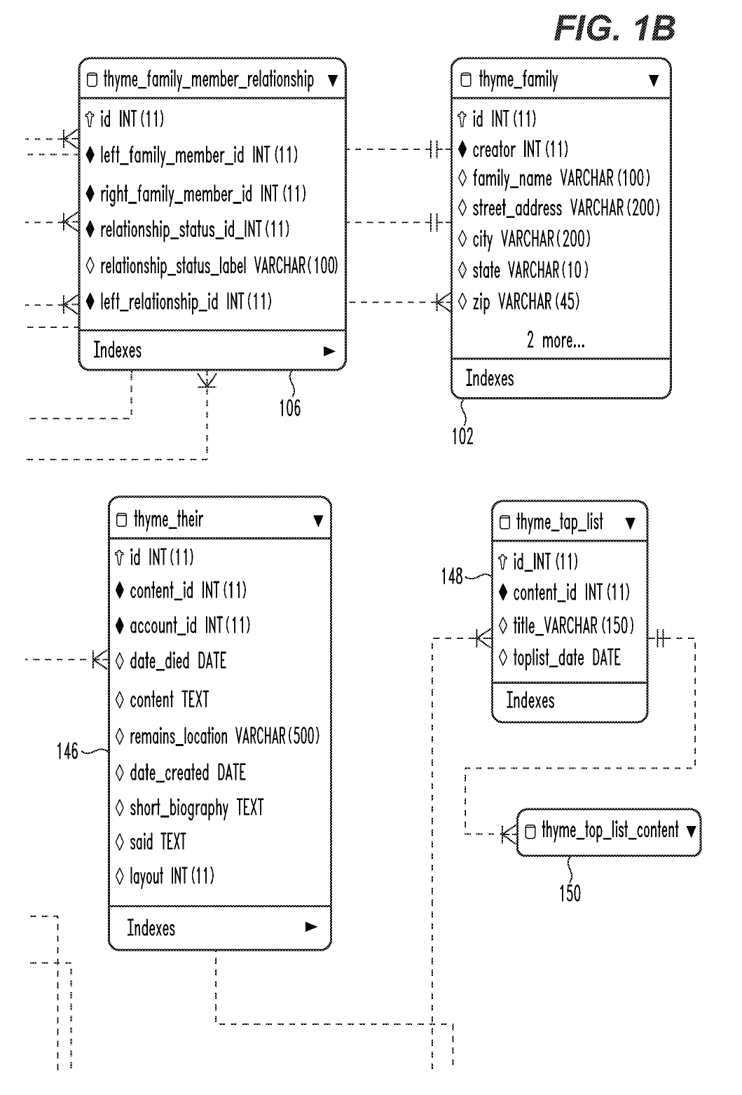

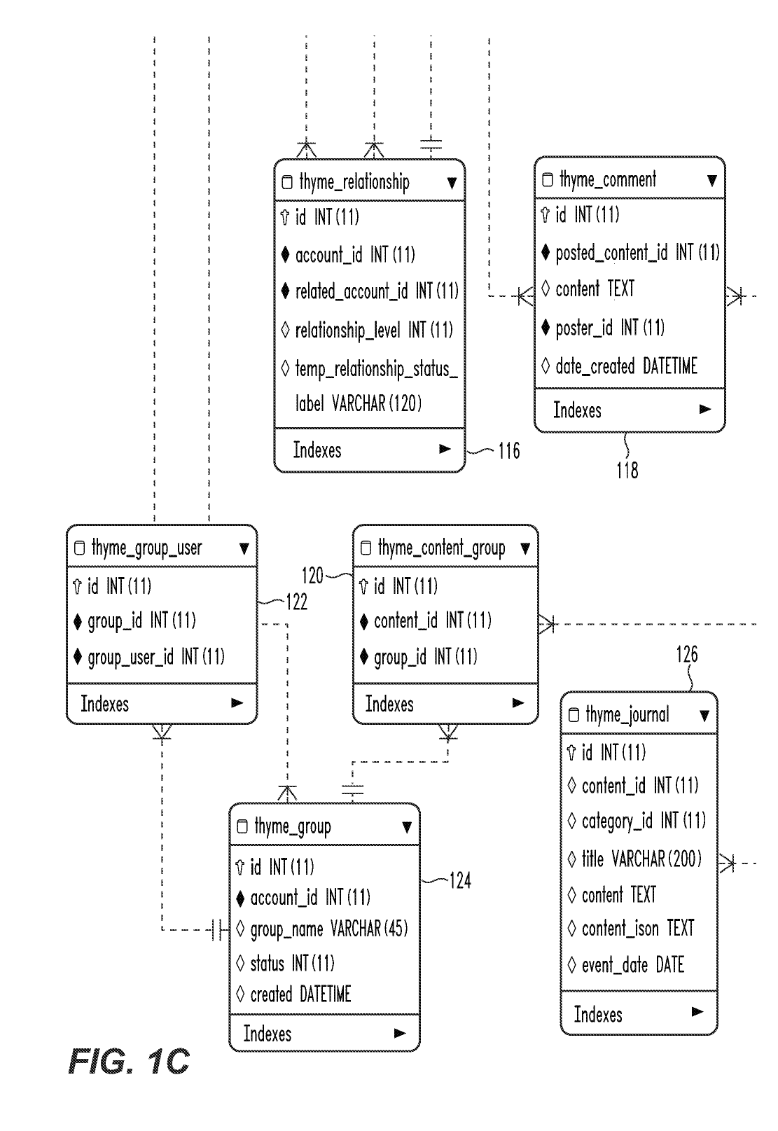

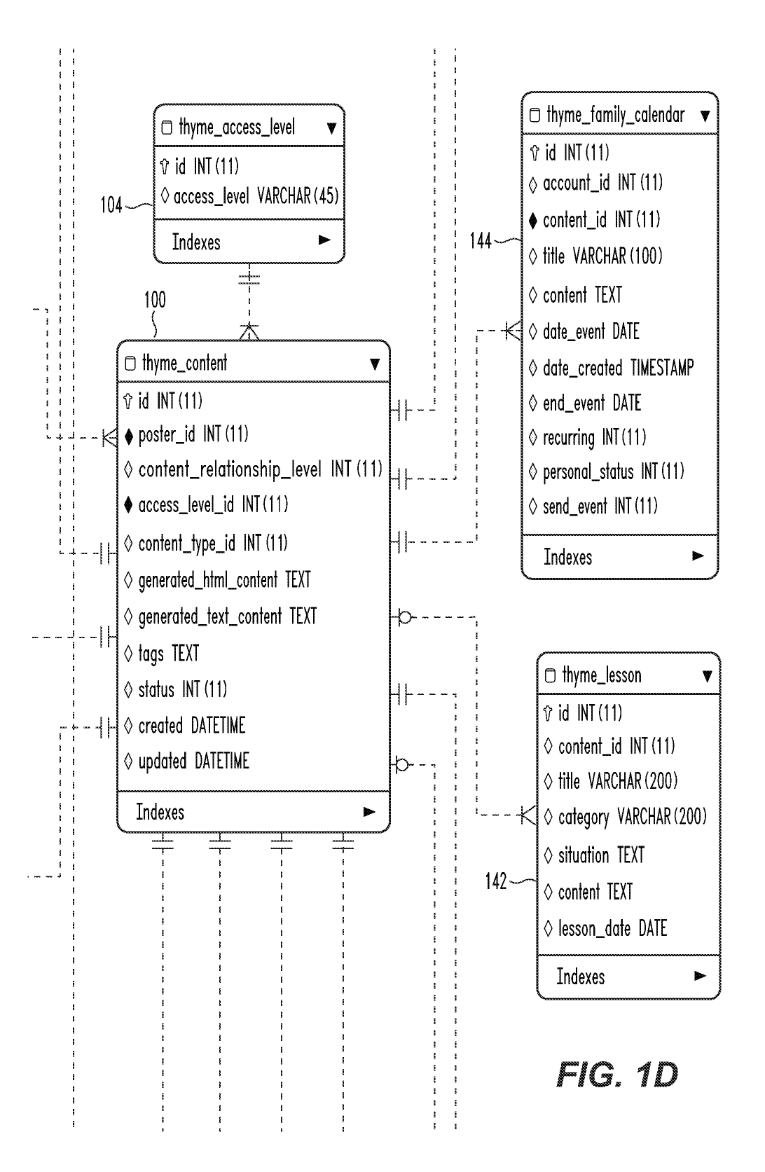

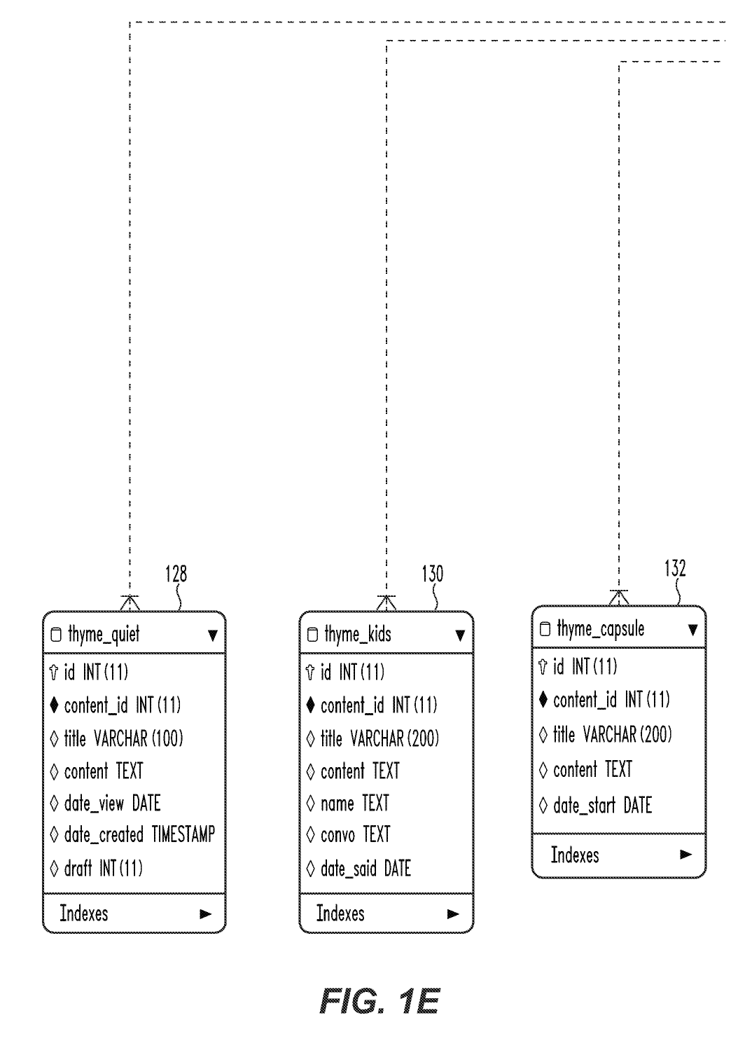

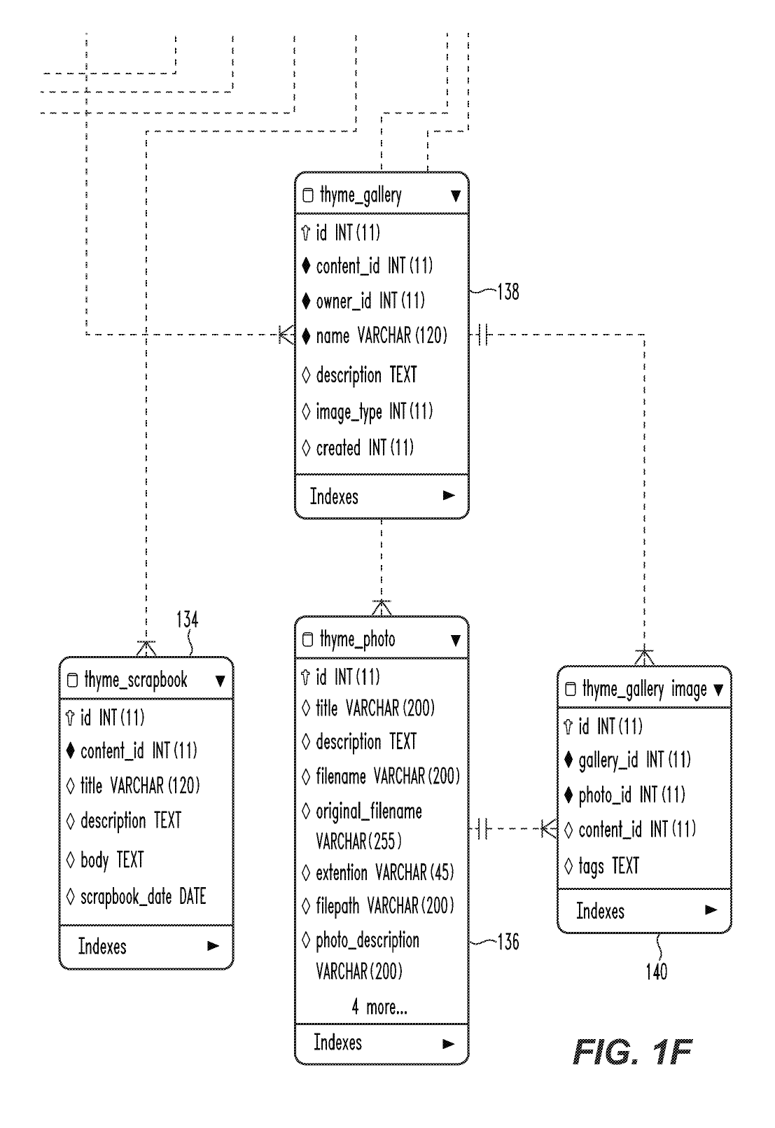

FIGS. 1A to 1F show an entity relationship diagram for the architectural structure of an exemplary embodiment of a social network share level network system, in accordance with the principles of the present invention.

In particular, as shown in FIGS. 1A to 1F, a social network share level is established in a network of devices, such as in a social network with various architectural modules. FIGS. 1A to 1F depict aspects of the invention affected within each module.

Exemplary modules depicted in FIGS. 1A to 1F include thyme_content 100, thyme_access_level 104, thyme_family 102, thyme_family_member_relationship 106, thyme_comment 118, thyme_group 124, thyme_group_user 122, thyme_content_group 120, thyme_relationship 116, thyme_account 114, thyme_family_member 110, thyme_family_administrator 112, thyme_relationship_status_lookup 108, thyme_journal 126, thyme_gallery 138, thyme_top_list, thyme_top_list_content 150, thyme_their 146, thyme_family_calendar 144, thyme_lesson 142, thyme_gallery_image 140, thyme_gallery 138, thyme_photo 136, thyme_scrapbook 134, thyme_capsule 132, thyme_kids 130, and thyme_quiet 128.

In particular, the thyme account 114 module holds all ThymeVine™ accounts either active or inactive. Almost all modules depicted in FIGS. 1A to 1F are associated with this module—all transactions in ThymeVine™ proceed with this table. An account can be created in the ThymeVine™ system via any of the following scenarios: account registered, account added from family tree, account created through invitation. A user must activate an account created through family tree or invitation, via an email notification sent to their personal email account (else the account remains inactive).

Thyme_family_administrator 112 is a module that holds all family administrator accounts, categorized by family, i.e., by thyme_family 102.

Thyme_family 102 is a module that holds all family member information created under ThymeVine™. The thyme_family table also includes street address, city, state, zip and country information associated with a family. As depicted in FIGS. 1A to 1F, a family creator linked to an account, has full control over that account. A family creator does not have to be a family administrator.

Thyme_family_member 110 is a module responsible for gathering family member accounts and showing how family member accounts are related to one another. A link to a thyme_family_member_relationship 106 module may vary. Family members are linked via different levels of relationship, which ultimately define the closeness rating defined between those members.

Thyme_relationship 116 is a module that specifies a relationship between two accounts. If an account is added to a family tree, a vine is connected, or a member is invited to join a family, a relationship is added to this table.

Thyme_family_member_relationship 106 is a module that specifies relationships held between family members in a family account. Left family member and right family member identifiers describe which side of a family a member is associated with. Left and right family member identifiers are useful when creating a family tree.

Thyme_group 124 is a module that holds share groups created by an account. Share groups are useful for post sharing and group messaging.

Thyme_group_user 122 is a module that maintains a list of accounts belonging to a particular share group.

Thyme_content 100 is a module that maintains posts from different modules of the ThymeVine™ social network server. For instance, the thyme_content module 100 contains general information associated with a post, e.g., tags, poster identification information, a social network share level (most important), etc. (posts are shared based on a relationship of accounts defined in the thyme_relationship 116 module). For instance, if a post is shared to a particular share group, that group is listed under thyme_content_group 120 in the thyme_content module 100, along with a relevant content identifier (i.e. a post ID). In a preferable embodiment, content is not fully deleted from the thyme_content module 100, but rather simply flagged as deleted or archived under a relevant content status. Generally, everything under wall activities is maintained in the thyme_content module 100.

Thyme_comment 118 is a module that holds comments of a post and also a poster. In particular, a user device can comment on a post if they have access to that post's content, or are part of the social network share level assigned to the post.

Modules under a system linked to the thyme_content 100 module include: thyme_journal 126, thyme_top_list 148, thyme_kids 130, thyme_quiet 128, thyme_capsule 132, thyme_gallery 138, thyme_lesson 142, thyme_family_calendar 144, thyme_their 146, and thyme_scrapbook 134.

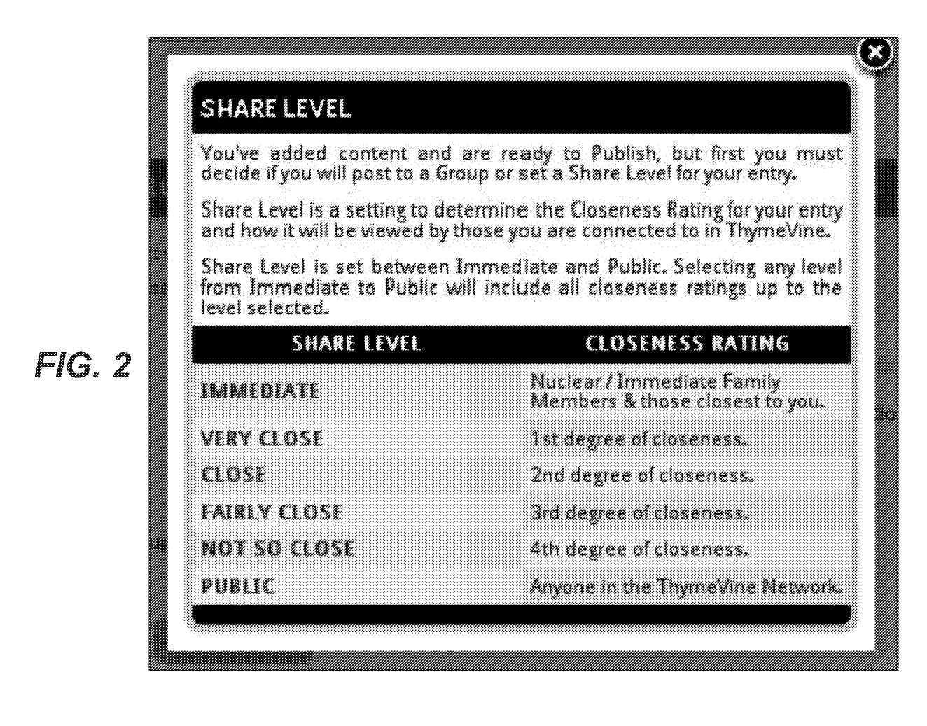

FIG. 2 shows exemplary social network share levels available in a social network share level network, in accordance with the principles of the present invention.

In particular, as shown in FIG. 2, a social network share level designates a qualitative level of closeness (e.g., a range from “Immediate” all the way to “Public”) for a particular post, photo, etc. Exemplary social network share levels include, but are not limited to, “Immediate”, “Very Close”, “Close”, “Fairly Close”, “Not So Close”, and “Public”. These exemplary social network share levels represent six (6) degrees of closeness that may be applied subjectively by a social network user device to a post, photo, etc., and to social network member devices (or even non-member devices) to which the social network user device is connected or otherwise associated with.

The range of social network share levels in the disclosed embodiments of the ThymeVine™ social network server is limited (e.g. from “Immediate” to “Not So Close”), though additional social network share levels may be implemented within the principles of the present invention.

A social network share level in a social network share level network, in accordance with the principles of the present invention, includes a significant number of levels of closeness, with which to define a relationship between two user social network user devices in a social network. Alternatively, or additionally, levels of closeness may be used to define a relationship between a given social network user and a pre-established group of social network users, as identified on their respective user devices.

In accordance with the principles of the present invention, a social network user device uses a social network share level to define a closeness rating for an entry or post uploaded onto the ThymeVine™ social network server. A social network share level assigned to a post determines how that post will be viewed by other social network user devices to which the posting social network user device is connected (i.e., associated with) in the ThymeVine™ social network server.

A social network user device may establish a share level of closeness for other social network user devices within the ThymeVine™ social network, particularly those social network user devices with which that social network user device has an established relationship. Once content is added to a social network user's ThymeVine™ presence, that user is ready to share (i.e. publish). In accordance with the principles of the present invention, a post may be shared to a particular group of members, or a social network share level may be assigned to the post. A social network share level assigned to a post (i.e., a photo, link, or other content) may be set between “Immediate” (being the most private setting) and “Public” (being the least private setting). In accordance with the principles of the present invention, a plurality of closeness levels are defined between the most private share setting and the least private share setting. In the given embodiments, four levels of closeness are defined between the most private share setting and the least private share setting (for a total of six share settings). It is within the principles of the invention to include more share level setting between the most private share level setting and the least private share level setting. Even a virtually infinite number of social network share levels or settings may be implemented (e.g., visually presented to the user as if the closeness setting may be anywhere along an analog sliding bar) for selection of a closeness rating as a fractional value anywhere between the most private setting (e.g., “Immediate”) and the least private setting (e.g., “Public”).

The “Immediate” social network share level setting preferably includes a social network user's nuclear members, members of the given social network user's immediate family, and social network members that are closest to the given social network user.

The “Very Close” social network share level may be defined as a 1^{st} degree of closeness share level setting.

The “Close” social network share level may be defined as a 2^{nd} degree of closeness share level setting.

The “Fairly Close” social network share level may be defined as a 3^{rd} degree of closeness share level setting.

The “Not So Close” social network share level may be defined as a 4^{th} degree of closeness share level setting.

The “Public” social network share level includes anyone in the network, e.g., anyone in the ThymeVine™ social network.

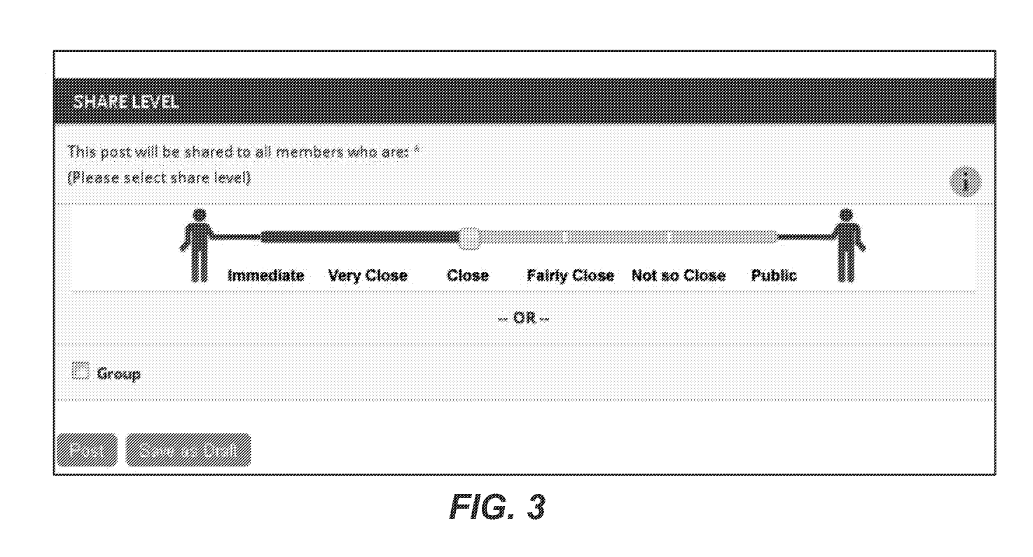

FIG. 3 shows an exemplary social network user device interface for establishing a social network share level via a closeness-in-relationship rating, in accordance with the principles of the present invention.

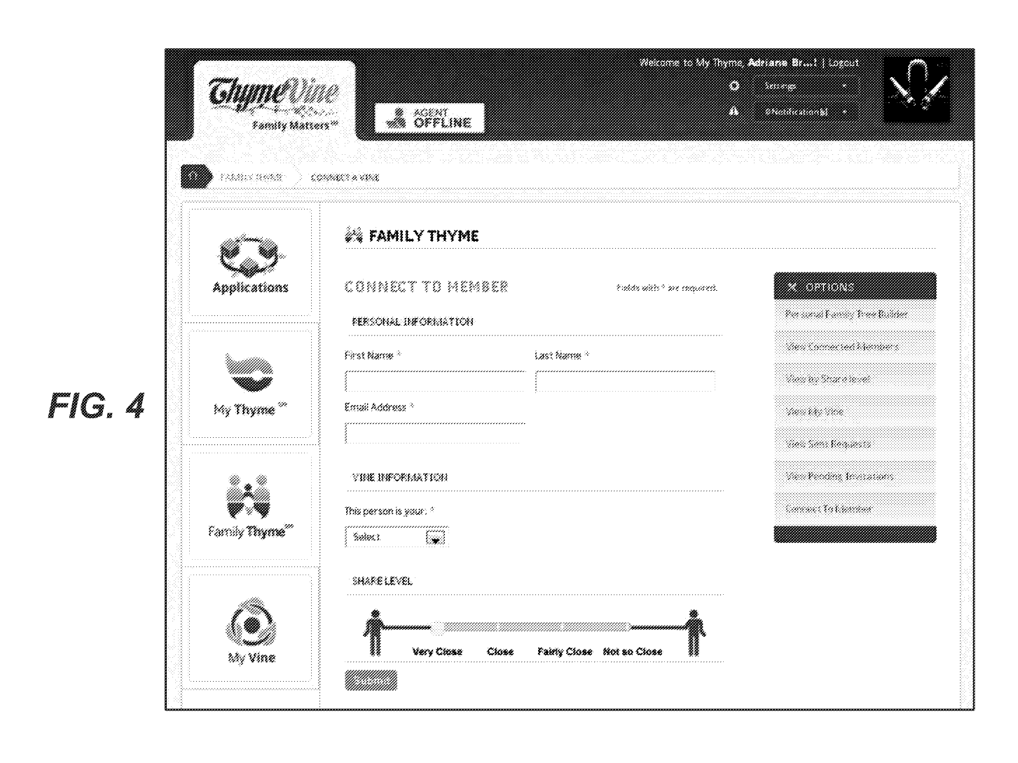

FIG. 4 shows an exemplary social network user device interface for setting a social network share level when connecting, in accordance with the principles of the present invention.

In particular, as shown in FIG. 4, a social network share level may be set when connecting (associating) or accepting a connection (association) to another social network member device in the ThymeVine™ social network server. Rules and conditions are preferably used to maintain integrity and communication between social network member devices.

A given user on a social network user device may connect to another social network user on the ThymeVine™ social network by inputting personal information about the other social network user with which they want to establish a relationship into a search field on the user device interface. For example, entry of a first and last name and/or email address may be sufficient to seed a successful search for a social network identity of a desired social network user. A social network identity may also/alternatively be searched by relationship, e.g., family, parent, friend, relative, colleague, schoolmate, etc. Once a social network identity is found, the social network user defines a closeness rating for that social network user, e.g., a social network share level anywhere from a most private setting (e.g., “Immediate”) to a least private setting (e.g., “Public”), to enable certain posts, photos, etc., uploaded by the social network user to be accessed by that social network user device following connection.

In the disclosed embodiment, a social network share level is chosen using a visual sliding bar that may be set to any of a predetermined number of closeness levels (e.g., six in the given embodiments, though a virtually infinite number of positions corresponding to fractional closeness settings may be established between the most private and least private settings.)

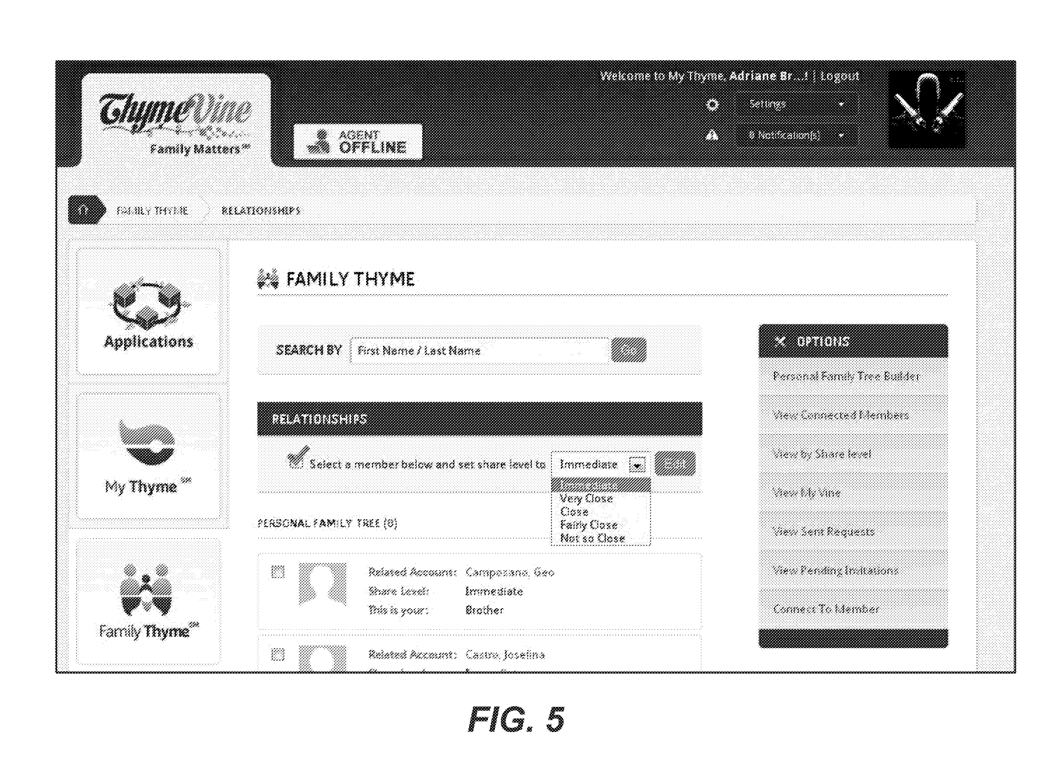

FIG. 5 shows an exemplary social network user device interface for establishing a social network share level between two network entities with an established relationship, in accordance with the principles of the present invention.

The range of social network share levels that may be set between two ThymeVine™ social network members, when neither member is a Family Administrator of the other is: “Very Close” to “Not So Close”. The “Immediate” social network share level is under the control of a Family Administrator. In particular, when a Family Administrator adds a social network member to a group defined as “Family”, a default social network share level of “Immediate” is set between that new group member and all other members in the group.

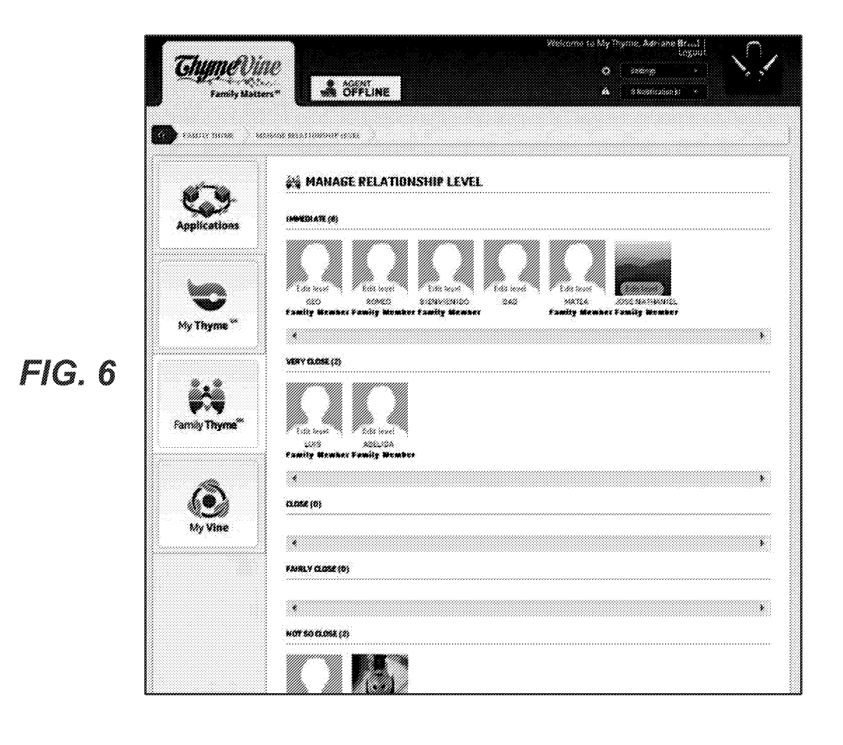

FIG. 6 shows an exemplary social network user device interface to display and permit management of a social network share level for networked entities with which a social network user has a relationship, in accordance with the principles of the present invention.

In given embodiments, social network members that connect to each other outside of the Family Administrator to Family group, and yet wish to establish a social network share level of “Immediate”, must first connect with a lower social network share level and, after successful connection, change their social network share level from that of the lower social network share level to “Immediate”. The Family Administrator social network user device is provided the authority to override any social network share level connections set to Immediate by a social network user in that Family Administrator's Family group.

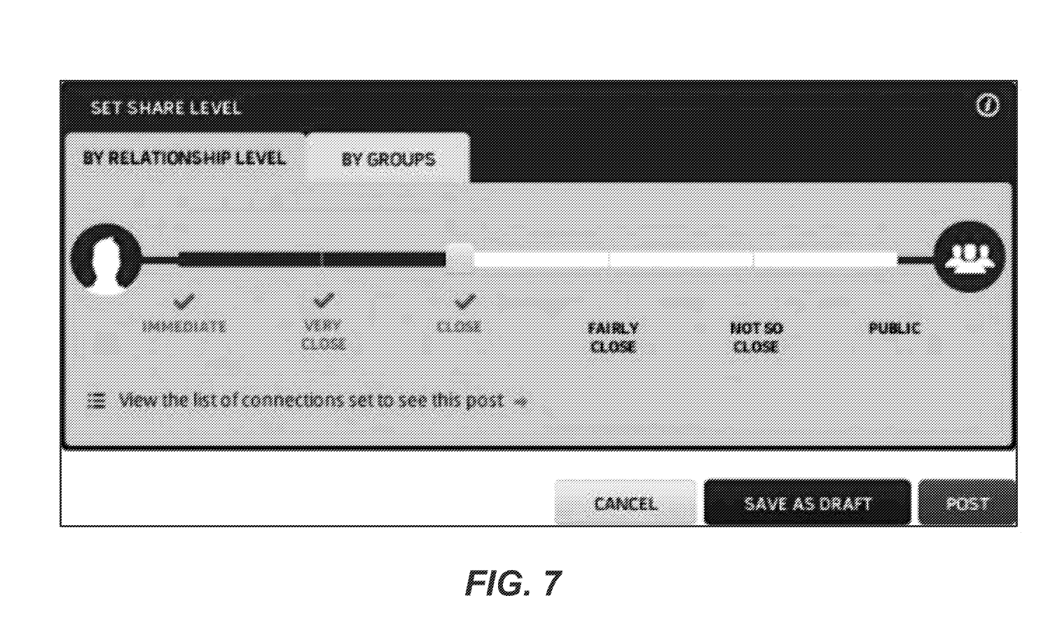

FIG. 7 shows an exemplary social network user device interface for displaying an exemplary updated layout of setting social network share level, in accordance with the principles of the present invention.

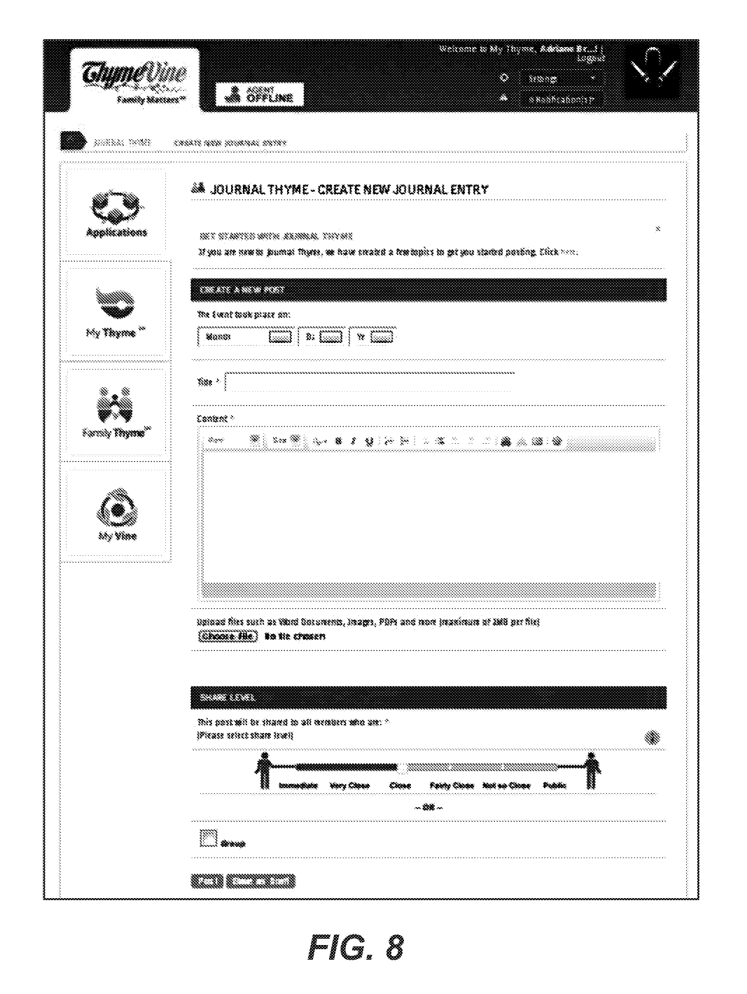

FIG. 8 shows an exemplary social network user device interface for establishing a social network share level in an application for posting on a given shared server, in accordance with the principles of the present invention.

Social network share level set as a Posting rule for the content in an Entry is an inclusive measure to include all higher levels of closeness from the selected level. For example, if a social network user device assigns social network share level, “Close”, to a post, then all connected (e.g., associated) social network user devices with social network share level(s) equal to or higher than “Close” (e.g., “Close”, “Very Close” and “Immediate”) can view or otherwise access the posting (or photo or other information by the posting social network user device.)

The inclusive use of a social network share level maintains the qualitative nature of the social network share level, versus the quantitative nature of the use of a group setting, as in conventional social networks. In the inventive scenario, a group can include connected members of different social network share level settings. For example, a group called “Group Reunion” can include all connected social network members with a relationship status of “Cousin” (with respect to the posting social network user), and each cousin in the group can have different or similar social network share level settings.

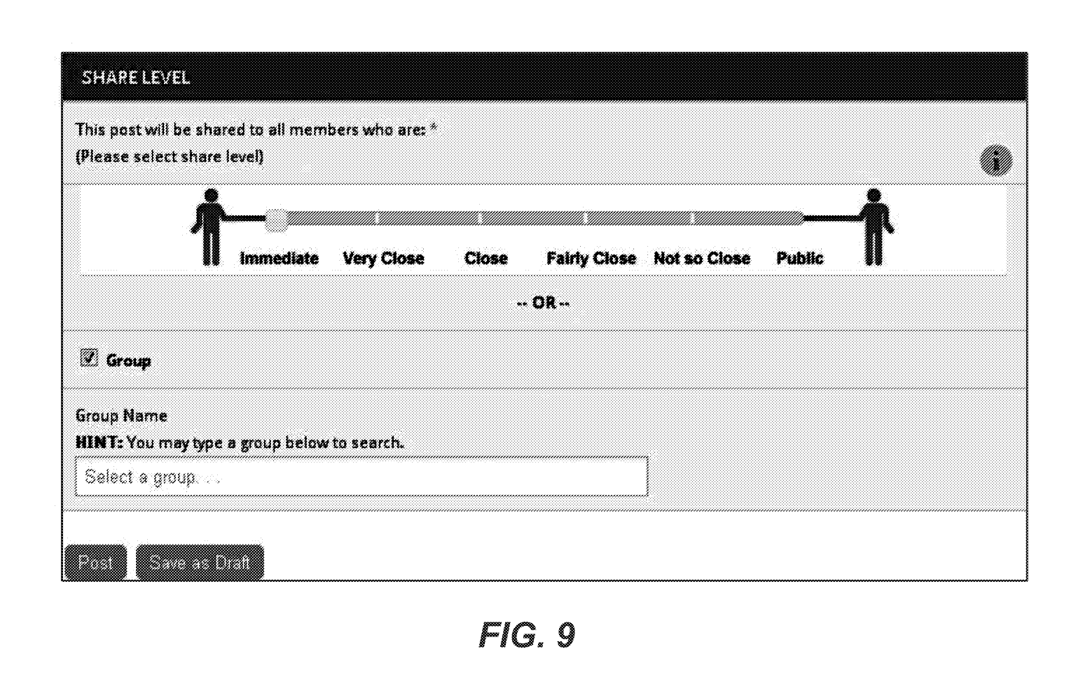

FIG. 9 shows an exemplary user device interface for establishing a social network share level of a posting to a common group of shared networked entities, in accordance with the principles of the present invention.

Members of the ThymeVine™ social network cannot see a social network share level setting that a connected social network member has set for them. However, a Family Administrator can see relationship status settings, connection requests, and acceptances between “Family” group members and members outside the “Family” group, but family group members cannot see social network share level settings between “Family” group members and anyone they are connected to on the ThymeVine™ social network, including the Family Administrator.

Below is an exemplary network implementation of share level networking, in accordance with the principles of the present invention.

### Registration (Create a Family Account)

Step1. Account Information (PLANT A VINE). Fill out all the required fields indicated with an asterisk “*”. Enter Username (*). Username should be unique and not registered by another user. Special characters are not allowed (e.g. “!”, “@”, “,”, “ ”, “:”) Enter Password (*). Minimum is 8 characters. Special characters are not allowed (e.g. “!”, “@”, “,”, “ ”, “:”). Re-Type Password (*). Re-typed password must match the first one. Minimum is 8 characters. Special characters are not allowed (e.g. “!”, “@”, “,”, “ ”, “:”). Enter Email-address (*). Email Address that was already used to register with this website is not allowed. Re-Type E-mail Address. Re-typed Email Address must match the first one. The “Clear” button clears all fields. When the form is completed, select the “Next” button to proceed on to Step 2.

Step2. Misc Information (PLANT A VINE). Fill out all the required fields indicated with an asterisk “*”. Enter First Name (*), Middle name is optional, Enter Last Name (*), Nickname is optional. Select Gender (*), should be chosen from the two given options. The option “Please select” is selected by default so as to force a user to select one. Date of Birth field is entered in the following order: (Format: Month/Day/Year e.g.: March/16/1992) (*). Month (January to December), 2 Digits for the Day, 4 Digits for the Year. Select Country (*). If a user lives in the United States the default country is “STATE”. Street Address optional, City optional, State optional, Zip Code optional, Phone Number optional, Mobile Number optional. The “Clear” button clears all fields. The “Back” button redirects to the previous page (Step 1).

Step3. Billing Information (PLANT A VINE). Check: Start a 30 day trial. User can invite up to five verified ThymeVine™ users to be part of a Personal Family Tree. Preferably a user can create and update posts for the user and other members of the user's Personal Family Tree. Valid credit card is required to start the free 30 day trial. Uncheck: to skip Start 30 day trial.

### Login

Click and Type Username. Click and Type Password. Click “Login button to redirect to the ThymeVine™ main page. Forgot Username/Password functionality is preferably included. A user may enter an email used to create a ThymeVine™ account into a Forgot Username/Password field, click a “Retrieve Username/Password” button, and check a Thyme Vine Password Recovery tab sent to them in an email to recover their username and password.

### Settings

Settings include: Modify your account, Update subscription info, Hide or Show markers, and Logout. The table below depicts an exemplary user-accessible account setting.

| BUTTONS/ | |
|---|---|
| HYPERLINKS | FUNCTION |
| Save | Save and apply changes to account information. |

### Steps to Update Account Settings

On home page, at top right of the page, hover the pointer on a Settings tab. A list of settings options appears. Click Account Settings. The page redirects to user account information. Filling out fields to be changed. Required fields must be filled out. After filling out fields, click Save. A prompt message displays text: “Account Successfully Updated”.

### Profile Picture

| BUTTONS/ | |
|---|---|
| HYPERLINKS | FUNCTION |
| Save | Save and apply changes. |
| Choose file | Browse files on a computer for uploading. |
| Gallery | Browse pictures in ThymeVine ™ Gallery. |

Steps to Change Profile Picture (from My Computer):

On account settings, click profile picture tab. From the drop down list choose, from my computer, to choose a picture from a computer file. Click choose file. Select desired profile picture. The file name of the selected image is displayed beside the button. Click Save. A prompt message displays text: “Profile Picture Successfully Updated”.

### Steps to Change Profile Picture (My Gallery):

On account settings, click profile picture tab. From the drop down list choose, My Gallery, to choose a picture from the ThymeVine™ Gallery. Click Gallery. A window appears to let user browse pictures. Select desired profile picture. The link of the selected image is displayed on the field. Click Save. A prompt message displays text: “Profile Picture Successfully Updated”.

### Profile Info

| BUTTONS/ | |
|---|---|
| HYPERLINKS | FUNCTION |
| Save | Save and apply changes to account information. |
| Choose file | Browse files on your desktop for uploading. |

### Steps to Update Profile Info:

On account settings, click a profile info tab. The page redirects to a page with profile information. Start filling out fields to be changed. Required fields must be filled out. To upload documents or files, click choose file. A window for browsing files appears. To delete uploaded files, mark the box beside the filename. Click save. A prompt message displays text: “Your Profile was Successfully Updated”.

### Education and Work

| BUTTONS/ | |
|---|---|
| HYPERLINKS | FUNCTION |
| Save | Save and apply changes to account information. |
| +Add Entry | Add an entry to information. |
| −Cancel | Remove entry. |
| Edit | Edit entered information. |
| Update | Apply changes made. |
| Delete | Delete entry. |
| Cancel | Cancel editing. |

### Steps to Add Education and Work:

On account settings, click education & work tab. The page redirects to a page with profile information. To add additional information, click +Add Entry. Start filling out fields. Required fields must be filled out. Click Save. A prompt message displays text: “Your Profile was Successfully Updated”.

### Steps to Update Education and Work:

Click edit an entry to be updated. Fill out fields to be changed. Required fields must be filled out. Click Update. A prompt message displays text: “Your Profile was Successfully Updated”.

### Steps to Update Education and Work (Delete):

Click edit an entry to be updated. A prompt message appears. Click OK. A prompt message displays text: “Your Profile was Successfully Updated”.

### Philosophy

| BUTTONS/ | |
|---|---|
| HYPERLINKS | FUNCTION |
| Update | Save and apply changes to account information. |

### Steps to Update Philosophy:

On account settings, click philosophy tab. The page redirects to a page with profile information. Start filling out fields. Required fields must be filled out. Click update. A prompt message displays text: “Your Profile was Successfully Updated”.

### Favorites

| BUTTONS/ | |
|---|---|
| HYPERLINKS | FUNCTION |
| +Add Entry | Add an entry to information. |
| Update | Apply changes made. |
| Delete Marked | Delete entry. |

### Steps to Update Favorites:

On account settings, click favorites tab. The page redirects to a page with profile information. To add additional information, click +Add Entry. Start filling out fields. Required fields must be filled out. Click Update. A prompt message displays text: “Your Profile was Successfully Updated”.

### Steps to Update Favorites(Delete Marked):

Mark the box of an entry to be deleted. Click delete marked. A prompt message displays text: “Your Profile was Successfully Updated”.

### Sports

| BUTTONS/ | |
|---|---|
| HYPERLINKS | FUNCTION |
| +Add Entry | Add an entry to information. |
| Update | Apply changes made. |
| Delete Marked | Delete entry. |

### Steps to Update Sports:

On account settings, click sports tab. The page redirects to a page with profile information. To add additional information, click +Add Entry. Start filling out fields. Required fields must be filled out. Click update. A prompt message displays text: “Your Profile was Successfully Updated”.

### Steps to Update Sports (Delete Marked):

Mark the box of an entry to be deleted. Click delete marked. Click OK. A prompt message displays text: “Your Profile was Successfully Updated”.

### Subscription Info

| BUTTONS/ | |
|---|---|
| HYPERLINKS | FUNCTION |
| Start 30 day trial | This button enables the features of |
| | ThymeVine for 30 days. |
| Increase limit | Purchase more slots to increase the |
| | number of verified family members. |
| Add a new Credit Card | Register a new credit card. |
| View Subscription | View details of subscription |
| Cancel Subscription | End subcription |

### Steps to Register Subscription (Plant a Vine):

Billing Information is the 3^{rd} step of planting a vine. Check: Start 30 day trial. Fields appear for credit card registration. Preferably, if a user does not sign up for a 30 day trial while planting a vine, the user can still sign up for a 30 day trial via Family Admin Options, after logging in. Start filling out fields. Required fields must be filled out. Click submit. A prompt message displays text: “You have successfully created your account”.

### Steps to Select a Purchase Plan:

On home page, at top right of the page, hover the pointer on a Settings tab. A list of settings options appear. Click Subscription Info. The page redirects to ThymeVine™ Subscription Info. Select a credit from a drop down list. Click Purchase Plan. A prompt message displays the new ThymeVine Plan.

### Steps to Increase Limit (Slots):

On Subscription Info, click Increase limit. Choose the number of slots to add. Select a credit card to use from a drop down list. Click Purchase Family Member Slot.

### Steps to Hide/Show Markers:

On home page, at top right of the page, hover the pointer on a Settings tab. A list of settings options appear. Click Hide Markers to hide markers or click Show Markers to show markers.

### Profile

| BUTTONS/ | |
|---|---|
| HYPERLINKS | FUNCTION |
| Go back to MyThyme | Redirect to My Thyme. |
| Modify Profile | Redirect to Profile Info. |
| Update Status | Update a posted status or shoutout on profile. |
| Profile Completion | Redirect to designated page depending upon an |
| | option selected. Percentage increases when |
| | information is added to a profile. |
| Edit | Redirect to a page to edit profile information. |
| Expand | Enlarge the list. |
| Update Personal Family | Redirects to Manage Personal Family Tree. |
| Tree | |
| Connect a vine | Connect to a member. |
| +Add | Add a member to a group. |
| Edit Groups | Edit family groups. |
| Change Profile Picture | Change Profile Picture. |
| Photos | Redirect to My Gallery. |

### Steps to Modify Profile:

On profile, click Modify Profile. The page redirects to a page with profile information. Fill out fields to complete or update. Required fields must be filled out. To upload documents or files, click Choose file. A window for browsing files appears. To delete uploaded files, mark the box beside the filename. Click Save. A prompt message displays text: “Your Profile was Successfully Updated”. The Modify Profile procedure is the same as a Basic Info (Edit) procedure and a +Complete your personal procedure. Changes made may be applied to the Profile Page.

### Steps to Update a Status:

On profile, click Update Status. Enter status. Click Share.

Steps to Edit Education and Work from Profile:

On profile, click Edit on Work and Education. The page redirects to a page with profile information. To add additional information, click +Add Entry. Start filling out fields. Required fields must be filled out. Click Save. A prompt message displays text: “Your Profile was Successfully Updated”. Changes made may be applied to Profile Page. The work and education (edit) procedure is the same when initiated from an +Add College or +Add High School button.

### Steps to Update Education and Work:

Click Edit on an entry to be updated. Fill out fields to be changed. Required fields must be filled out. Click Update. A prompt message displays text: “Your Profile was Successfully Updated”. Changes made may be applied to Profile Page.

### Steps to Update Education and Work (Delete):

Click Edit on entry to be updated. A prompt message appears. Click OK. A prompt message displays text: “Your Profile was Successfully Updated”.

### Steps to Edit Favorites on Profile:

On profile, click Edit on Favorites. Page redirects to a page with Profile information. To add additional information, click +Add Entry. Start filling out fields. Required fields must be filled out. Click Update. A prompt message displays text: “Your Profile was Successfully Updated”. Changes made may be applied to Profile Page.

### Steps to Edit Favorites (Delete Marked):

Mark the box of an entry to be deleted. Click Delete Marked. Click OK. A prompt message displays text: “Your Profile was Successfully Updated”.

### Steps to Edit Sports on Profile:

On profile, click Edit on Sports. The page redirects to a page with Profile information. To add additional information, click +Add Entry. Start filling out fields. Required fields must be filled out. Click Update. A prompt message displays text: “Your Profile was Successfully Updated”. Changes made may be applied to Profile Page. The edit sports procedure is the same when initiated from an +Add Sports button.

### Steps to Update Sports (Delete Marked):

Mark the box of an entry to be deleted. Click Delete Marked. Click OK. A prompt message displays text: “Your Profile was Successfully Updated”.

### My Thyme Options (Family Admin Options)

### Personal Family Tree Builder

A personal family tree builder enables a family administrator to manage personal family tree details, view a personal family tree, add a member, delete a member, edit a member, view a family member, or link an account.

To add a parent to a family tree, navigate to an ADD A . . . drop down list, click “Add a Parent”, and fill out all the required fields, e.g., First Name, Last Name, Nick Name, Gender, and Birthday. Email-Address and Middle Name are optional. A “Save” button saves information entered in to fields. A “Reset” button clears the fields. A “Cancel” button returns to the personal family tree builder.

To add a sibling to a family tree, navigate to an ADD A . . . drop down list, click “Add a Sibling”, and fill out all the required fields, e.g., First Name, Last Name, Nick Name, Gender, and Birthday. Email-Address and Middle Name are optional. A “Save” button saves information entered into the fields. A “Reset” button clears the fields. A “Cancel” button returns to the personal family tree builder.

To add a partner to a family tree, navigate to an ADD A . . . drop down list, click “Add a Partner”, and fill out all the required fields, e.g., First Name, Last Name, Nick Name, Gender, and Birthday. Email-Address and Middle Name are optional. A “Save” button saves information entered into the fields. A “Reset” button clears the fields. A “Cancel” button returns to the personal family tree builder.

To add a child to a family tree, navigate to an ADD A . . . drop down list, click “Add a Child”, and fill out all the required fields, e.g., First Name, Last Name, Nick Name, Gender, and Birthday. Email-Address and Middle Name are optional. A “Save” button saves information entered into the fields. A “Reset” button clears the fields. A “Cancel” button returns to the personal family tree builder.

### Edit Family News

To create a Family News Ticker, fill out all the required fields (indicated with an asterisk “*”). Enter Title and Content, select who can view the ticker (e.g., “Show” is publicly viewable and “Hide” permits only a user to view), and select a status. Select Expiration Date: Month (January to December); 2 Digits for the Day; 4 Digits for the Year. A “Create” button creates the news. A “Cancel” button redirects to manage the family news ticker.

To manage the Family News Ticker: click “View” to view the news ticker, click “Update” to update the news ticker, and click “Delete” to delete the news ticker.

### Applications

### Journal Thyme

A user can choose a topic from one of a few provided topics to start posting a journal entry. For instance, exemplary journal topic categories include: Personal, Family, Travel, Medical, Documents, and Customize. Topic categories are arranged in the form of tabs, and turn white when clicked. Beneath the categories are the topics of each category.

### Choosing a Topic:

Journal Thyme includes several various topics, all of which are categorized accordingly. To choose a topic: click a desired category tab and then click a desired topic title or a ‘write about this’ link.

### Creating a Journal Entry

An exemplary journal entry may comprise: a title, questions and answers, documents, images, or PDF files (PDF files have a maximum size, e.g., a maximum size of 2 MB per file). If a size limit is desired for uploaded images or documents, a filter may be implemented to compress a photo or file to a desirable size or to convert a photo or file to a desirable format.

Journal entries can be shared based on an assigned share level or share group. A journal entry can only be shared with users that have a share level equal to or higher than that assigned to the journal entry. Share levels vary, as disclosed earlier, e.g., from exemplary articulated points such as Immediate, Very Close, Close, Fairly Close, Not So Close, to Public. A journal entry may also be shared with a particular group, if desired.

### Saving a Journal Draft

Journal entries may be saved as draft, so that a user can continue or update the entry on the next login. Drafts are displayed under Pending Projects, once a user logs in again. The table below depicts exemplary Journal Thyme buttons, parts, and functions.

| | |
|---|---|
| Title | Each journal entry should have a title |
| Questions | Questions may vary depending on a chosen topic |
| | and category. |
| Answers | Answers to questions may be supplied (optional). |
| Upload files | Documents, images, PDFs, etc., with a maximum of |
| | 2 MB per file may be included in an entry |
| Browse button | Click this button to choose and upload a file |
| | from a computer. |
| Share level | Varies from immediate, very close, close, fairly |
| | close, not so close, to public. |
| Group | Click this button to share an entry with an |
| | affiliated group. |
| Publish button | Click this button to publish a journal entry. |
| Save as draft | Click this button to save a journal entry as a |
| button | draft. |

### Journal Thyme Options Menu

Journal entries can be created, viewed, and managed using a Journal Thyme Options Menu. A Journal Thyme Options Menu preferably includes the following tabs: View Your Journal Entry, Manage Your Journal Entry, Create New Journal Entry, and Browse Posts by Others. This menu may be placed on the right-side of the page.

### View Your Journal Entry

A user can view all journal entries and drafts by clicking the ‘View Your Journal Entry’ button on the Journal Thyme Options Menu. All entries and drafts are posted accordingly along with a Publish Date, Author, Topic Category, and Comments. Users may leave a comment on a Journal entry and a Draft.

| | |
|---|---|
| Add a Journal entry | Click this button to post a new journal entry. |
| button | |
| Leave a comment | Click this button to leave a comment on a journal |
| | entry or post. |

### Manage Journal Entries

User can create, view, edit, and update journal entries and drafts using the ‘Manage Journal Entries’ button on the Journal Thyme Options Menu. Journal entries and drafts may also be deleted, published, or updated into a draft.

| Button/ | |
|---|---|
| Hyperlink | Function |
| Create a New Journal | Create a new journal entry |
| entry button | |
| Publish | Publish a certain draft. |
| Draft | Turn an entry into a draft. |
| Delete | Delete a journal entry or a draft. |
| Update button | Click this button to commit a selected option. |
| View link | Click this link to view an entire journal entry or |
| | draft. |
| Edit | Click this button to edit an entire journal entry or |
| | draft. |

### Browse Posts by Others

A user may browse posts of user's with which they are affiliated, and view and leave comments.

| Button/ | |
|---|---|
| Hyperlink | Function |
| View Full Posts button | View entire post |
| Leave a comment | Leave comment on a posted journal entry. |
| Submit button | Submit a comment. |

### Top Lists

A user can make a Top List. For instance, a Top list can be, e.g., a Top Wish List, a Top Favorites List, a Top Priorities List, etc. A user can add an image or link to a Top List. The inventive Top Lists application allows a user to customize and detail their favorites, quotes, songs, memories, and/or people. Top lists are viewed with a Title, Publish Date and Time, and Author.

| Button/ | |
|---|---|
| Hyperlink | Function |
| Edit button | Edit a Top List |
| View the Complete | View entire Top List |
| List button | |
| Comment/Leave a | Add and view comments to the Top List |
| comment button | |
| Add a Top List | Add a new Top List |
| entry button | |
| Gallery link | Add an image from Thyme Gallery to an |
| | item or entry. |

### Creating a New Top List

A Top List should have a title, such as: ‘My Top favorite’, ‘My Top Priorities’, ‘My Top Recipe’, or a Custom Title. A Top list comprises items (e.g. songs, recipes, memories, etc.) and may include an image or link. A Top List can only be shared with users or group members that have a share level that is equal or higher than that assigned to the Top List.

As previously disclosed, share levels vary, e.g., from: Immediate, Very close, Close, Fairly Close, Not so Close, to Public. A user may also share a Top List with a group, if desired. Exemplary Top List parts, buttons and hyperlinks are depicted in the table below.

| | |
|---|---|
| Title | Each top list should have a title, e.g., ‘My Top |
| | favorite’, ‘My Top Priorities’, ‘My Top Recipe’, |
| | or a custom title. |
| Top List Date | Each Top List has a date |
| Add New Top List | Click this button to add items or entries to a Top |
| Entry button | List |
| Link | A link to an item or entry can be added to a Top |
| | List. |
| Gallery link | Click this button to add an image from Thyme |
| | Gallery to an item or entry. |
| Remove link | Click this button to remove an item or entry from a |
| | Top List |

### Saving a Top List Draft

A Top List can be saved as a draft, so that a user can continue or modify the Top List the next time they log in.

### Top List Options Menu

Top Lists can be created, viewed, and managed using a Top List Options menu. A Top List Options Menu may include the following exemplary tabs: Manage Top Lists, Create New List, and View Only Your List. This menu can be found on the right-side of the page.

### Manage Top List

In the disclosed embodiments a user can create, view, edit, and update a Top List and drafts using the ‘Manage Top List’ button under on the Top Lists options Menu. Top Lists and drafts may also be deleted, published, or updated into a draft.

| Button/ | |
|---|---|
| Hyperlink | Function |
| Create a New List button | Create a new List |
| Publish | Publish a certain draft. |
| Draft | Turn entry into a draft. |
| Delete | Delete a Top List or a draft. |
| Update button | Commit a selected option. |
| View link | View entire Top List or draft. |
| Edit | Edit entire Top List or draft. |

### View Only Your List

When this menu option is clicked, only a user's personal Top Lists and drafts will appear on the page. Other user's Top Lists are excluded from the page.

### View All List

When this menu option is clicked, all posts, including other user's Top Lists appear on the page.

### Thyme Calendar

Events such as: Birthdays, Memorials, Anniversaries, etc., can be recorded and managed using a calendar function on the inventive share level network. For instance, events on Thyme Calendar may be posted either in Vine or in a user's Personal Calendar.

A Family Calendar allows a user to browse the previous events or to browse the upcoming events. It is also easier to browse since the calendar can be viewed by year or month.

### Searching Through the Family Calendar

The Family Calendar can jump to, and back to, a certain year or month using a search function, and can be used to display events from a specific time period.

### Viewing the Full Calendar

A user can manually browse the Family Calendar by month, by clicking previous and next button found atop the calendar. Events, death anniversaries, or birthdays within a month are displayed (e.g., represented by violet, black, and red bars). Hyperlinks associated with a Family Calendar function are listed in the table shown below.

| Hyperlink | Function |
|---|---|
| View Full Calendar link | View full calendar |
| Go Back to Main Page | Go back on Vine |
| link | |
| Year drop down list | Select a year to view |

Exemplary Family Calendar display details are listed in the table shown below.

| | |
|---|---|
| Violet bars | Indicate dates with an event |
| Red bars | Indicate dates with a birthday |
| Black bars | Indicate dates with a death anniversary |
| Highlighted Day | Indicates a current date |

### Yearly View Calendar

All twelve months of a year can be viewed using a Yearly View calendar, which displays twelve mini calendars (from January to December). The Yearly View calendar provides a user with an overview of events that occur within a year.

### Adding an Event

An event is composed of a title, event details, start date, and end date. A user can freely customize event details by changing font style, changing alignment, adding an image, or adding a link. An event may last for a period of time as indicated by a start and end date set by a user. An event may be set to reoccur every year. An event message can be sent to family members to notify them of the event. An event entry can only be shared with users or group members that have a share level that is equal to or greater than that assigned to the event. As previously disclosed, share levels vary from Immediate, Very Close, Close, Fairly Close, Not so Close, all the way to Public. An event entry may also be shared with a group, if desired a the user. Events can be posted either on vine or on a personal calendar. Details and buttons associated with an event feature are depicted in to table shown below.

| | |
|---|---|
| Event title | An event must have a title |
| Event Details textbox | Used to input and customize details of an event |
| Start Date | Starting date of an event |
| End Date | Ending date of an event |
| ‘Recur every year’ | Click this button to make event repeat yearly |
| ‘Send Event Message’ | Click this button to send Event message to family |
| | members to notify them of upcoming events |
| Post to Vine button | Click this button to post event on Vine |
| ‘Post to Your Personal | Click this button to post event on Personal |
| Calendar’ button | Calendar |

### Posting an Event to Vine

Calendar entries posted to vine are displayed in Vine, wherein other people can also view the entries.

### Posting an Event to Your Personal Calendar

Calendar entries posted to a personal calendar are displayed in the personal calendar, wherein other users cannot view the entries.

### Edit an Event

A user can update or delete an events on vine or on a personal calendar.

| | |
|---|---|
| Public Events | A user's personal events |
| Event Details | Details of an event |
| Delete button | Click this button to delete an event |
| Update button | Click this button to edit an event |

### Thyme Calendar Options Menu

Calendar events can be created and viewed in the calendar using a Thyme Calendar Options menu. A Thyme Calendar Options menu preferably includes the following options: ‘Create a Calendar Event’ and ‘View Full Calendar’. This options menu can be found on the right side of the page.

### Contact Thyme

In a Contact Thyme module a user is enabled to see contact information listings of all their family members in ThymeVine. A user can click a family member's name to automatically redirect to that family member's profile.

### View Profile & Edit Info

A user can view and edit their personal information by clicking appropriate buttons (e.g., View Profile & Edit Info). A user is automatically redirected to a page for editing profile information.

### Contact List

A user can see family members' contact information/profiles through a contact list module by clicking an appropriate button (e.g., Your Contact List). To view full details for a certain family member, a user can click on the family member's name to automatically redirect to a profile page for that family member.

The user can choose a certain type of view to determine how names will appear on their page (e.g., full details and List are almost the same, except on Full details, a picture is displayed).

### Send a Message to a Family Member

To send a message to a certain family member, a user can click an appropriate button (e.g., Send Message) to automatically redirect to a page for typing and sending a message.

### Searching Feature

To search for a certain family member, a user need not go over the list. Rather, a user can search for the family member by typing the family member's name into a search bar. The system automatically filters the list based on the search term and displays a result.

### Name Thyme

In a name thyme module, a user can view a family member via a personal family tree and other connections. In particular, a user can click the name of a family member to automatically redirect to the family member's profile.

### Add a Name

A name can be added to a personal family tree. To add a name, click an appropriate button (e.g., add a name), and the page will automatically redirect to a page for updating a personal family tree. Name can be sorted by choosing an option on a dropdown list (First name, last name & Year of birth). A user can choose a certain type of view to determine how names will appear on a page (Full details & List are almost the same, except on Full details, a picture is displayed).

### Searching Feature

To search for a certain family member on a name thyme module, a user need not go over the list Rather, a user can search for a family member by typing the family member's name into a search bar. The system automatically filters the list based on the search term and displays a result.

### Thyme Capsule

A Thyme Capsule module allows a user to create a digital thyme capsule. A Thyme Capsule is a historic cache of goods or information, usually intended as a method of communication with future people. Time capsules are sometimes created and buried. Thymevine allows a user to do the same via thyme capsule.

### Create Thyme Capsule

To create a thyme capsule, click an appropriate button (e.g., add a capsule entry) to automatically redirect to a page for inputting thyme capsule information. The following exemplary information may be entered into a thyme capsule:

An inscription (e.g. this capsule is for xxx family members)

Delivery Date (month, day, and year)

Title

A memory to share message or a to save

Pictures or documents

### Update Thyme Capsule

To update a thyme capsule entry, click the thyme capsule name and click an appropriate button (e.g., update capsule post), to automatically redirect to a page for updating thyme capsule information.

### Manage Thyme Capsule

To manage a thyme capsule, click an appropriate button (e.g., Manage Thyme Capsules), to automatically redirect to a page for managing thyme capsules. Update entries/change status according to the following: publish, draft, delete, or browse posts by others.

A user can browse thyme capsule posts by others by clicking an appropriate button (e.g., browse posts by others) to automatically redirect to a page with thyme capsule posts by others.

### Leave a Comment on a Thyme Capsule Post

Users that have access to view a thyme capsule can leave a comment on it. To leave a comment on a Thyme capsule, click an appropriate button (e.g., leave a comment), type a comment, and click the Submit button.

### They Said It

A “They Said It” feature of the disclosed share level network, in accordance with the principles of the present invention, is enables users to capture priceless statements made by children or adults.

| BUTTONS/ | |
|---|---|
| HYPERLINKS | FUNCTION |
| Create new they said it! | Create new post. |
| Entry | |
| Add a scenario/statement | Enter a situation or description about a |
| | post. |
| Add a conversation | Enter a conversation or discussion with the |
| | name of the person who said it. |
| Continue conversation | Add a field. |
| (X)or close | Remove added field on a conversation. |
| Choose file | Browse a file on a desktop for uploading. |
| Share level | Choose a publication level for post. |
| (i)or information | Show a description of each Share level. |
| Group (checkbox) | Choose group to view post. |
| Post | Publish post according to a chosen |
| | publication level. |
| Save as draft | Save post on pending projects. |
| View your they said it! | Display all your created post on They Said |
| Entries | It module. |
| Leave a comment | Enter comment on post. |
| Submit | Post comment. |
| (X) number of comment/s | View posted comments. |
| Browse post by others | Show all entries in They Said It module |
| | (including users). |
| View full post | View entire post. |
| Manage they said it! | update, delete or view post. |
| Entries | |
| Update (publish, draft, | Publish -post entry. |
| delete) | Draft - saved to pending projects. |
| | Delete - remove post. |
| View | View entire post. |
| Edit | Edit information on post. |
| Update they said it! Post | Update information on post. |

Creating They Said it! Entry

On home page, click Application>They said it!. The page is redirected to the They Said It! home page. Click Create they said entry! or Add a new entry. Page redirects to a create post page. Start filling out the fields. Required fields must be filled out. After filling out fields, click Post. The entry is posted to recent activity. To save entry as a draft, click Save as draft, and the entry is saved to pending projects.

Manage They Said it! Entries

To Publish a “They Said It!” entry, select an entry by marking a box next to the entry (can be multiple). Select Publish on a drop down list. Click Update The post's status is changed Publish and the status is posted to recent activity.

To save an entry as a Draft, select an entry by marking a box next to the entry (can be multiple). Select Draft on a drop down list. Click Update. The post's status is changed to Draft and the draft is posted to pending projects.

To delete a “They Said It!” entry, select an entry by marking a box next to the entry (multiple boxes/entries can be marked). Select “Delete” on a drop down list. Click update. The post is deleted.

To view a “They Said It!” entry, click “View” on the entry that is desired to be viewed. The page redirects to the entire post.

To edit a “They Said It!” entry, click edit on the entry that is desired to be edited. The page redirects to an updated post.

### Scrapbooking

Create a unique scrapbook that captures your family's history.

| BUTTONS/ | |
|---|---|
| HYPERLINKS | FUNCTION |
| Create New Scrapbook | Create a new entry. |
| Entry | |
| Next | Proceed to next step of creating an entry. |
| Cancel | Close procedure. |
| Back | Back from previous step. |
| Start Scrapbook | Start designing entry. |
| Application Icons (On | Choose entry or pictures to place on Scrapbook |
| Top) | page. |
| Modify Scrapbook | Update Scrapbook Information. |
| Information | |
| < > or Navigation | Navigate to next or previous page. |
| page | |
| (+)or Add | Add a page to Scrapbook. |
| Page Break | Default (Theme Page) - Add page with curent |
| | theme. |
| | Blank - Add blank page. |
| Other | Note - Add Sticky note to Scrapbook page. |
| | Custom Text - Add Text to Scrapbook page. |
| Done | Finish procedure. |
| Change my current | Chane current Scrapbook/Scrapbook page |
| theme | theme. |
| Apply | Apply changes made. |
| (x)or Delete Page | Remove page. |
| Share level | Choose publication level of entry. |
| (i)or information | Show description of each Share level. |
| View the list of | Display family members that belongs to |
| connections set to this | a selected share level. |
| post | |
| Group (checkbox) | Choose a group to view post. |
| Save | Publish entry according to a chosen |
| | publication. |
| View Scrapbooks | Display all created Scrapbook entries. |
| Leave a comment | Enter a comment on an entry. |
| Submit | Post comment. |
| Manage Scrapbooks | Update, delete and/or view Scrapbook entry. |
| Update (publish, draft, | Publish - post entry. |
| delete) | Draft - save entry to pending projects. |
| | Delete - remove entry. |
| View | View entire entry. |
| Update Scrapbook Entry | Edit or update information on an entry. |

### Create New Scrapbook Entry

On home page click Application>Scrapbooking, and the page redirects to a Scrapbook module home page. Click New Scrapbook Entry or Create New Scrapbook Entry. A pop up window appears for scrapbook information. Fill out the fields then click Next. Required fields must be filled out. Choose a theme, then click Next. A summary of the scrapbook is displayed.

To start Scrapbook customization, click Start Scrapbook. Drag, drop, rotate and enlarge entries on a Scrapbook page. Click Save. The entry is posted to recent activity.

### Manage Scrapbooks

To publish a scrapbook, select an entry by marking a box next to the entry (multiple Scrapbook entries can be selected). Select Publish on a drop down list. Click Update. The entry's status changes to Publish and the entry is posted to recent activity.

To leave a scrapbook in draft form, select an entry by marking a box next to the entry (multiple Scrapbook entries can be selected). Select Draft on drop down list. Click Update. The entry's status changes to Draft and the entry is accessible under pending projects.

To delete a scrapbook entry, select an Scrapbook entry by marking a box next to the entry (multiple Scrapbook entries can be selected). Select Delete on a drop down list. Click Update, and the entry is deleted.

To view a Scrapbook entry, click View on an entry that is desired for viewing. The page is redirected to the entire entry.

To edit a Scrapbook entry, click Edit on an entry desired for editing. The page is redirected to an update entry page. Note that EDIT is the same as Update Lesson Post under Options.

### View Scrapbooks

On the right side of the page, under Options, click Lesson Entries. The page displays all entries posted by the user. Comments may be left on entries by clicking a leave a comment button.

### Lesson Thyme

A Lesson Thyme feature allows a user to pass on life's lessons, or to simply help a child do their homework remotely, or anything in between.

| BUTTONS/ | |
|---|---|
| HYPERLINKS | FUNCTION |
| Start with this | Create entry based on category chosen. |
| Add a lesson (radio | Insert lesson on entry. |
| button) | |
| Ask for an answer (radio | Insert question on entry. |
| button) | |
| Choose file | Browse desktop files for uploading. |
| Share level | Choose publication level of entry. |
| (i)or information | Show description of each Share level. |
| Group (checkbox) | Choose a group to view post. |
| Post | Publish post according to publication |
| | level chosen. |
| Save as draft | Save entry to pending projects. |
| View your lesson entry | Display all Lesson Thyme entries. |
| Leave a comment | Enter a comment on an entry. |
| Submit | Post comment. |
| (X) number of comment/s | View comments posted on an entry. |
| Browse posts by others | Shown all Lesson Thyme entries |
| | (including user's). |
| Manage Lesson Entries | Update, Delete, or View a Lesson |
| | Thyme entry. |
| Update (publish, draft, | Publish -post entry. |
| delete) | Draft - saved to pending projects. |
| | Delete - remove post. |
| View | View entire entry. |
| Edit | Edit information on entry. |
| Update Lesson Post | Update information on entry. |
| Search | Search for a specific entry. |

### Create New Lesson Entry

To create a new lesson entry, on home page, click Application>Lesson Thyme. The page is redirected to a Lesson Thyme home page. Choose a category then click start with this. The page redirects to a page where a user can start creating an entry. Start filling out fields. Required fields must be filled out. After filling out fields, click Post. The entry is posted on recent activity. To save as draft, click Save as draft. The entry is saved to pending projects.

### Manage Lesson Entries

To publish a lesson entry, select an entry by marking a box next to the entry (multiple entries can be selected). Select Publish on drop down list. Click Update. The entry's status is changed to Publish and the entry is posted to recent activity.

To leave a lesson entry as a draft, select an entry by marking the box next to the entry (multiple entries can be selected). Select Draft on drop down list. Click Update. The entry's status is changed to Draft and the entry is accessible under pending projects.

To delete a lesson entry, select an entry by marking a box next to the entry (can be multiple). Select Delete on drop down list. Click Update. The entry is deleted.

To view a lesson entry, click View on an entry to be viewed. The page redirects to the entire entry.

To edit a lesson entry, click Edit on an entry to be edited. The page redirects to an update entry page. Edit is the same as Update Lesson Post under Options.

### View Lesson Entries

On the right side of the page, under Options, click Lesson Entries. The page displays all the entries posted by the user. A comment can be left on an entry by clicking a leave a comment button.

### Browse Post by Others

On the right side of the page, under Options, click Browse Post by Others. The page display all entries posted by other family members. Clicking View Full Post redirects to the entire entry.

### Search Lesson

On the right side of the page, type a Title or Content of an entry into search bar. Click Search. Results are displayed on the page.

### Wish List

| BUTTONS/ | |
|---|---|
| HYPERLINKS | FUNCTION |
| Create new Wish List | Creates wish list that can be shared with to |
| Entry | family members or a group. |
| View Wish List (Under | View all wish lists. |
| “Options” pane) | |
| Manage Wish List(Under | Manage wish list wherein by creating, viewing |
| “Options” pane) | or updating wish list. |
| Update Wish List(Under | Update wish list. |
| “Options” pane) | |
| View only your wish | View only your own wish lists. |
| list(Under “Options” | |
| pane) | |
| Edit (Button below the | Make changes to wish list. |
| list) | |
| View the Complete List | View all list. |
| (Button below the list) | |
| Comment( )I Leave a | See number of comments and leave a comment. |
| Comment (Button below | |
| the list) | |
| Title | A wish list must have a title. |
| Wishlist Date | A wish list must have a wishlist date. |
| Add New List Entry | Enter name of wish list, wherein you can add |
| | a link to a list. |
| Gallery | Add image from Thyme Gallery. |
| Remove | Remove name of list. |
| Share Level | Select level of member who can view post |
| Post | Publich wish list. |
| Save as Draft | Save list as draft. |
| Publish (Update Option) | Publish selected wish list. |
| Draft (Update Option) | Save wish list as draft. |
| Delete(Update Option) | Delete selected wish list. |

### Creating a New Wish List

When creating a new Wish List click Application icon>Wish List. Click the “Create a new list entry” button. If there are existing wish lists, click the “Add a wish list entry” button or “Create New List” under the Option pane to create a new wish list. Fill out the required fields, click “Post” button. When creating a wish list, required fields like, Title, Wish List date, List and level of family member should be filled out.

### Viewing Wish List

There are two options in viewing a wish list: view your own wish lists or view all wish lists. When viewing a wish list, click the Application icon, Wish List. Then, under the Option pane on the right side, click “View Only Your List” or “View All List”.

### Managing a Wish List

To manage a Wish List, click Application icon>Wish List. Under the Option pane on the right side, click “Manage Wish List”. Tick the checkbox of a wish list to which changes should be made and select an option from the dropdown list to Publish, Draft or Delete the selected list. Click the “Update” button. View or edit a wish list by clicking “View” or “Edit” on the right side of the title of a list.

### Updating a Wish List

“Update wish List” option is shown on the Option pane after a new list is added. Click “Update wish List” under the Option pane on the right side. After changes are made click “Post” button.

### Quiet Thyme

| BUTTONS/ | |
|---|---|
| HYPERLINKS | FUNCTION |
| Letters | View list of letters created. |
| Funeral Plans | View all wish lists added. |
| Obituary | Manage wish list by creating, viewing and/or |
| | updating wish list. |
| Last Will and | Update wish list or make changes to it. |
| Testament | |
| Religious Verse | View list of bible/Koran/Torah, etc. verse |
| | created |
| Post Bible/Koran/Torah, | Post a religious verse and send it to family |
| etc. verse/s | members |
| Manage Posted | Manage a posted religious verse posted by |
| Bible/Koran/Torah, etc. | editing or deleting the verse. |
| verse/s | |
| Create Letter for Loved | Create a new letter and send it to family |
| ones | member/s. |
| View full post | View the whole content of a letter. |
| Manage Letter for Loved | Manage a letter wherein by viewing or |
| ones | deleting the letter. |
| View | View a letter created. |
| Delete | Delete a letter. |
| Create a new Funeral | Create a funeral plan and send it to family |
| Plan | member/s. |
| Edit Funeral Plan | Edit funeral plan and make some changes. |
| Create a new Obituary | Create obituary and send it to family |
| | member/s. |
| Edit Obituary | Edit obituary and make some changes. |
| Create Last Will and | Create Last Will and Testament. |
| Testament | |
| Download | Download file or image attached. |

### Posting a New Religious Verse

To post a new religious verse: click the Application icon>Quiet Thyme. Hover the mouse to “Religious Verses” (or similar). On the upper right side of the page click “Post Religious Verse/s” (or similar). Fill out the following required fields, e.g.: To (Family member that you want to see your post); Verse; Content. Click “Send Now” button. A message displays that the verse has been successfully updated. Click a “Save as Draft” button to save a verse. A message message displays that the verse has been successfully saved.

### Managing Posted Religious Verses

To manage a posted religious verse, click Application icon>Quiet Thyme. Hover the mouse to “Religious Verses” on the upper right side of the page. Click “Manage Posted Religious Verse/s”. A list of suggested verses is displayed with two options: Edit and Delete.

### Editing a Posted Religious Verse

To edit a posted religious verse, click Application icon>Quiet Thyme. Hover the mouse to “Religious Verses” on the upper right side of the page. Click “Manage Posted Religious Verse/s”. A list of suggested verses is displayed with two options: Edit and Delete. Click the Edit button. Changes may be made to headline, content, members to whom verse should be sent. Click “Send Now” button to send verse or click “Save as draft” button to save changes made to verse. A message displays that the verse has been successfully updated.

### Deleting a Posted Verse

To DELETE a posted religious (or otherwise) verse, click Application icon>Quiet Thyme. Hover the mouse to “Religious Verses” on the upper right side of the page. Click “Manage Posted Religious Verse/s”. A list of verses is displayed with two options: Edit and Delete. Click the Delete button. A dialog box appears. Click “OK” button to delete the verse. A message is displayed to confirm that the verse has been successfully deleted.

### Creating Letters for Loved Ones

To create a new letter, click Application icon>Quiet Thyme. Hover the mouse to “Letters to Loved Ones” on the upper right side of the page. Click “Create Letters for Loved Ones”. Fill in the following required fields: To (Family member that you want to receive your letter), Subject, Message, Choose file (optional). Click the “Send” button. A message is display to confirm that the letter has been sent successfully. Click a “Save as Draft” button to save a letter.

### Managing Letters for Loved Ones

To MANAGE letters for loved ones, click Application icon>Quiet Thyme. Click “Letters to Loved Ones” on the upper right side of the page. Click “Create Letters for Loved Ones”. A list of letters is displayed with two options: View and Delete.

### Viewing a Letter

To VIEW a letter, click Application icon>Quiet Thyme. Click “Letters to Loved Ones” on the upper right side of the page. Click “Create Letters for Loved Ones”. A list of letters is displayed with two options: View and Delete. Click View button. All messages sent to the message receiver are displayed.

### Deleting a Letter

To DELETE a letter, click Application icon>Quiet Thyme. Click “Letters to Loved Ones” on the upper right side of the page. Click “Create Letters for Loved Ones”. A list of letters is displayed with two options: View and Delete. Click View button. All messages sent to the receiver of the message are displayed. Click the Delete button. A dialog box appears. Click “OK” button to delete the verse. A message is displayed to confirm that the letter has been successfully deleted.

### Creating Funeral Plan

To create a funeral plan, click Application icon>Quiet Thyme. Hover the mouse to “Plan your Funeral” on the upper right side of the page. Click “Create Funeral Plan”. Fill out the required field: To (Family member that you want to receive your letter). Click the “Send” button. A message is displayed to confirm that the letter has been sent successfully. Click the “Save as Draft” button to save a funeral plan as a draft.

### Editing Funeral Plan

To EDIT a funeral plan, click Application icon>Quiet Thyme. Hover the mouse to “Plan Your Funeral” on the upper right side of the page. Click “Edit Funeral Plan”. A user can make changes to the funeral plan, change the list of member(s) to whom the funeral plan should be sent, etc. Click “Send Now” button to send the funeral plan or click “Save as draft” button to save the changes made to the funeral plan. A message is displayed to confirm that the funeral entry has been successfully updated.

### Creating Obituary

To create an obituary, click Application icon>Quiet Thyme. Hover the mouse to “Obituary” on the upper right side of the page. Click “Create Obituary”. Fill out the required fields: To (Family member that you want to receive your letter), Headline, News, and Choose file (optional). Click the “Send” button. A message is displayed to confirm that the obituary entry has been successfully updated. Click a “Save as Draft” button to save the Obituary.

### Editing Obituary

To edit an obituary, click Application icon>Quiet Thyme. Hover the mouse to “Obituary” on the upper right side of the page. Click “Edit Obituary”. A user can make changes to the obituary, change the list of member(s) to whom the obituary should be sent, etc. Click “Send Now” button to send the obituary or click “Save as draft” button to save the changes made to the obituary. A message is displayed to confirm that the obituary entry has been successfully updated.

Creating Last Will & Testament

To create a Last Will & Testament, click Application icon>Quiet Thyme. Hover the mouse to “Last Will & Testament” on the upper right side of the page. Click “Create Last Will & Testament”. Fill out the required fields: To (Family member that you want to receive your letter); Content; Choose file(s) (optional). Click “Send” button. A message is displayed to confirm that the Will entry has been successfully updated. Click a “Save as Draft” button to save the Last Will & Testament.

### Editing Last Will & Testament

To EDIT a Last Will & Testament, click Application icon>Quiet Thyme. Hover the mouse to “Last Will & Testament” on the upper right side of the page. Click “Create Last Will & Testament”. A user can make changes to the last will & testament, changing the list of member(s) to who the Last will nd Testament may be sent, etc. Click “Send Now” button to send the obituary or click “Save as draft” button to save the changes made to the obituary. A message is displayed to confirm that the Will entry has been successfully updated.

### Their Thyme

| BUTTONS/ | |
|---|---|
| HYPERLINKS | FUNCTION |
| View Memorials you | View memorials added |
| added | |
| Add New Memorial | Add a new memorial |
| Post | Publish a memorial |
| Save as Draft | Save memorial as draft |
| Choose File | Choose a file when creating a memorial |
| Dedicate e-Flowers | Dedicate a flower for a deceased person. |
| Light a Candle | Light a candle for a deceased person. |
| View Gallery | View images of a deceased person |
| Update Memorials Post | Make some changes to a posted memorial |
| Manage Memorial Album | Manage images from a memorial post |
| | wherein you can delete multiple images. |
| Memorial Theme | Select a memorial theme. |
| Statistics | Gives an update on how many flowers and |
| | candles have been offered to a deceased |
| | person. |
| Recent page activity | View recent activities. |
| Share this Memorial | Share a link of a posted memorial with a |
| Link | family member. |
| Write a Tribute | Write a tribute for a deceased person. |
| Submit a photo | Submit a photo of a deceased person. |
| View full page | Download a file or image. |
| Edit Information | Make changes to a posted memorial. |
| Leave a Testimonial | Post a testimonial for a deceased person. |
| Manage Memorials | Manage a posted memorial posted, wherein |
| | user can view and edit the memorial |
| | posted and manage the images. |
| Publish (Update Option) | Publish selected memorial. |
| Draft (Update Option) | Save selected memorial as draft. |
| Delete(Update Option) | Delete selected memorial. |

### Adding a New Memorial

To create a new memorial, click Application icon>Their Thyme. Click “Add New Memorial” from the Option pane. Fill out the following field: Name (Select Relative who's already deceased). A user can populate the list above by adding the deceased person on Name Thyme. Possible information includes date of passing, resting place location, theme, something about the person, something the person once said, a short biography of the person, choose file (optional), etc. Click “Post” to publish the memorial or click “Save as draft” to save the memorial as a draft.

### Adding a Deceased Person on Name Thyme

To add a deceased person on Name Thyme, click Application icon>Their Thyme. Click “Add New Memorial” on the Option pane. Click “Click Here” link to add a person on name thyme. Fill out the following fields: Family Name, Country, Street Address, City, State, Zip. Click “Save” button to save the name. A message is displayed to confirm that it is successfully updated.

### Managing Memorials Added

To manage added memorials, click Application icon>Their Thyme. Click “Manage Memorials” on the Option pane. A list of memorials is displayed with three options: View, Edit and Photo. A user can also Publish, Save as draft, and delete a memorial.

### Deleting a Memorial

To DELETE a new memorial, click Application icon>Their Thyme. Click “Manage Memorials” on the Option pane. A list of memorials is displayed. Select “Delete” from the dropdown list and click the “Update” button. A message is displayed to confirm that the memorial was successfully deleted.

### Editing Memorial Information

To edit memorial information, click Application icon>Their Thyme. A list of memorials is displayed. Click “Edit Information” on the Option pane below the Statistic. After changes are made, click “Post” to post the memorial or click, “Save as Draft”, to save the changes made.

### Sharing Memorial Link

To share a memorial link, click Application icon>Their Thyme. Click “View Full Page” of the memorial. Click “Email” button on the “Share this memorial link” pane. A dialog box appears. Select family member or enter an email address. Click “Send” button. A message is displayed to confirm that the memorial has been successfully shared.

### Take Me to:

### My Image Gallery(My Gallery):

To create a new album, click the “Create a new album” button. Fill out all the required fields indicated with an asterisk “*”.

Enter “Album Title” (*), noting that special characters are allowed, and that the same title on the user album is allowed.

Select “Image Type” (*) should be chosen from the three options. “Select” is selected by default to force a user to select one. For instance, exemplary Photo Image file types are as follows: jpg, jpeg, png, gif. Exemplary document Image file types are as follows: pdf, doc, docx, ppt, xls, xlsx, txt. Exemplary photo and document image file types are as follows: jpg, jpeg, gif, png, pdf, doc, docx, ppt, xls, xlsx, txt.

A description is optional.

A share level (*), in accordance with the principles of the present invention, should be chosen from the provided options. “Immediate” may be selected by default. Immediate relates to nuclear/immediate Family Members and those closest to a user. Other share level articulated positions include very close (1^{st} Degree of Closeness), Close (2^{nd} Degree of Closeness), Fairly close (3^{rd} Degree of Closeness), Not so close (4^{th} Degree of Closeness), and Public (anyone in the thyme vine network including non-paying accounts can view the post).

Another field to be filled in is groups, which may be, e.g., relatives, etc. When fields are complete, select the “Create Album” button.

To ADD photos/images to the album, click “Add Photos/Images to the album” button. Select a Gallery album, and upload Images. As many as, e.g., 10 images at a time may be uploaded. The size of the images may be limited if desired, e.g., to 2 Mb per image. Alternatively, if storage space in the network is a concern, the size of uploaded images may be compressed to be of no more than a maximum size (e.g., 2 Mb). The uploaded images may additionally or alternatively be converted to a desirable format within the shared network. Click “Upload Photos” button. A user can also edit their album by selecting an “Edit” button.

### Edit/Update Album

To Edit/update an album, click the album and then click an “Edit” button to update the album. Fill out all the required fields indicated with an asterisk “*”. Enter “Album Title” (*), note that special characters are allowed and that the same title as the user album title may be allowed. “Image Type” (*) should be chosen from the three options. “Select” is selected by default to force a user to select one, e.g., Photo Image—file type such as jpg, jpeg, png, gif; Document Image—file type such as pdf, doc, docx, ppt, xls, xlsx, txt; Photo and Document image—file type such as jpg, jpeg, gif, png, pdf, doc, docx, ppt, xls, xlsx, txt. Alternatively, the shared network may sense a compatible file format for upload thereby eliminating or automating the need for the user to select a file type. Description may be optional. Share Level (*) should be chosen from the provided options. “Immediate” is selected by default. Share level options preferably include: Immediate—nuclear/Immediate Family Members & those closest to you, Very close—(1^{st} Degree of Closeness), Close—(2^{nd} Degree of Closeness), Fairly close—(3^{rd} Degree of Closeness), Not so close—(4^{th} Degree of Closeness), and Public—anyone in the thyme vine network including non-paying accounts. Groups—relatives and groups. Click “Update Album” button.

To go back to gallery home, click “Back to Gallery Home” under Option.

To delete album, check the album then click “Delete” button below. Multiple albums may be deleted by ticking their respective boxes.

Albums may be viewed by “Image type”, e.g., all; by photo Image—file type such as jpg, jpeg, png, gif; by document Image—file type such as pdf, doc, docx, ppt, xls, xlsx, txt; or by photo and document image—file type such as jpg, jpeg, gif, png, pdf, doc, docx, ppt, xls, xlsx, txt.

### My Profile>Profile Info

Personal Information. Fill out all required fields indicated with an asterisk “*”: Enter First Name (*); Middle name (optional); Enter Last Name (*); Name Extension (optional); Nickname (optional); Date of Birth field entered in the following format: (Format: Month/Day/Year)(*); Gender (*) should be chosen from the two provided options. The option “Please select” is selected by default. Address (including street address (optional); city optional; country (*); and Zip code (optional), though if user lives in the United States entry of their State may be required.) Contact information can include phone number and/or mobile number. To upload documents, click “Browse” button (optional). To delete documents, click on the appropriate check box to delete. Multiple documents may be deleted by ticking the appropriate box(es). When the form is complete, click the “Save” button.

### My Groups>Create a New Group

Enter group name then click “Create” button. Ideally special characters are not allowed (e.g. “!”, “@”, “,”, “ ”, “:”) and group name should be unique and not existing. Groups may be edited, e.g., a group name, after which the “Save” button is clicked. Group members may also be edited, and groups/group member(s) may be deleted by clicking the appropriate trash icon or similar. Sort by: should be chosen from the two options. The option “Select Members” is selected by default.

### All—all Family Members

Share level—The Option “Select” is selected by default, e.g., Immediate—nuclear/Immediate Family Members & those closest to you; Very close—(1^{st} Degree of Closeness); Close—(2^{nd} Degree of Closeness); Fairly close—(3^{rd} Degree of Closeness); or Not so close—(4^{th} Degree of Closeness).

### My Messages

A user can send a message by clicking a “Send a message” button. To: (select receiver) (ideally Last name and First Name only). A subject may be entered, and/or a message may be entered. Preferably a file(s) can also be attached by selection of an “Attach a file” button. When a message is complete, it may be sent by clicking an appropriate “Send” button.

An inbox of messages may be viewed, with provision to mark all inbox messages. Marked messages may be marked as “Read” by clicking a “Read” button, or “Unread” by clicking an “Unread” button. A message may be viewed by clicking a “View Message” button and deleted by clicking a “Delete” button. Sent messages may be viewed by clicking a “Sent” button. Deleted messages may also be viewed, as can be trashed messages. A “Restore” button may be implemented to return the selected message(s). A “Delete permanently” button may be implemented to remove the selected message(s) (or all messages in a given category) permanently from the trash.

### Family Calendar

A “Show” button may be implemented to show an appropriate calendar panel; and a “Hide” button may be implemented to hide the calendar panel. A “View Full Calendar” button enables viewing of a full calendar.

The viewed Family Calendar may be sorted, e.g., by year (e.g., 4 digit year); by month (January to December). When done selecting year and month, click the “Search” button.

Months in the Family Calendar may also be viewed with a “Next Month” button; a “Previous Month” button, and a “Today” button to view the current date.

An event may be added to the Family Calendar by clicking an appropriate “Add Event” button. To add an event, all required fields indicated with an asterisk “*” are filled out: Event (*); Event Details (*); Font name; Font size; text color; bold; Italic; Underline; numbered list; bulleted list; decrease indent; increase indent; text alignment: align left/center/align right; link/unlink; image; maximize; start date (*)—current date default; and end date (*)—current date is the default.) Note: the entry should be rejected if the start date is later than the end date. Optionally the event may be entered as recurring each year. An event message may be sent. Share Level (*) should be chosen from the options, with “Immediate” being selected by default. For instance, the share level may be set as immediate; very close; close; fairly close, not so close; or public.

A “Post to Vine” button will be post on the user's vine. The “Post to your personal calendar” button will be posted only on the user's Family Calendar.

To go back to the main page, click “Go Back to Main page” button to return on the Thyme Vine main page.

Click “Yearly View Calendar” button to view yearly events.

### Pending Projects

In this module, the user will see all of their unpublished posts or posts that are saved as drafts. Pending Projects is found on “My Thyme” above Recent Activities. The user will see the complete list of their pending projects by: clicking an arrow facing downwards; or hide the list by clicking the arrow facing upwards.

### Update Post

The user can edit posts on the list just by clicking an appropriate button: To change the name or title of the post—click to update and the user interface will automatically redirect to the page were they can update their post and publish it on their ThymeVine.

### Recent Activities

In this module, the user will see the list of all the recent activities they made on their ThymeVine. Recent Activities is found on “My Thyme” below Pending Projects. By default the title or name of a post is the only detail displayed on the list. Content may be viewed by clicking an appropriate button (Expand), or be hidden or revert back to a default setting just by clicking appropriate button (Hide).

### View Post in Full Details

The user can view full details of a certain post just by clicking the appropriate button (View post), and the user interface will automatically redirect to the page where they can view it in full details.

### Leave a Comment on Post

The user can leave a comment on a certain post under Recent Activities by clicking the appropriate button to type a comment, type the comment, and then click a Submit button.

### View More Posts

To view more of the activities posted on a user's ThymeVine: click the appropriate button to view more posts, and the user interface page automatically redirects to a page where they view all of the posts on their ThymeVine.

### Family Thyme

This is where a user may manage their family tree, privacy settings, and connection to family members. They may view and manage their family members and the persons they are connected to, by share levels. They may also see all of their pending and sent requests, or may connect to a member in this section.

### Search by

This search filter makes it easier to find a family member or a person that a user is connected with. Rather than going through all the list of names, they may just simply enter the first name or last name of a family member into the text box, and click a “Go” button. A list of all names that matched with the keyword will be displayed. Preferably a user may only search their family members and persons that they are connected with.

| | |
|---|---|
| ‘Search By’ textbox | To search a family member or a person, input the |
| | first name or last name on the 'Seatch By' text box. |
| Go button | Click this button to view the sorted results. |

### Relationships

Access to a user's vine may vary depending on the share level set by the user. Family member's share level can vary from, e.g., Immediate; very close; close; fairly close; and not so close. A user may change a family member's share level from time to time by going to: Family Thyme, then to relationships. To use this function, select the name(s) of the family member(s), then choose a share level from the drop down list, then click the edit button. A pop-up message will then appear, notifying that the changes have been successfully made.

| | |
|---|---|
| List of connections | These are the names of your family members or |
| | connections. To select a family member you wish |
| | to modify, tick the check box beside the name. |
| ‘Share level’ | A family member's share level may be changed |
| dropdown list | into immediate, very close, close, fairly close, or |
| | not so close. |
| Edit button | Click this button to commit the changes made. |

### Family Thyme Options Menu

Connected members, Vine, Sent requests, and Pending Invitations can be viewed using this menu. This is also where a Personal Family Tree can be built, wherein you can add, edit, or delete family members to your family tree. User may also view connections by Share level, and also to connect to a member. This option menu includes the following tabs and can be found on the right-side of the page: Personal Family Tree Builder; View connected members; View by Share level; View My Vine; View Sent requests; View Pending Invitations; and Connect to a member.

### View Connected Members

A user may view a list of their Personal Family Tree members, and other connections by clicking this option. The list of names found under the ‘Personal Family Tree’ table are the names of the persons that have been connected to their family tree, or the ones that the users have added to their family tree.

On the other hand, the list of names found under ‘Other connections’ table are the names of the persons they are connected to. A user may also delete a connection in this feature.

### Deleting a Connection

A user can delete a connection from a member, or permanently delete a member from connections. To delete a connection from a member: click ‘View connected members’ tab, and then click the ‘x’ button beside the name of the member they wish to delete.

### View by Share Level

A user may view family members, and connections according to their Share level: immediate; very close; close; fairly close; and not so close. Members are displayed by groups according to Share level, wherein a user may also edit their Share level by clicking ‘Edit Level’.

### Manage Relationship Level

The Share level of a member can be changed using this feature. To manage relationship levels: go to Family Thyme, click the ‘View by Share Level’ tab, and click ‘Edit Level’.

### View My Vine

This is where a user may search with options, and view the posts posted by Personal Family members. There is also the ‘Family Group & Sort Options’ to easily sort the posts made by a Personal Family member which can be sorted by: share level; by Members per Modules; Members or Modules; or by Year.

### Search Options

This makes it easier to search for a specific post by simply inputting the poster name, post content, or title. A user may easily find a post made days, weeks, or years ago by using this feature.

| | |
|---|---|
| Search options textbox | This is where the user inputs the poster name, |
| | post content, or title to search. |
| Search button | Click this button to show the results for search |
| | options |

### Filter Options

This option is another feature under Search Options, wherein a user may filter post results by Name, or by App (All Modules, Journal Thyme, Top Lists, Wish Lists, Their Thyme, Calendar Entry, or Gallery).

| | |
|---|---|
| Show filter options | To expand the filter options: Filter by Name, and |
| | Filter by App |
| Filter by Name | To filter the results by name |
| Filter by App | To filter the results by app: by All Modules, Journal |
| | Thyme, Top Lists, Wish Lists, Their Thyme, |
| | Calendar Entry, or Gallery. |

### View Sent Request

This is where a user can view pending requests, and previously accepted invitations. All pending requests are logged in this list, as wells as the accepted invitations. The user has an option to resend a pending request, or to cancel the request. Logs of accepted invitations can also be removed by the user.

### Resending a Pending Request

A pending request can be resent to a member. To resend a pending request: click the request that you wish to resend; select the options ‘resend’; and click the ‘update’ button.

### Canceling a Pending Request

A pending request to a member can be cancelled. To cancel a pending request: click the request that you wish to cancel; select the options ‘cancel’: and click the ‘update’ button.

### Removing Accepted Invitations

All accepted invitations are logged so that the user can keep track of recent activities. The user also has an option to remove an accepted invitation. To delete an accepted invitation: click the accepted invitation that you wish to remove; select the options ‘remove’: and click the ‘update’ button.

| | |
|---|---|
| ‘Pending Request’ | These are the list of requests that are pending |
| List | to be confirmed. |
| ‘Accepted Invitations’ | These are the list of invitations accepted |
| List | recently and previously. |
| Options | A Pending Request has an option to be resend or |
| | cancelled, while accepted invitations can be |
| | removed. |
| Update button | To commit the action made. |

### Family Thyme

| | |
|---|---|
| View Pending | Lets you view pending request from a user who |
| Invitations | wants to invite you as family member. |
| Notification of | Notifications can be view on messages, shows |
| Pending Invitations | you number of family invite request. |
| List of Invitations | A table that display list of names that send you a |
| | family request. |
| Relationship Status | Lets you select the relationship with the sender. |
| Share Level | Lets you select the level of closeness to the |
| | sender. |
| Accept button | A button that lets you approve family invitation |
| | request. |
| Decline button | A button that lets you reject family invitation |
| | request |
| Connect to member | Lets you send an invitation request to a member. |
| Required fields | When adding a member fields should not leave as |
| | blank, like personal information and vine |
| | information or choosing the relationship status. |
| Submit button | A button that lets you send the request. |

### Viewing Pending Invitations

Pending Invitations can be view in three ways. First, a notification is sent and can be viewed in messages. Second, a number of pending requests are automatically shown on the first page of Family Thyme. Third, in Family Thyme, a “View Pending Invitation” link on the option pane may be clicked to list family invite request(s).

### Accepting Family Invite Request

To accept a family invite request, click pending invitations to display a table showing a list of all requests. Click “View” on the right side of the Name. The name of the sender will be shown, as well as how the user is related to the sender. A relationship status and level of closeness is selected, and the “Accept” button is clicked to display a message that the user is successfully connected.

### Sending Family Invitation

Connecting to a member starts with sending a family invite request. Go to Family Thyme>Connect to Member. Fill out the following fields: First Name; Last Name; Email Address; and Relationship Status. Then choose a level of closeness, and click the “Submit” button. A message will be displayed that you have successfully sent the invitation.

### My Vine

| | |
|---|---|
| Search Option | Lets you search for poster name, post |
| | content or title. |
| Search button | A button that lets you search your entered |
| | keyword. |
| Filter Options | Displayed results can be filtered by Name |
| | and Application. |
| Familt Group & Sort Option | Lets you sort family group in different |
| | options. |
| Choose Family Option | Lets you select a family to displayed on |
| | family tree, it can be your personal family |
| | or family that you've added. |
| Share level | Lets you sort by level of closeness |
| Sort Option | There is three options in sorting, these are: |
| | Members per Modules, Member or |
| | Modules. |
| Year | A button that lets you reject family |
| | invitation request |
| Set Button | A button that lets you sort your selected |
| | options |

### Searching a Poster Name, Post Content or Title

Search options lets a user search for poster name, post content or title. Displayed results can be filtered. To search, go to My Vine, type a keyword and click the “Search” button. Results will be displayed.

### Filtering Displayed Result

Results can be filtered by Name and Application. When results are displayed, click the “Show Filter Option”. If a user wants the results to be filtered by name only, a name of a member is entered, and the “Search” button is clicked. If a user wants the results to be filtered by application only, select an application: Journal thyme; Top List; Wish List; Their Thyme; Calendar Entry and Gallery. Click the “Search” button.

### Family Group and Search Options

It's a sort engine, wherein you have the options to sort family group by the following: Year; Choose a Family (Personal family or family that you've added); Share Level (Level of closeness); or Sort by Member per Modules, Member or Modules. (If Member is set, a family tree will be displayed showing the name of the members and their posts. If Modules is set, a number of posts in a specific application will be displayed. If Member per Modules is set, the name of the member and how many posts they have in a specific application is displayed.) Then click the “Set” button.

### Get Image Function

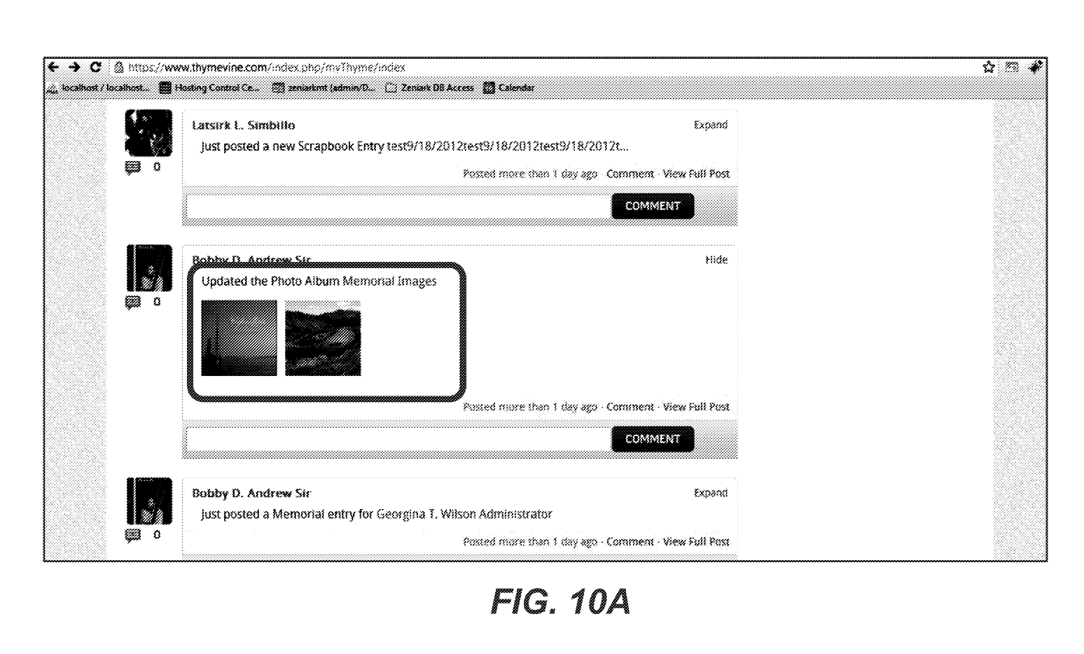

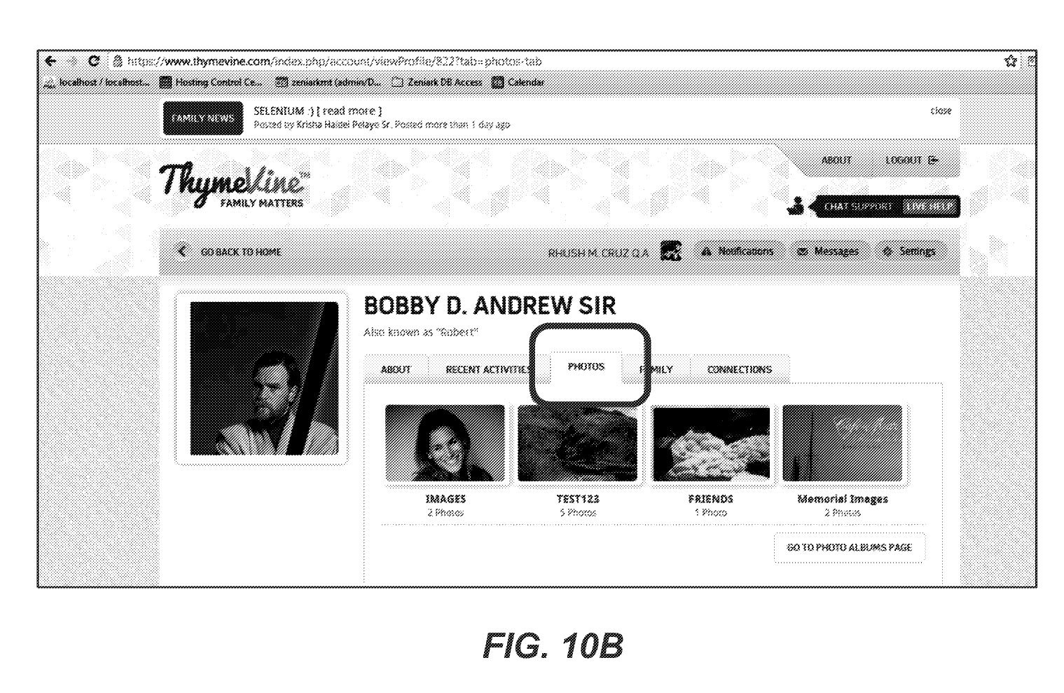

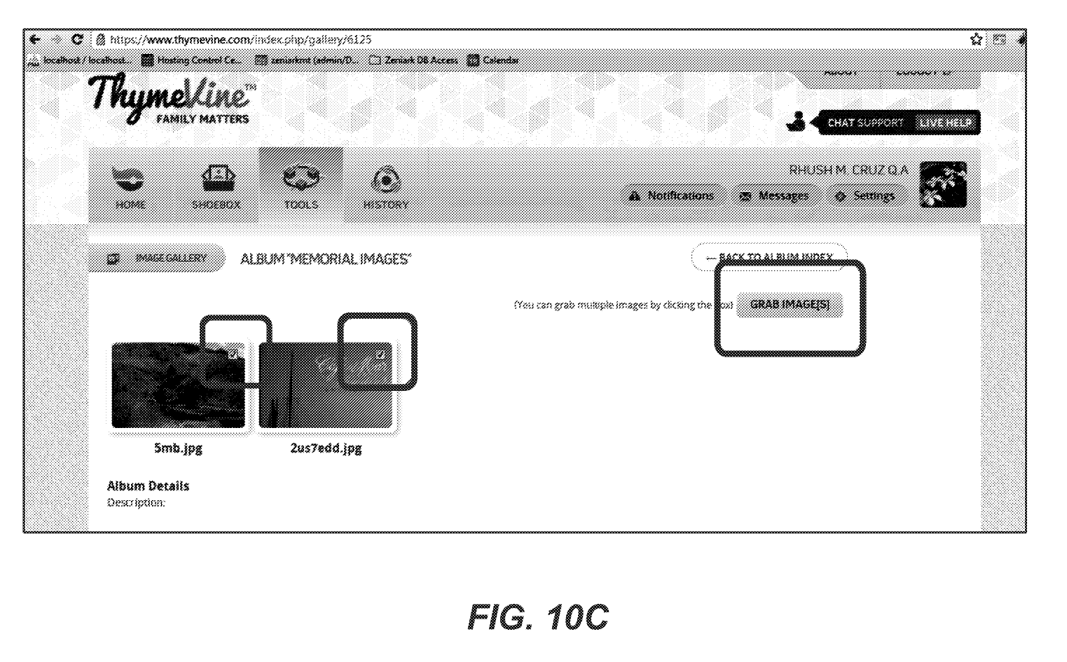

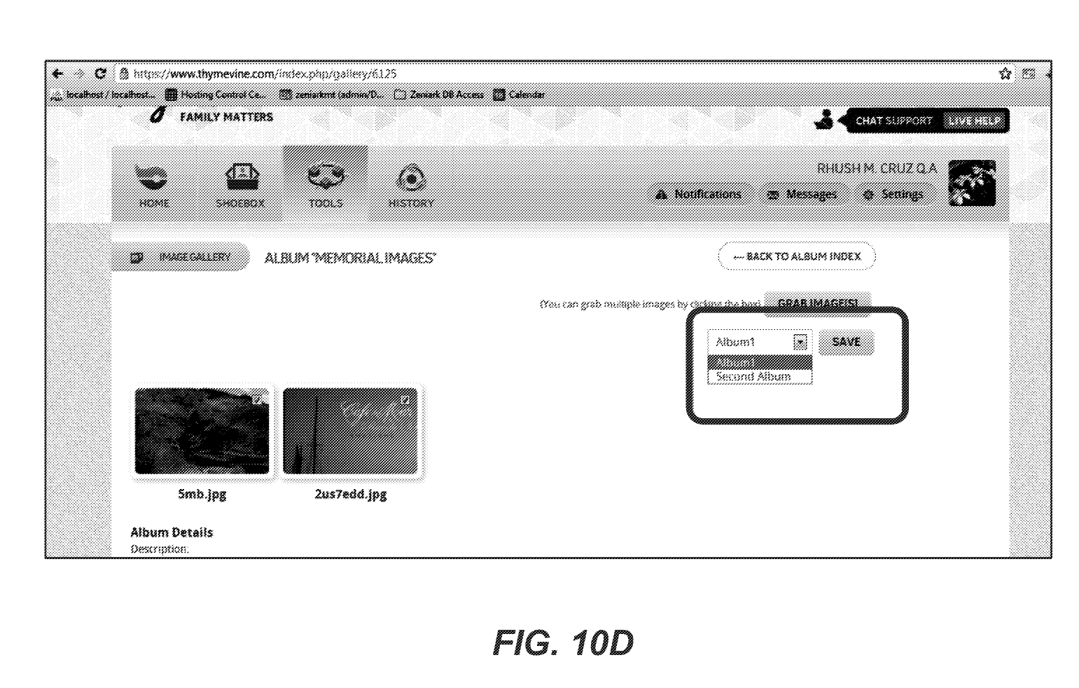

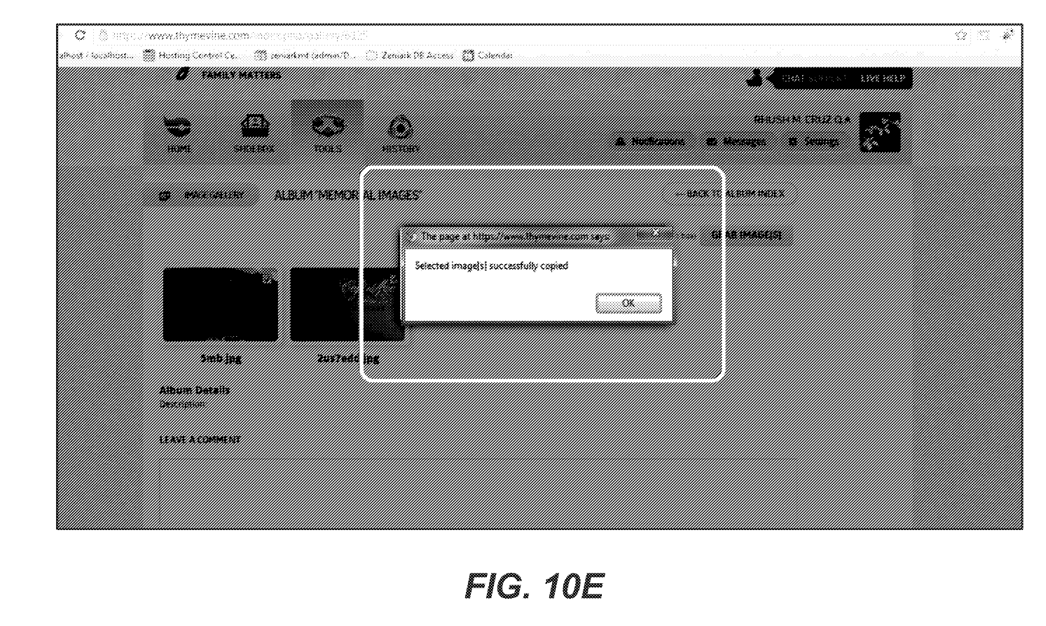

FIGS. 10A to 10E show an exemplary user interface for a GetImage feature, in accordance with the principles of the present invention.

In particular, a Get Image (Grab Image) function in accordance with the principles of the present invention enables a user's device to grab an image or images from a photo gallery or album associated with a connected member. The user can ‘grab’ images from the photo gallery or album associated with the connected member, e.g., from the connected member's wireless device such as a Smartphone, etc., if it is shown on the home page, or go directly to the profile of the connected member.

As shown in FIG. 10A, it the desired image or images (or other type file) is shown on the home page via thumbnail or other descriptive icon, the name of the album may be clicked.

In FIG. 10B, the user can go directly to the profile of the connected member. They do this by clicking the cursor on a “Photos” or similar tab, then the photo albums of the connected member will be displayed to the transferring user. They then click on the name of the desired album that the user is ‘getting’.

In FIG. 10C, the user is redirected to the photo album. The user selects the checkbox of the images that they want to grab or put into their own gallery. The user's device then has its cursor click a “Grab Image(s)” or similar button.

In FIG. 10D, upon clicking the “Grab Image(s)” or similar button, a list of existing albums of the user where they want to save the image(s) is displayed.

In FIG. 10E, a message is displayed indicating if the image(s) were successfully copied. The user selects an “OK” button to clear the message window.

Below explains how an image or images are “grabbed” from a user's Connected Family member's Gallery.

### Homepage>go to Settings>View all Connections

Click and Chose the profile Name of connected member with an existing ThymeVine Account.

From Member's Profile navigation tab, choose and click “Gallery” tab, existing album(s) of connected member will be displayed.

Chose and Click from any of the existing album of your Connected Family Member(s), Photos added on the selected album will be displayed.

Tick the checkbox of the image(s) you want to grab, or to copy on your Gallery.

Click the “Grab Image[s]” button. after clicking the “Grab Image[s]” button, it will display the list of existing album of the connected member. Preferably multiple images may be grabbed on the current page by selecting a suitable box. Checked images from the first and second page preferably can't be grabbed at the same time. Images are preferably only grabbed one page at a time, because once a user devices moves to the next displayed page, images that were marked will be removed.

Select an album, and click “Save” button. If a user device just selects from an existing album and clicks a suitable save button, a message confirming that the image(s) was successfully copied will be displayed.

Click “Ok” button.

Go to Gallery page to View the album of the images being grabbed.

### There is Also an Option to “Add a New Album” for the Image(s).

Select the “Add New Album” from the dropdown list of existing album(s).

Click “Save” button. User is redirected to “Create New album page”.

Fill in the required fields.

Assign “Share Setting”. Importantly, images or other files can be grabbed only from those who have Share permissions set to the user's device, and vice versa. In this important way the Grab It function is primarily related to Share Level.

Click on “Share” button to share it with the connected member's who are included from the Share Level assigned.

Posted Activity can now be viewed on “Recent Activities” on Homepage.

There is a quick way that a user can grab images from other connected members.

### Homepage>Recent Activities

From the posted entry (e.g posted entry from Gallery) shown on the home page's Recent Activity, choose and click the name of the album. The user will then be redirected to the album's Image(s).

Tick the checkbox of the image(s) you want to grab, or to copy on your Gallery.

Click the “Grab Image[s]” button.

After clicking the “Grab Image[s]” button, it will display the list of existing album of the connected member. You can grab multiple images on the current page by clicking the box. Checked images from the first and second page can't be grabbed at the same time. Images can only be grabbed one page at a time, because once the user goes to the next page, images that have been marked will be removed.

Select an album, and click “Save” button. If a user just selected from an existing album and clicked save, a message confirming that the image(s) was successfully copied will be displayed.

Click “Ok” button.

Go to Gallery page to View the album of the images being grabbed.

### There is Also an Option to “Add a New Album” for the Image(s).

Select the “Add New Album” from the dropdown list of existing album(s).

Click “Save” button, User will be redirected to “Create New album page”.

Fill in the required fields.

Assign “Share Setting”.

Click on “Share” button to share it with the connected member's who are included from the Share Level assigned.

Posted Activity can now be viewed on “Recent Activities” on Homepage. If a user created a new album and it was successfully created, it will redirect to the album, and will display the grabbed images.

Below are various use case scenarios for a ThymeVine™ share level network in accordance with the principles of the present invention.

### 1.) Use Case Name: Share Level Access

### Actors:

1. Account User (Has an existing account. Can set the Level of Access for a connected member)
2. Another user (Access to other user's details/post is limited. Access/Share level may vary from immediate, Very close, Close, Fairly Close, Not so Close, to Public)
3. System/ThymeVine (Set limits to the connected member's access of the account user's details/vine)

### Trigger:

Account user wants to post a Journal entry.

### Precondition:

User has Finished the journal entry

### Post-Conditions:

The entry will be placed in the system/list of journal entries

The account user can view the journal entry

The account user may choose the Share level of the entry

### Normal Flow:

1. Account user will Log in, then go to Applications>Journal Thyme.
2. The System will present some categories and sub topics for each category.
3. Account user will select a category and a subtopic to write about.
4. The System will present a form for the journal entry.
5. Account user will fill in the required fields in the form.
6. Account user will set the Share level access of the journal entry.
7. The System will get the Share level of the journal entry.
8. Account user will click the publish button.
9. Other user will try to display the journal entry

10. The System will compare the share level access of the user with the share level of the journal entry.

11. The System will display the journal entry to user if share level matched.

### Alternative Flow:

7A1. If account user wants to modify the Share level access of the journal entry, to keep the journal entry as private as possible.
1. User will determine that journal entries can be edited
2. User will determine which share level access he will change the journal entry into.
3. User will go to Manage Journal entries
4. System will display the list of journal entries
5. User will choose the entry, and commit the action edit
6. System will display the inputted details of the entry
7. User will modify the share level access, from lowest share level access, to the highest share level access
8. System will save the changes made and modify the share level access of the entry
11A1: If the other user's share level access did not match with the Share level access of the journal entry, then the other user can not view the entry.
1. The other user's share level access should be changed to match the share level access required for the journal entry.
2. Account user will determine that he can modify other user's share level access to his details
3. Account user will determine which share level access will allow the other user to access the journal entry
4. Account user will go to Family Thyme
5. The system will display the connected user to account user
6. Account user will select a user, and the new share level.
7. System will save the changes and modify the share level access of the user.
8. The other user will try to display the journal entry again.
9. The System will compare the share level access—matched!
10. The other user can display the journal entry.

### 2.) Use Case Name: Share Level Access—Wish List

### Actors:

1. Account User (Has an existing account. Can create wish list and select share level access.)
2. Another user (User that is connected to account user. Can view post from a connected member based on the different share level: Immediate, Very close, Close, Fairly Close, Not so Close, and to public)
3. System/ThymeVine (Processes posts and limits the access of the connected member.)

### Trigger:

Account user wants to share or post the wish list created.

### Precondition:

Account User has added the list to be post and selected level access on sharing.

### Post-Conditions:

The wish list created will be placed in the system.

The account user will have a displayed list of created entries.

The account user may edit the Share level of the entry.

### Normal Flow:

1. Account user will Log in, then go to Applications>Wish List.
2. The System will present options for the wish list.
3. Account user will create a new wish list entry.
4. The System will present a form for the wish list entry.
5. Account user will fill in the required fields of the form.
6. Account user will add list of wish.
7. Account user will set the Share level access of the entry.
8. Account user will click the publish button.
9. The System will get the Share level of the entry.
10. The System will compare the level of sharing based on the selected level from the list.
11. The System will post the created wish list to the other user if share level access matched.
12. Other user will view the posted wish list.
13. The System will display list the created wish list to the account user with different options.
14. The account user will view and verify the wish list and its access share level.
15. The account user will go back to the main page of Wish List.

### Alternative Flow:

7A1. The account user can modify the created entry. This alternative flow also applies if the user want to change the share level access of the entry.
1. User will verify the list created.
2. User will edit the form.
3. User will change the share level access.
4. User will click the publish button.
5. System will save the changes made by the user.
6. The use case returns to step9 and continues.
3.) Use Case Name: Share Level Access—their Thyme

### Actors:

Account User (Has an existing account. Can create add memorial plan and select share level access.)

Another user (User that is connected to account user. Can view memorial added from a connected member based on the different share level: Immediate, Very close, Close, Fairly Close, Not so Close, and to public)

System/ThymeVine (Processes added memorial plans and limits the access of a connected member.)

### Trigger:

Account user wants to create a memorial plan.

### Precondition:

Account User has added the list to be post and selected level access on sharing.

### Post-Conditions:

The memorial plan added will be placed in the system.

The account user can view the memorial plan added.

The account user may edit memorial plan and the Share level of the entry.

### Normal Flow:

1. Account user will Log in, then go to Applications>Their Thyme.
2. The System will present options for the Their Thyme.
3. Account user will add a new memorial plan.
4. The System will present a form for the memorial plan.
5. Account user will fill in the required and optional fields of the form.
6. Account user will add an image for the entry.
7. Account user will set the Share level access of the entry.
8. Account user will click the Post button.
9. The System will get the Access Share level of the entry.
10. The System will compare the level of sharing based on the selected level from the memorial plan.
11. The System will post the added memorial plan to the other user if share level access matched.
12. Other user will view the posted memorial plan.
13. The System will display list of created memorial plan to the account user with different options (Dedicate e-Flowers, View Gallery, Submit a Photo, Light a Candle, Leave a Testimonial and Edit Information).
14. The account user will view and verify information of the memorial plan and its access share level.
15. The account user will go back to the main page of Their Thyme.

### Alternative Flow:

A1. The account user can modify the added memorial plan. This alternative flow also applies if the user want to change the share level access of the memorial plan.
1. User will view the full page of the memorial plan.
2. User will verify the memorial plan added.
3. User will edit the form and other information about the memorial.
4. User will change the share level access.
5. User will click the Post button.
6. System will save the changes made by the user.
7. The use case returns to step2 and continues.

### 4.) Use Case Name: Share Level Access—My Vine: Sort Options

### Actors:

1. Account User (Has an existing account. Can use the sort engine and sort by access share level.)
2. Sort Option (Arrange family group based on the selected options from the account user)
3. System/ThymeVine (Processes the options selected and displays the result.)

### Trigger:

Account user wants to sort the family group.

### Precondition:

Account User has selected the options to be sort.

### Post-Conditions:

The selected options will be process and sort.

The account user can view the result.

The account user may select another options and sort it again.

### Normal Flow:

1. Account user will Log in, then go to My Vine.
2. The System will present Search Option and Sort Option interface.
3. Search Option was set to All Share level access by default and a family tree graph.
4. Search Option will present a list of dropdown options.
5. Account user will select from the dropdown list (Choose Family, Sort by, Year).
6. Account user will set the Share level access of the entry.
7. Account user will click the Set button.
8. The System will get the selected options from the dropdown list.
9. The System will get the set share level.
10. The System will present a family tree if it is sort by member or a list of activities in an application if it is sort by module.
11. The System will present a result based on selected level of sharing of the user.
12. The Account user will view the displayed result from the Search Option.

### Alternative Flow:

6A1. The account user can change the set access share level. Account user can view different post based on selected options and the set access share level.
1. User will determined the different access share level.
2. User will select from the share level dropdown list.
3. The use cases returns to step 7 and continues

### 5.) Use Case Name: Share Level Access—Lesson Thyme

### Brief Description

This Use Case describes how the Share level of an entry connects with the Share level of Family member.

### Actors:

### 1. Account User

2. Family member (connected to Account user)
3. ThymeVine users (not connected to Account user)

### 4. System (ThymeVine)

### Preconditions:

Account user should create an entry.

Account user should publish his/her entry.

### Basic Flow of Events:

1. The use case begins when the Account user starts to create an entry.
2. The Account user will go to Applications>Lesson Thyme>Create new Lesson Thyme Entry.
3. The System will show a categories to choose with.
4. The Account User will choose a category and click write about this.
5. The System will show the form for lesson thyme.
6. The Account user will fill the fields and set the share level.
7. The Account user will click Post.
8. The System will post the entry on Recent Activities.
9. Family Member can view the posted entry as long as the set share level entry fit in with the set family member share level.
10. ThymeVine users cannot view the entry as long as the share level is not set as Public.

### 11. End of Use Case.

### Alternative Flows

If the Account user missed a required field on the form.

1. The System will prompt an error message.
2. The use case resumes at Step 6.

If the account user wants to post the entry with a selected member only.

1. The Account user should select Group on the share level of an entry.
2. The System will show the field for selecting a family member or group.
3. The Account user will select a family member or an entire group.
4. The use case resumes at Step 6.

### Special Requirements

The System must post the entry on Recent Activities.

Unauthorized family members cannot view the posted entry.

### Preconditions

The user must have a ThymeVine account.

The user must log in.

### Post Conditions

Successfully created an entry.

### 6.) Use Case Name: Share Level Access—They Said It

### Brief Description

This Use Case describes how the Share level of an entry connects with the Share level of Family member.

### Actors

Account User

Family member (connected to Account user)

ThymeVine users (not connected to Account user)

System (ThymeVine)

### Preconditions

Account user should create an entry.

Account user should publish his/her entry.

### Basic Flow of Events

1. The use case begins when the Account user starts to create an entry.
2. The Account user will go to Applications>They Said it!>Create new They Said it! Entry.
3. The System will show the form for the They Said it! Entry.
4. The Account user will fill the fields and set the share level of the entry.
5. The Account user will click the Post button.
6. The System will post the entry on Recent Activities.
7. Family Member can view the posted entry as long as the set share level entry fit in with the set family member share level.
8. ThymeVine users cannot view the entry as long as the share level is not set as Public.

### 9. End of Use Case.

### Alternative Flows

If the Account user missed a required field on the form.

1. The System will prompt an error message.
2. The use case resumes at Step 4.

If the Account user did not publish the entry and save it as draft.

1. The Account user will modify the entry on Pending projects.
2. The use case resumes at Step 5.

If the account user wants to post the entry with a selected member only.

1. The Account user should select Group on the share level of an entry.
2. The System will show the field for selecting a family member or group.
3. The Account user will select a family member or an entire group.
4. The use case resumes at Step 5.

### Special Requirements

The System must post the entry on Recent Activities.

Unauthorized family members cannot view the posted entry.

### Preconditions

The user must have a ThymeVine account.

The user must log in.

### Post Conditions

Successfully created an entry.

### 7.) Use Case Name: Share Level Access—Scrapbooking

### Brief Description

This Use Case describes how the Share level of an entry connects with the Share level of a Family member.

### Actors

Account User

Family member (connected to Account user)

ThymeVine users

System (ThymeVine)

### Preconditions

Account user should create an entry.

Account user should publish his/her entry.

### Basic Flow of Events

1. The use case begins when the Account user starts to create a scrapbook entry.
2. The Account user goes to Applications>Scrapbooking>Create new Scrapbook Entry.
3. The System shows the form for the Scrapbook Entry.
4. The Account user enters the Title, Scrapbook date, and Description.
5. The Account user clicks Next.
6. The System proceed to next step which is scrapbook theme selection.
7. The Account user chooses his/her desired theme for the scrapbook.
8. The Account user clicks Next.
9. The System shows the summary made by Account user.
10. The Account User clicks Start Scrapbook.
11. The Account User begins to design his/her scrapbook and sets the share level.
12. The Account User clicks Save.
13. The System post the scrapbook entry on Recent Activities.
14. Family Member can view the posted entry as long as the set share level entry fit in with the set family member share level.
15. ThymeVine users cannot view the entry as long as the share level is not set as Public.

### 16. End of Use Case.

### Alternative Flows

If the Account user missed a required field on the form.

1. The System will prompt an error message.
2. The use case resumes at Step 4.

If the account user wants to post the entry with a selected member only.

1. The Account user should select Group on the share level of an entry.
2. The System will show the field for selecting a family member or group.
3. The Account user will select a family member or an entire group.
4. The use case resumes at Step 11.

If the account user cancels the procedure.

1. The use case ends with a failure condition.

### Special Requirements

The System must post the entry on Recent Activities.

Unauthorized family members cannot view the posted entry.

### Preconditions

The user must have a ThymeVine account.

The user must log in.

### Post Conditions

Successfully created an entry.

### 8.) Use Case Name: Share Level Access—Contact Thyme (Account User and Family Members Only)

### Actors:

1. Account User (Has an existing account. Access to other user's contact/profile information if family member.)
2. Other users (Access to your contact/profile information—if family member.)
3. System/ThymeVine (Set limits to a user's access of contact information.)

### Triggers:

1. Account user wants to view other user's contact/profile information.
2. Other user wants to view other account user's contact/profile information.

### Precondition:

Users needs to be connected first—same family.

### Post-conditions:

1. The account user can view other user's contact/profile information—if set as family member/connected with each other.
2. The contact/profile information of other user will be accessible to account user—if set as family member/connected with each other.

### Normal Flow:

1. Account user will Log in, then go to Applications>Contact Thyme.
2. The System will display account user's overview of contact information.
3. Account user will select VIEW PROFILE button to view his contact/profile information in full details.
4. Account user will select EDIT PROFILE button to update his contact/profile information.
5. Account user will select CONTACT LIST link button to view the list of other user's contact/profile information—family member/connected with each other.
6. Account user will click a certain family member's name to view his contact/profile information.

### Alternative Flow:

If account user wants to view other user's contact/profile information but not on his list of family member.
1. Account user will connect to other user/add as his family member.

### 9.) Use Case Name: Share Level Access—Name Thyme (Account User Only)

### Actors:

1. Account User (Has an existing account. Access to family members' name on name thyme.)
2. Other users (Family members' name added by account user on name thyme—with or without Thymevine account.)
3. System/ThymeVine (Save account user's family members name on name thyme.)

### Trigger:

Account user wants to add name on his name thyme.

### Precondition:

User has added name on his name thyme.

### Post-Conditions:

The entry will be saved on the system/list of family members' names on Name Thyme.

The account user can view the name thyme entry.

### Normal Flow:

1. Account user will Log in, then go to Applications>Name Thyme.
2. The System will display the list of family member's name.
3. Account user will add name on his name thyme, click ADD NAME.
4. The System will display a form that will allow account user to manage his personal family tree.
5. Account user will add name, click ADD RELATIVE.
6. The System will display a form for name/relative entry.
7. Account user will fill in the required fields in the form.
8. Account user will click the SUBMIT button.

### 10.) Use Case Name: Share Level Access—Thyme Capsule (Account User And Family Members Selected by Account User for Each Thyme Capsule Entry)

### Actors:

1. Account User (Has an existing account. Can set the Level of Access for a connected member.)
2. Other users (Access to other user's thyme capsule. Access/Share level may vary from account user's settings upon creating thyme capsule—YOU or account user can select on the list of his family members/groups.)
3. System/ThymeVine (Set limits provided by account user.)

### Trigger:

Account user wants to create a thyme capsule entry.

### Precondition:

User has Finished the thyme capsule entry.

### Post-Conditions:

1. The entry will be placed in the system/list of thyme capsule entries.
2. The account user can view the journal entry.
3. The account user may choose the Share level of the entry.

### Normal Flow:

1. Account user will Log in, then go to Applications>Thyme capsule.
2. The System will display account user's list of thyme capsule entries.
3. Account user will select CREATE NEW CAPSULE ENTRY button.
4. The System will display a form for the thyme capsule entry.
5. Account user will fill in the required fields in the form.
6. Account user will set the Share level access of the thyme capsule entry/account user will choose among his family members or groups who the thyme capsule is for.
7. Account user will click the POST button.
8. The System will display the thyme capsule entry to other users set/selected by account user.

### Alternative Flow:

If account user wants to modify the Share level access of the thyme capsule entry.
1. Account user will determine that thyme capsule entries can be edited.
2. Account user will go to MANAGE CAPSULE ENTRIES.
3. System will display the list of thyme capsule entries.
4. Account user will choose the entry, and commit the action EDIT.
5. System will display the inputted details of the entry.
6. Account user will modify the share level access from what is desired.
7. System will save the changes made and modify the share level access of the thyme capsule entry.

### 11.) Use Case Name—Personal Family Tree Builder—Link an Account/Connect An Account.

### Actors:

1. ThymeVine User (Has an existing account. Valid Credit Card/can add personal family tree to connect)
2. Guest Account(Has an existing account. Invalid ThymeVine Subscription/No Valid Credit card, access to the thymevine user's details/for viewing purposes only)
3. ThymeVine system(sets limits for 30 Free day Trial/Valid Credit card, No Valid Credit card/viewing only)

### Trigger:

ThymeVine User wants to add personal family tree to connect.

### Precondition:

ThymeVine User done adding personal family tree to connect.

### Post-Conditions:

1. The added family member will be placed in the thymevine system/personal family tree.
2. The ThymeVine User can view the profile of the added member.
3. The ThymeVine User can update the member information of the added member.
4. Thy ThymeVine User can invite the added member to ThymeVine.
5. The ThymeVine User can create ThymeVine Account of the added member.
6. The ThymeVine User can post content (proxy) of the added member.
7. The ThymeVine User can administrate posts of the added member.

### Normal Flow:

1. ThymeVine User will Log in, then go to Family Admin Options>Personal Family Tree.
2. The ThymeVine System will show the personal family tree.
3. ThymeVine User will set family tree for selected member.
4. The ThymeVine System will show the personal family tree added members.
5. ThymeVine User will link/connect to the added members account.
6. ThymeVine User will click the “Connect” button.
7. The ThymeVine System will link/connect the account to the added members and ThymeVine user.

### Alternative Flow:

8A1. If ThymeVine User wants to link/connect an account to the added members in a different way.
1. ThymeVine User will go to Family Thyme>Options: Personal Family Tree.
2. ThymeVine User will Log in, then go to Family Admin Options>Personal Family Tree.
3. The ThymeVine System will show the personal family tree.
4. ThymeVine User will set family tree for selected member.
5. The ThymeVine System will show the personal family tree added members.
6. ThymeVine User will link/connect to the added members account.
7. ThymeVine User will click the “Connect” button.
8. The ThymeVine System will link/connect the account to the added members and ThymeVine user.

### 12.) Use Case Name: Share Level Access—Edit Family News

### Actors:

1. ThymeVine User1 (Has an existing account. Can set share level access for connected member)
2. ThymeVine User2 (Has an existing account. Can access family news/depends on share level from all family members, and selected relatives)
3. ThymeVine System(set limits to the family news who can access)

### Trigger:

ThymeVine user1 wants to post a family news.

### Precondition:

ThymeVine User1 done posting family news.

### Post-condition:

1. The family news will be placed on the system/list of family news ticker.
2. The ThymeVine User1 can view the posted family news.
3. The ThymeVine User1 can update and choose the share level access of posted family news.
4. The ThymeVine User1 can delete the posted family news.

### Normal Flow:

1. ThymeVine User1 will Log in, then go to Family Admin Options>Edit Family News.
2. ThymeVine User1 will fill out all the required fields (*) to news about.
3. ThymeVine User1 will select who can access the news.
4. The ThymeVine System will get the access level/who can view the news.
5. ThymeVine User1 will click “Create” button.
6. ThymeVine User2 will try to view the news.
7. The ThymeVine System will matching up the share level access with thymevine user.
8. The ThymeVine System will display the news to thymevine user if share level is matched.

### Alternative Flow:

9A1. If ThymeVine User2 share level access did not match with share level access of the news, then the ThymeVine User2 cannot view the entry.
1. The ThymeVine User1 must changed the level of the ThymeVine User2 to view the news.
2. The ThymeVine User1 will go to Family Thyme to set share level of ThymeVine User2.
3. The ThymeVine User1 will click “View share level” button.
4. The ThymeVine System will redirects to the manage relationship level.
5. The ThymeVine User1 will edit the level of ThymeVine User2.
6. The ThymeVine System accepts the changes of relationship level.
7A1. If ThymeVine User1 wants to change the share level access of the family news, to keep the news as confidential.
1. ThymeVine User1 will update the news.
2. ThymeVine User1 will go to Manage Family Ticker.
3. ThymeVine User1 will click “Update” button.
4. The ThymeVine System will redirects to the page to update the news.
5. The ThymeVine User1 will change the share level access.
6. The ThymeVine User1 will click “Save” button.
7. The ThymeVine System will save the updated share level access of the news.
8A1. If ThymeVine User1 wants to delete the news, so no one can view the news.
1. User will delete the news.
2. User will go to Manage Family Ticker.
3. User will click “Delete” button.
4. ThymeVine System will delete the news.

### 13.) Use Case Name: Share Level Access—Image Gallery

### Actors:

1. ThymeVine User1 (Has an existing account. Can set share level access for connected member)
2. ThymeVine User2 (Has an existing account. Can access depends on share level from Immediate, Very close, Close, Fairly close, Not so close, Public, and Groups)
3. ThymeVine System(set limits to the album who can access)

### Trigger:

ThymeVine user wants to create a new album and select share level who can view the album.

### Precondition:

ThymeVine User done creating a new album.

### Post-condition:

1. The album will be placed on the system/My Gallery.
2. The ThymeVine User can view the album.
3. The ThymeVine User can add photos or Images.
4. The ThymeVine User can edit and choose the share level access of album.
5. The ThymeVine User can delete the album.

### Normal Flow:

1. ThymeVine User will Log in, then go to Take me to.>My Image Gallery.
2. ThymeVine User will click “Create a New album” button.
3. ThymeVine User will fill out all the required fields(*) to create album.
4. ThymeVine User will select who can access the album.
5. The ThymeVine System will get the access level/who can view the album.
6. ThymeVine User will click “Create Album” button.
7. ThymeVine User2 will try to view the album.
8. The ThymeVine System will matching up the share level access with thymevine user.
9. The ThymeVine System will display the album to thymevine user if share level is matched.

### Alternative Flow:

10A1. If ThymeVine User2 share level access did not match with share level access of the album, then the ThymeVine User2 cannot view the entry.
1. ThymeVine User1 must changed the level of the ThymeVine User2 to view the album.
2. The ThymeVine User1 will go to Family Thyme to set share level of ThymeVine User2.
3. The ThymeVine User1 will click “View share level” button.
4. The ThymeVine System will redirects to the manage relationship level.
5. The ThymeVine User1 will edit the level of ThymeVine User2.
6. The ThymeVine System accepts the changes of relationship level.
7A1. If ThymeVine User wants to change the share level access of the album, to keep the album as confidential.
1. ThymeVine User will edit the album.
2. ThymeVine User will click the album.
3. ThymeVine User will click “Edit” button.
4. The ThymeVine System will redirects to the page to update album.
5. The ThymeVine User will change the share level access.
6. The ThymeVine will click “Update Album” button.
7. The ThymeVine System will save the updated share level access of album.
8A1. If ThymeVine User wants to delete the album, so no one can view the album.
1. ThymeVine User will delete the album.
2. ThymeVine User will go to My Gallery.
3. ThymeVine will check the album, and click “Delete” button.
4. ThymeVine System will delete the album.

### 14.) Use Case Name: Share Level Access—My Groups

### Actors:

1. ThymeVine User1 (Has an existing account. Can create groups)
2. ThymeVine User2 (Has an existing account. Can access group post)
3. ThymeVine System (set limits to the groups)

### Trigger:

ThymeVine user1 wants to create groups.

### Precondition:

ThymeVine User1 is done creating groups

### Post-conditions:

1. The Group is added on the system/list of Groups.
2. The ThymeVine User1 can view the group members.
3. The ThymeVine User1 can edit group name.
4. The ThymeVine User1 can delete group/group member.

### Normal Flow:

1. ThymeVine User1 Logs in, then goes to Take me to.>My Groups.
2. The ThymeVine System redirects when creating groups.
3. The ThymeVine User1 enters Group name and clicks “Create” button.
4. The ThymeVine User drags the member to the group.
5. The ThymeVine System adds the member to the group.

### Alternative Flow:

6A1. If ThymeVine User2 share level access did not match with the group selected, then the ThymeVine User2 cannot view the post.
1. The ThymeVine User1 must add the ThymeVine User2 to the group.
2. The ThymeVine User1 will drag the member to the group.
3. The ThymeVine System will add the member to the group.
4A1. If ThymeVine User1 wants to delete the groups/group member, so the group cannot view the post.
1. ThymeVine User1 deletes the group/members group.
2. ThymeVine clicks “Delete” button.
3. ThymeVine System deletes the groups.

FIGS. 10A to 10E show a grab images, or grab it, feature of shared networking, in accordance with the principles of the present invention.

The present invention comprises a Scrapbook social network that enables a user to build graphically stunning digital scrapbooks for documenting cherished family moments and significant life events. In accordance with the principles of the present invention, users may collaborate with connected family members and/or friends to build a scrapbook. A user may also instantaneously share a scrapbook post or entry with connected family members and/or friends over a shared network connection (e.g. the Internet).

FIGS. 11A-1 to 11A-4 and 11B-1 to 11B-4 show an architectural structure of an exemplary embodiment of a scrapbook networking feature, in accordance with the principles of the present invention.

In particular, as detailed in FIGS. 11A-1 to 11A-4 and 11B-1 to 11B-4, the inventive scrapbooking feature enables a plurality of users to collaborate to create a unique scrapbook entry.

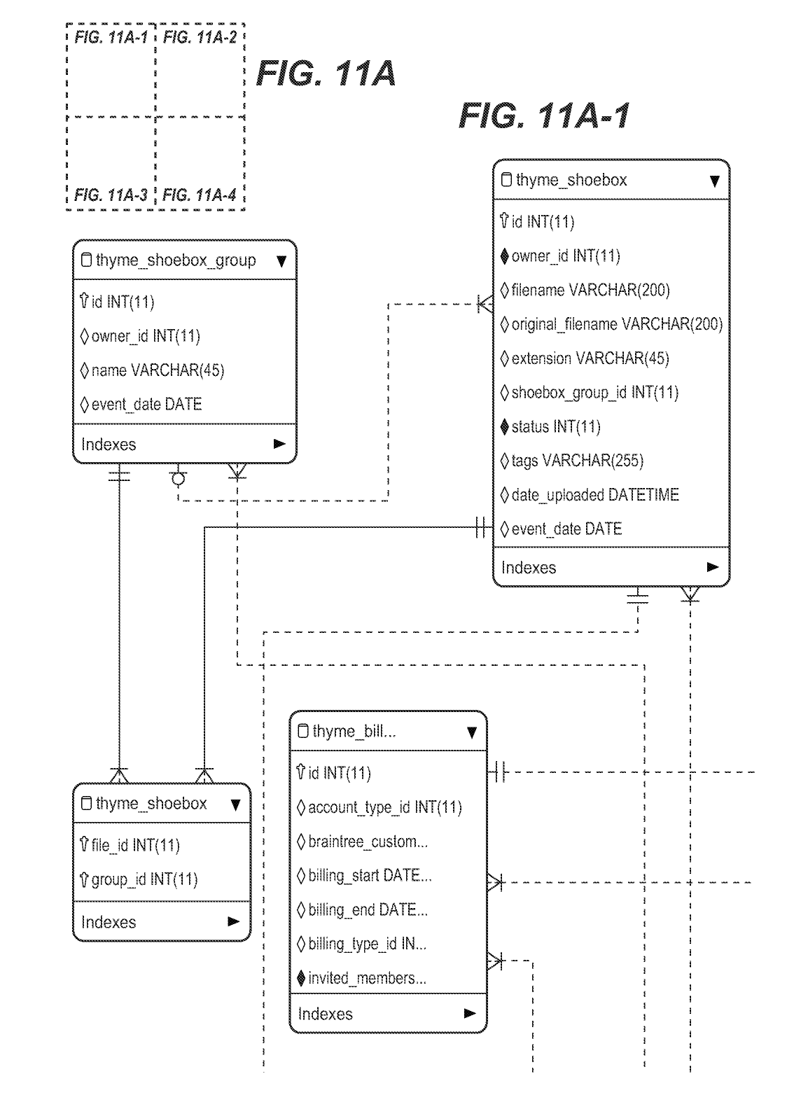

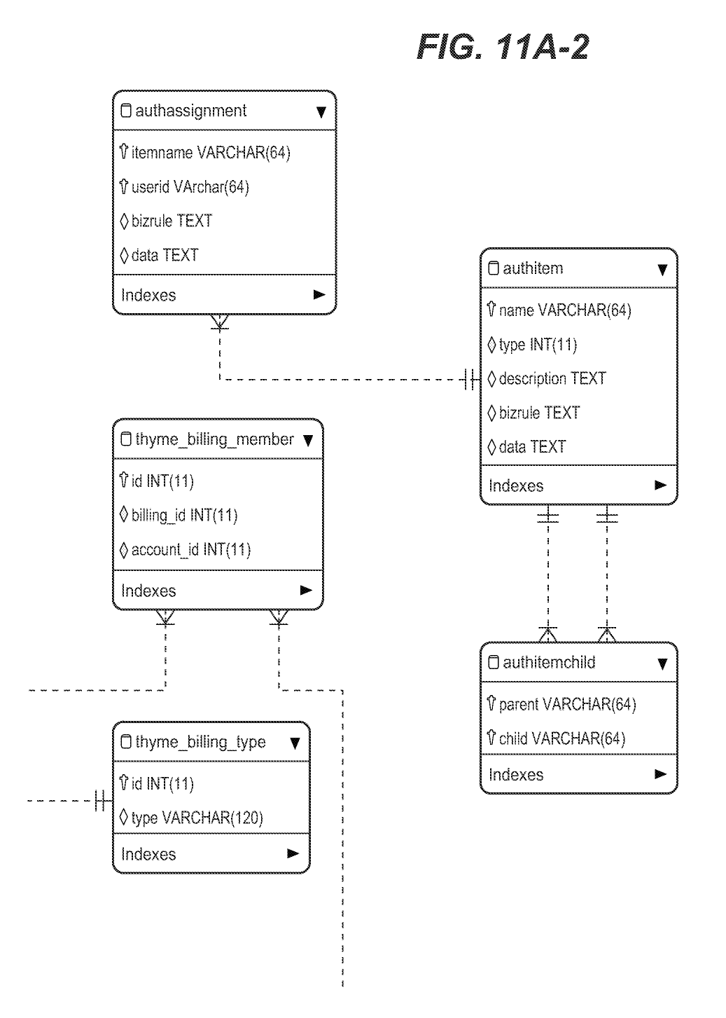

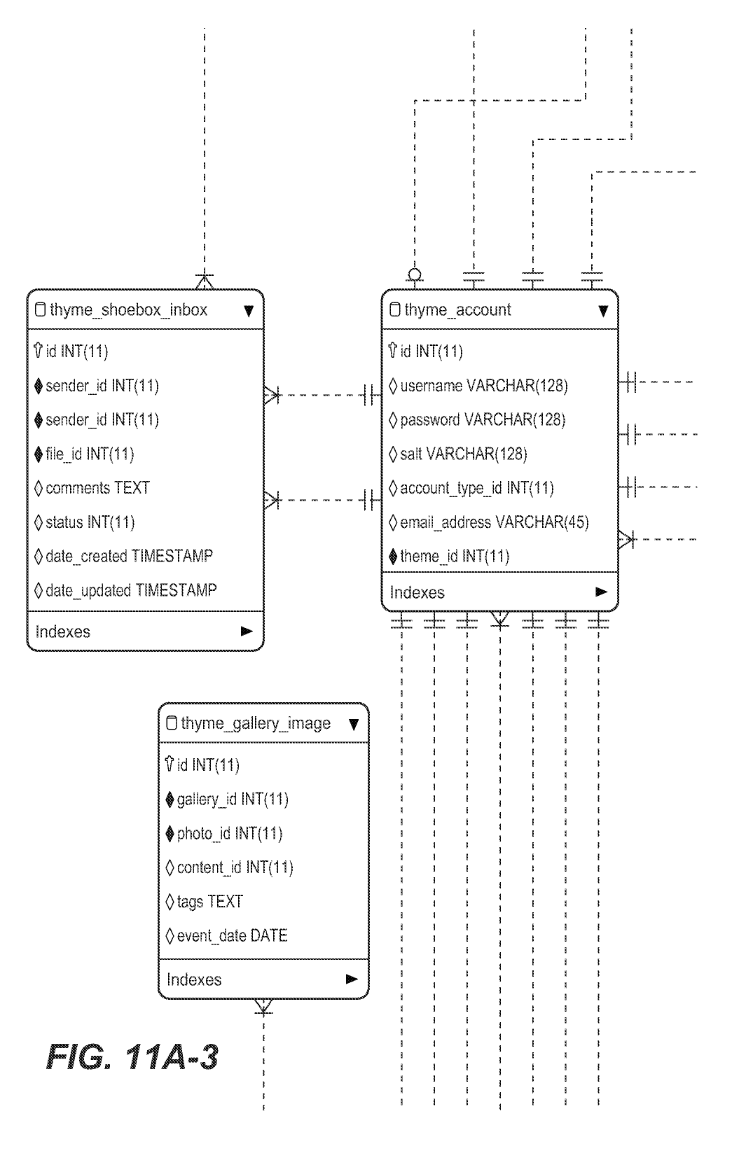

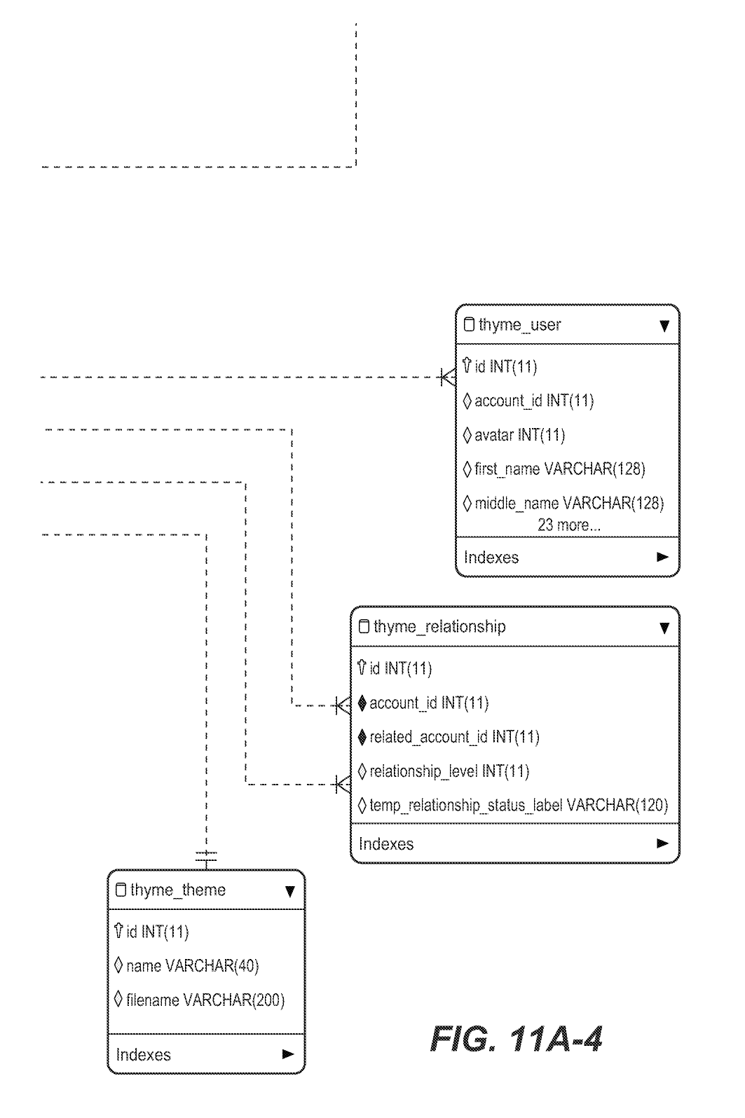

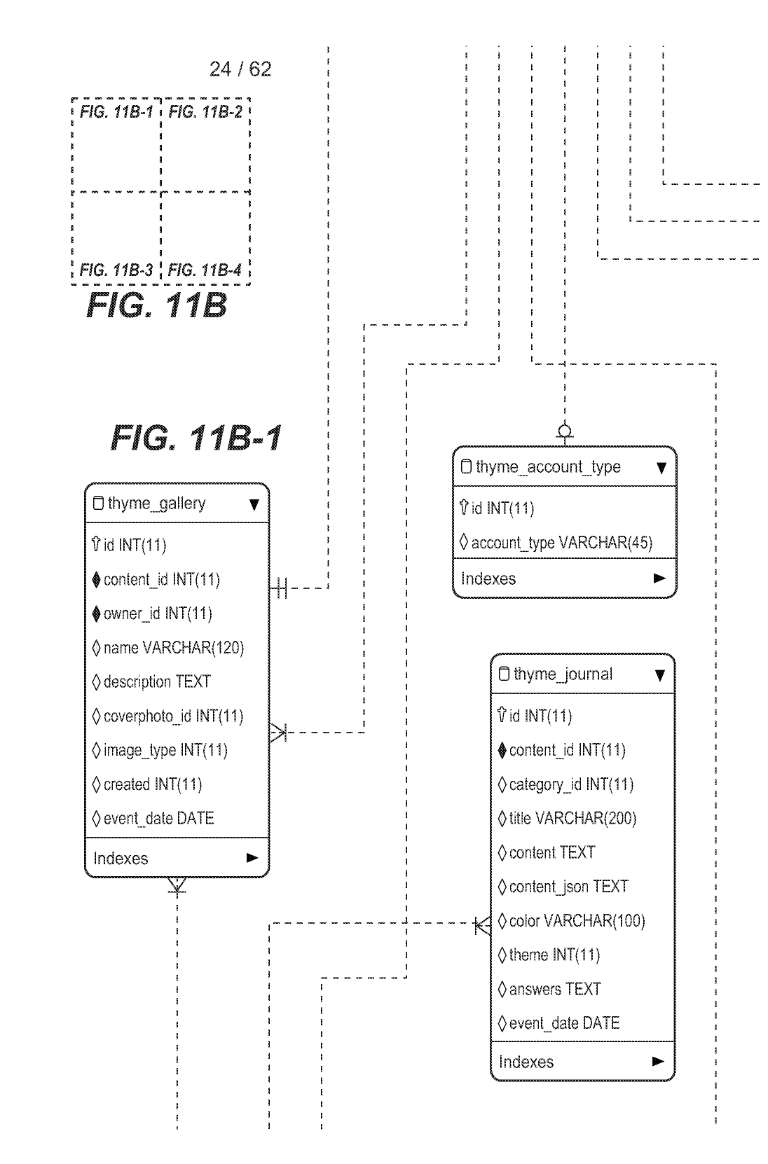

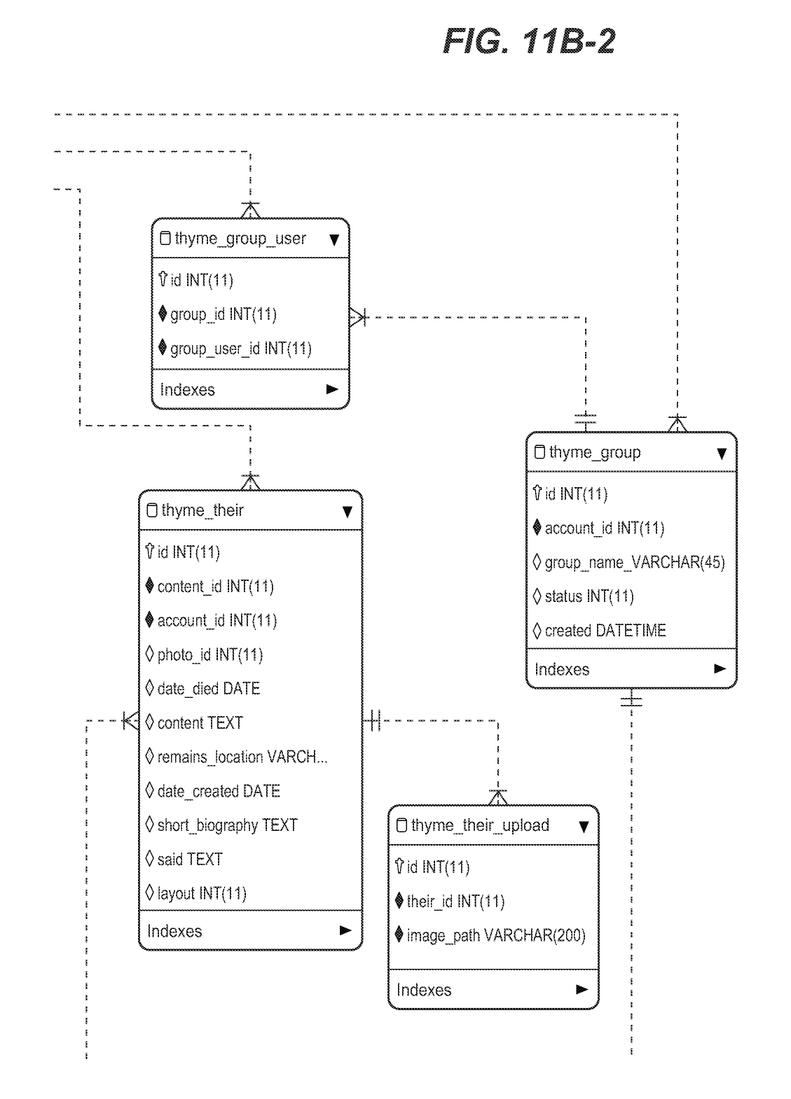

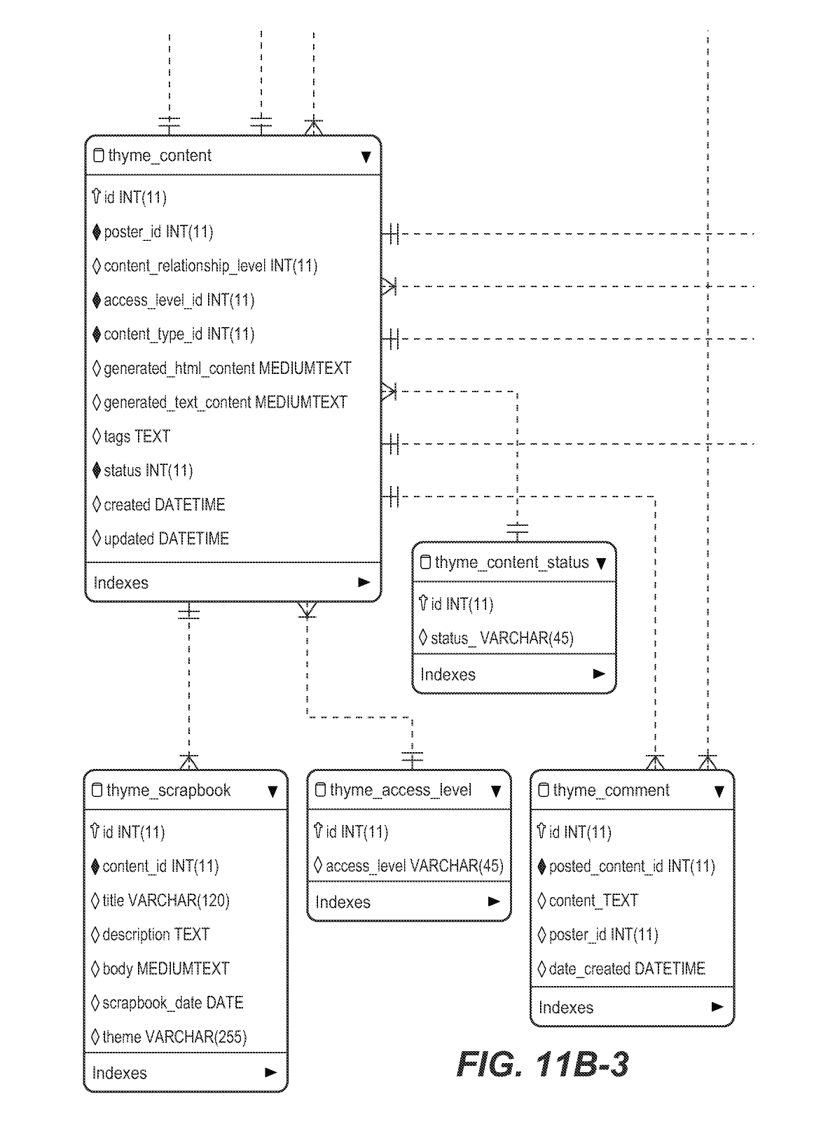

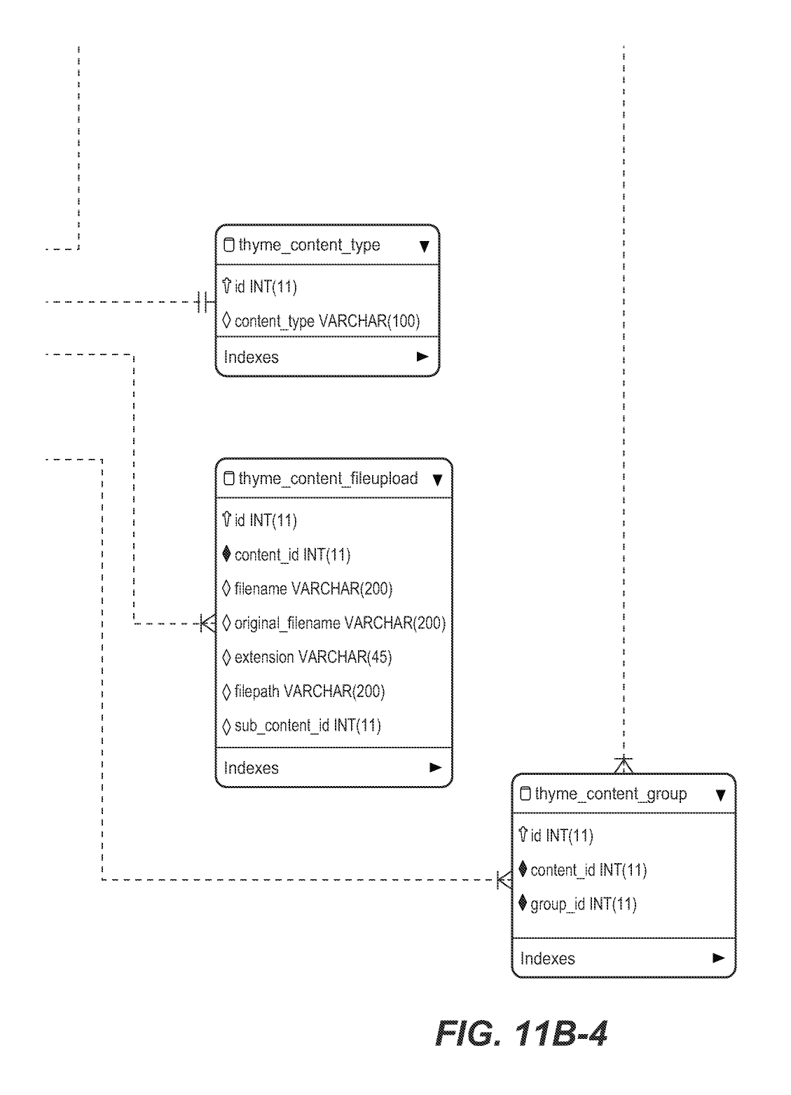

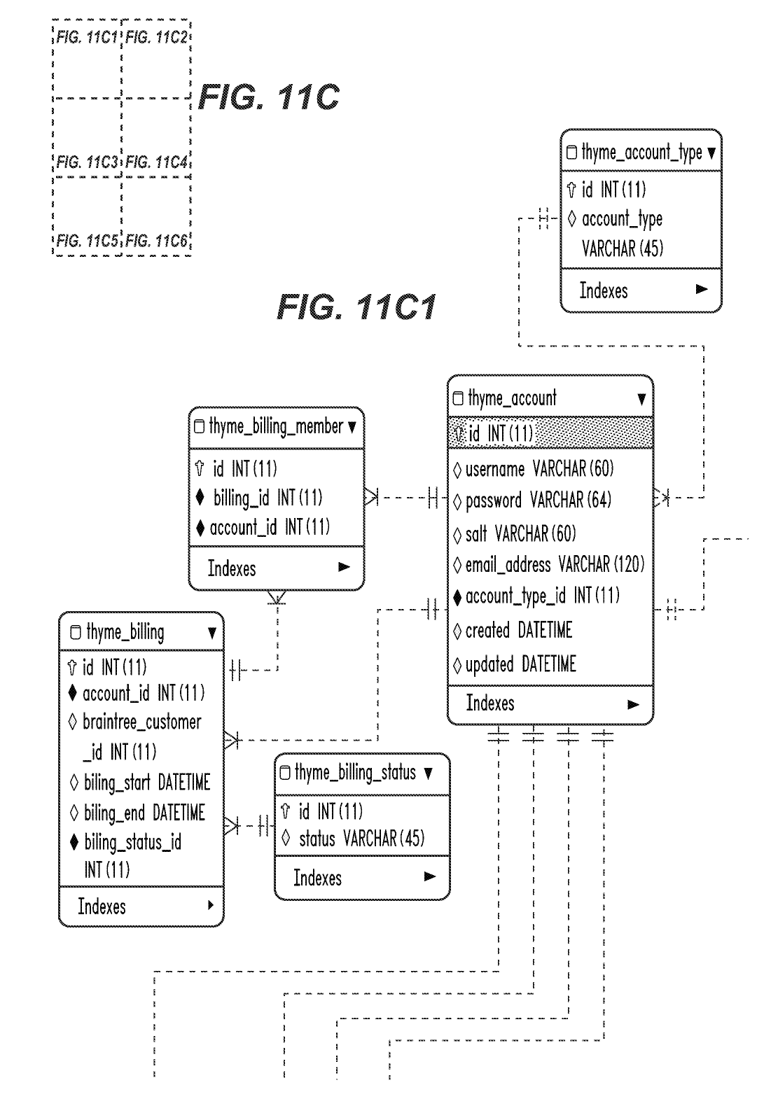

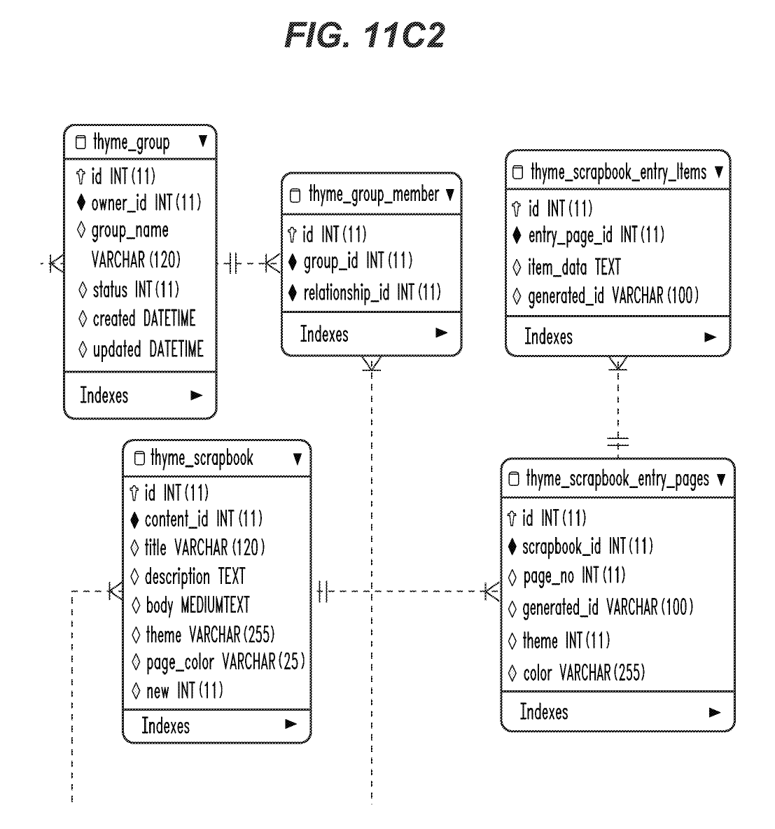

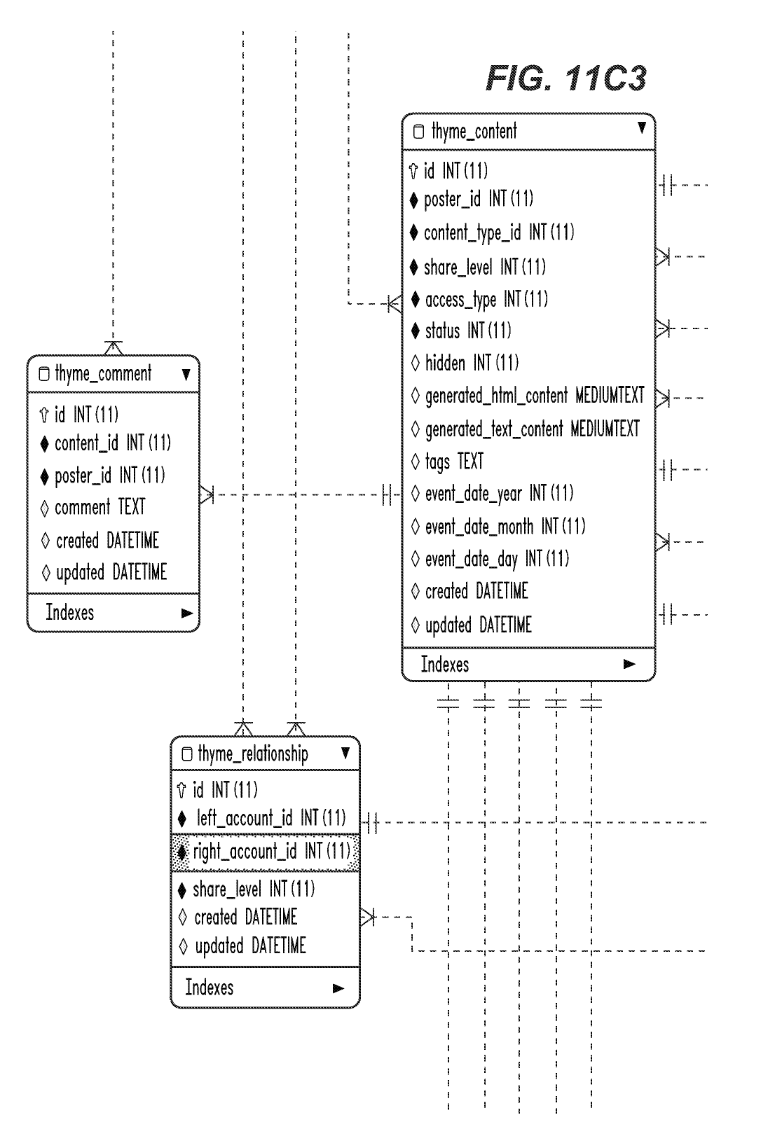

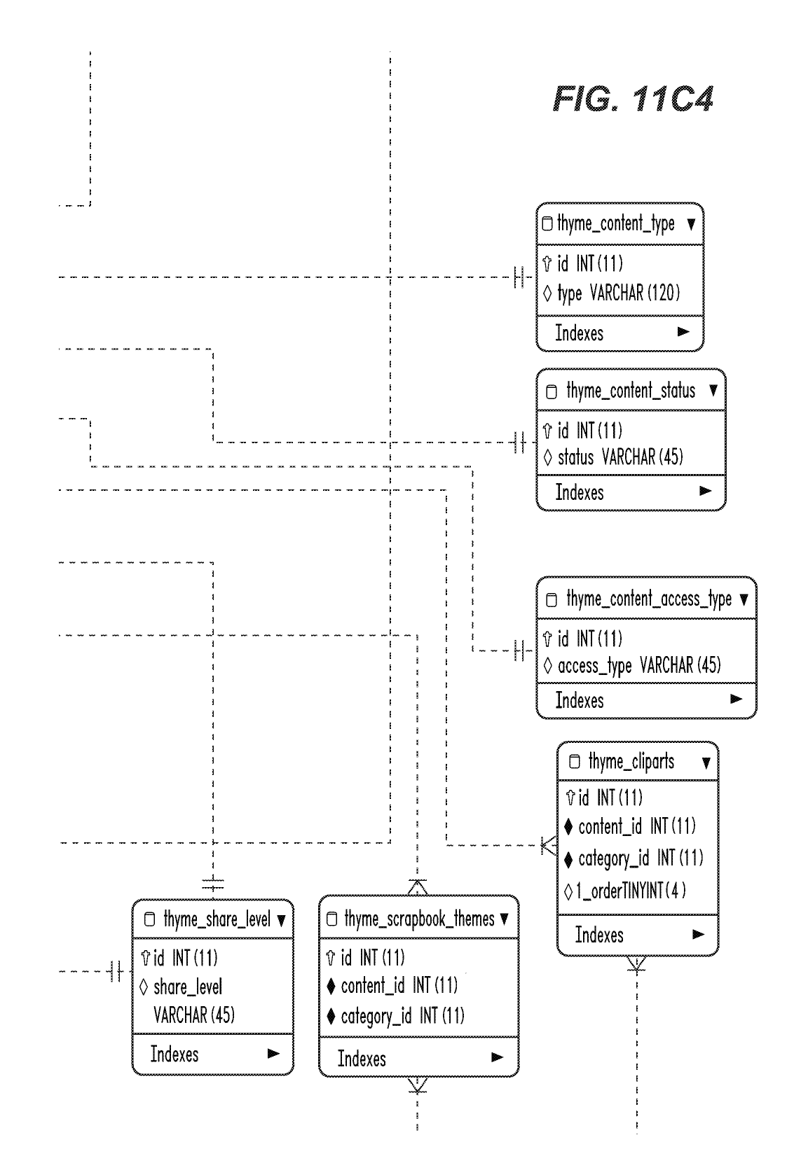

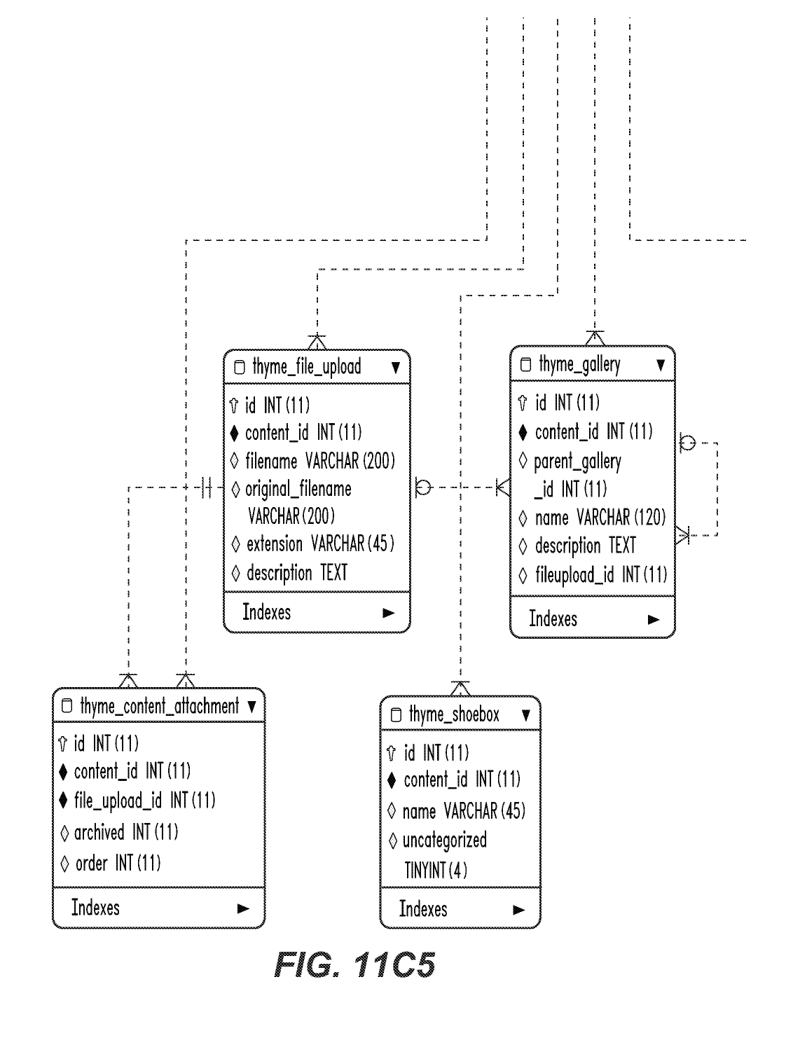

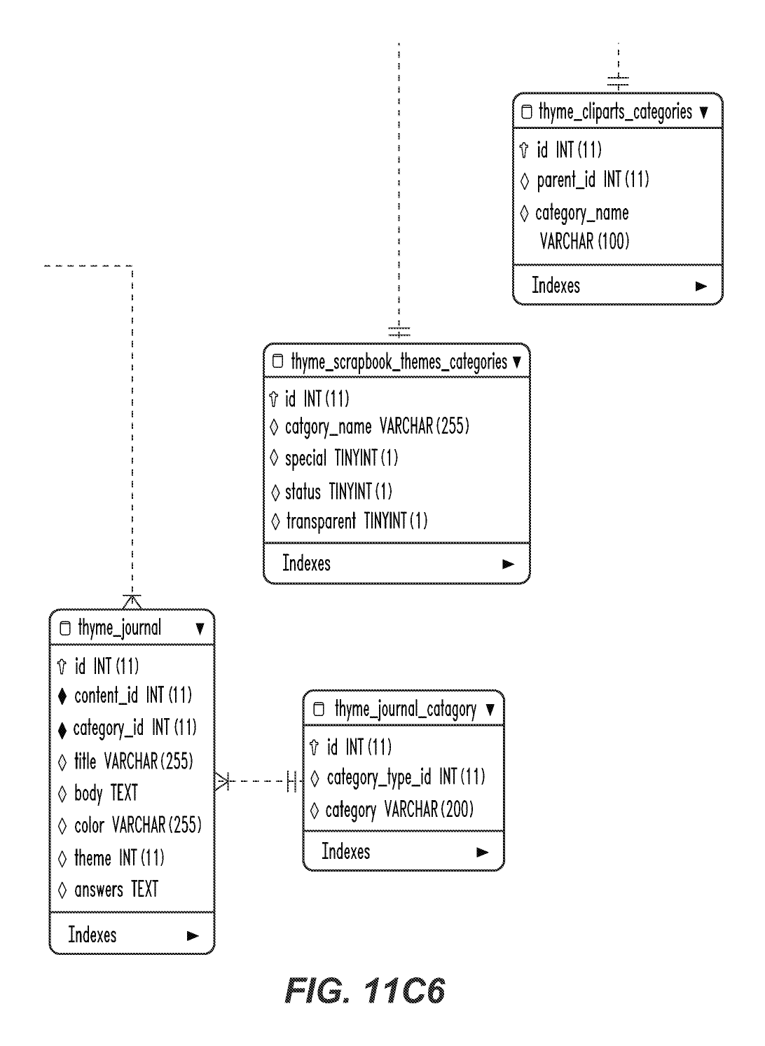

FIGS. 11C1 to 11C6 show the architectural structure of another exemplary embodiment of a scrapbook networking feature, in accordance with the principles of the present invention.

As depicted in FIGS. 11C1 to 11C6, billing administrators and billing members can use scrapbook tools to build and share a scrapbook entry with connected family members and friends.

A scrapbook entry can be created, viewed, and managed using an options menu. An options menu includes the following tabs: add a new entry, drafts and entries, and shared entries.

In accordance with the principles of the present invention, a user navigates to a scrapbook homepage on an inventive user device interface and clicks on an “Add a New Entry” button to begin a new scrapbook entry. When the “Add a New Entry” button is selected, a popup textbox appears on the user device interface and prompts the user to enter a scrapbook cover title. The user must enter a scrapbook cover title to continue building a new scrapbook entry.

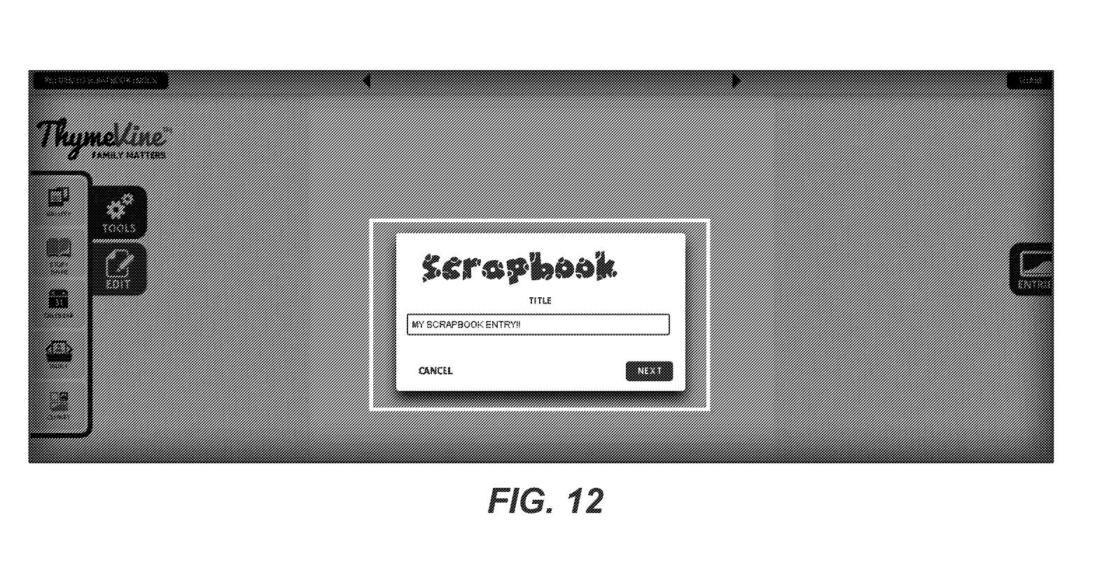

FIG. 12 depicts an exemplary graphical user interface for a scrapbook cover title entry feature of scrapbooking, in accordance with the principles of the present invention.

In particular, to create a new cover title, a user must enter a cover title into a title entry popup textbox and select a ‘next’ button to save changes. Once a cover title has been entered, the user is directed to a background customization textbox. If a ‘cancel’ button is selected on the title entry popup textbox, the scrapbook entry is terminated.

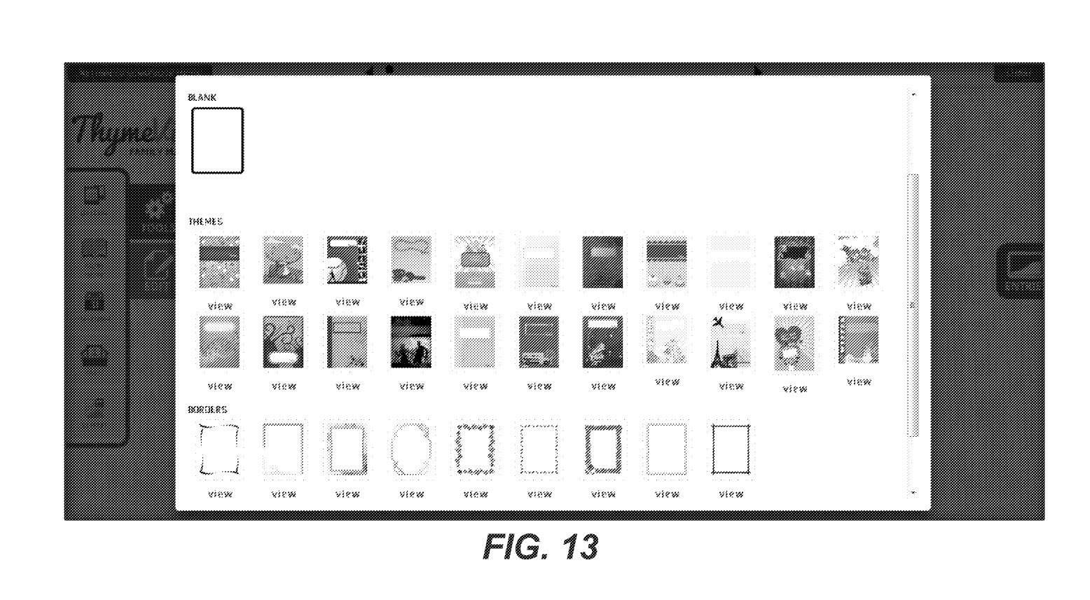

FIG. 13 depicts an exemplary graphical user interface for a scrapbook background customization feature of scrapbooking, in accordance with the principles of the present invention.

In particular, a background customization textbox displays colors, themes, and borders that may be applied to a background of a scrapbook page. To customize the background of a scrapbook cover page, a user selects a theme, color, and/or border from the background customization textbox and then selects a ‘next’ button.

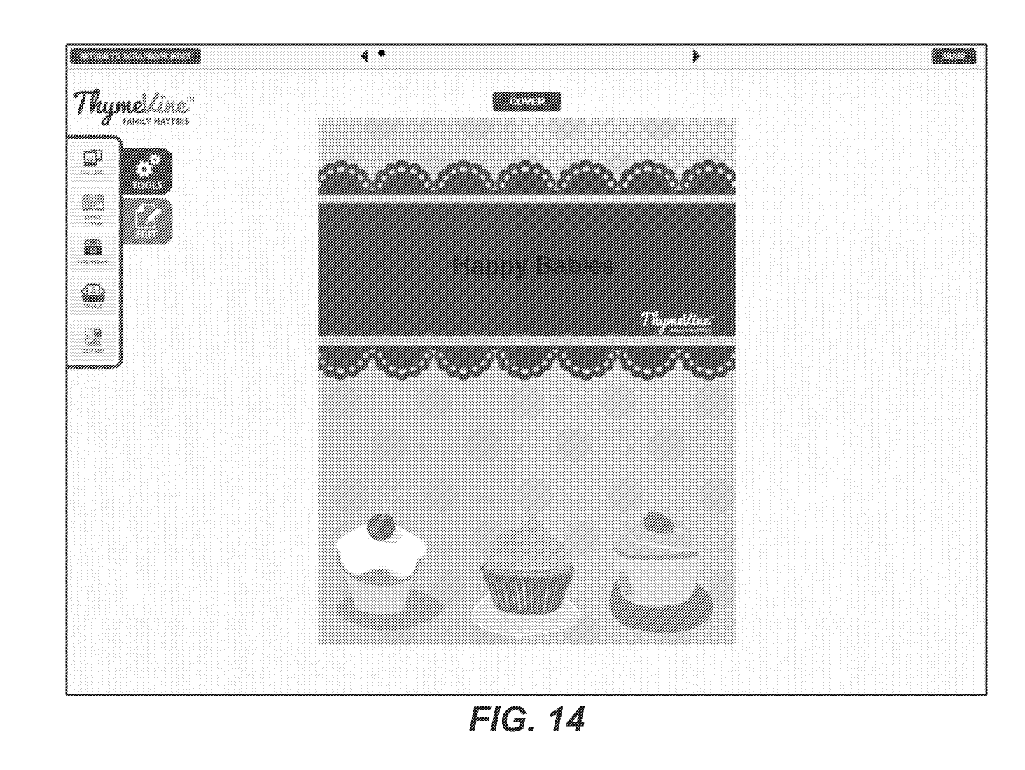

FIG. 14 depicts an exemplary scrapbook cover page, in accordance with the principles of the present invention.

Once a user navigates away from a background customization textbox, a scrapbook cover page with a user-defined cover title and selected background customization settings is generated and displayed on the user device interface. If a user does not select a theme, color, or border from the background customization textbox, the background of the scrapbook cover page is white.

Once a new scrapbook entry is started, a user can edit a scrapbook entry by grabbing content and images from other tools or using scrapbook tools.

In accordance with the principles of the present invention, an edit toolbar can be used to customize a scrapbook entry. An edit toolbar can be accessed by double clicking on an edit icon on the user device interface.

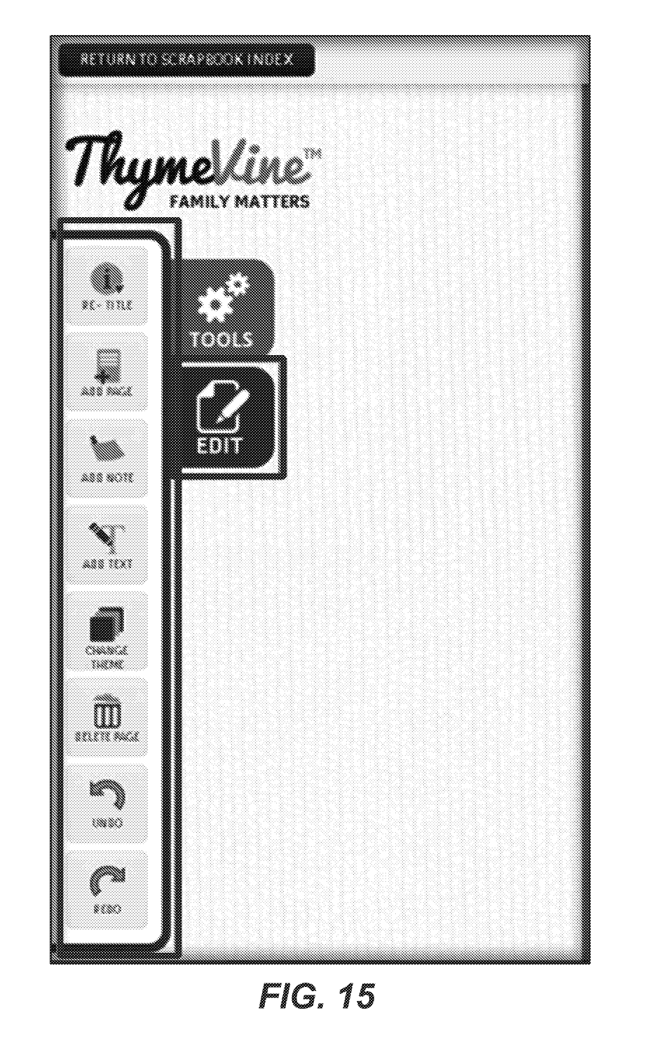

FIG. 15 depicts an exemplary graphical user interface for an edit toolbar for scrapbooking, in accordance with the principles of the present invention.

In particular, an edit toolbar comprises the following tools: re-title, add page, add note, add text, change theme, delete page, undo and redo.

The re-title tool on the edit toolbar can be used to modify a scrapbook cover title.

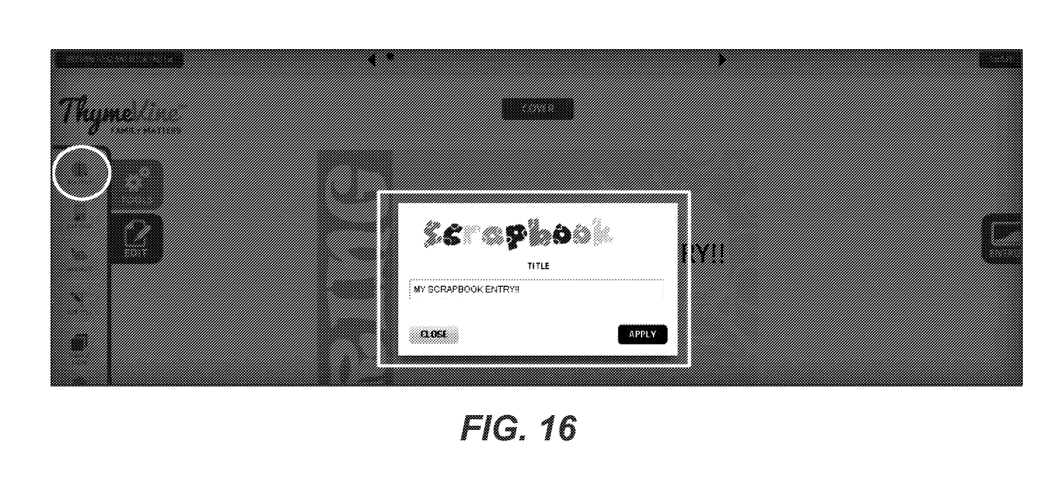

FIG. 16 depicts an exemplary graphical user interface for a cover title modification feature of scrapbooking, in accordance with the principles of the present invention.

In particular, to update the cover title of a scrapbook entry, a user must click the re-title tool on the edit toolbar, enter a new scrapbook title into a re-title textbox, and click an ‘Apply’ button to save changes. Selecting a ‘cancel’ button on the re-title textbox causes the re-title text box to close, and changes are not saved.

The ‘add page’ tool on the edit toolbar can be used to add pages to a scrapbook.

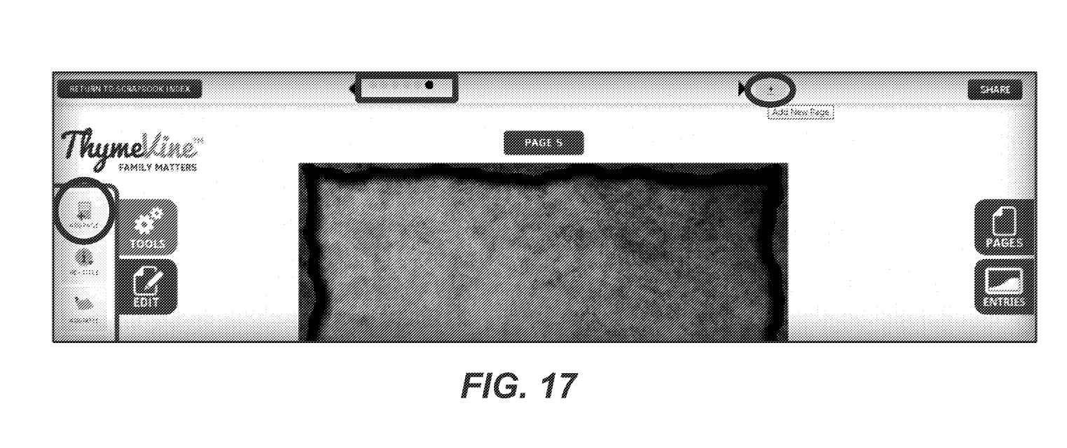

FIG. 17 depicts an exemplary graphical interface for an add a page feature of scrapbooking, in accordance with the principles of the present invention.

In particular, to add a new page to a scrapbook, a user must click on the ‘add page’ button on the edit toolbar (or an ‘add new page’ quick button on the user device interface). Clicking the ‘add page’ tool (or the ‘add new page’ quick button) causes a new page to be added to the end of a scrapbook and the number of pages in the scrapbook to be automatically incremented. Added pages with module contents and images are automatically saved once placed on a scrapbook.

The ‘add note’ button on the edit toolbar allows a user to add a note (i.e., a post-it-note, a sticky paper image) to a scrapbook page.

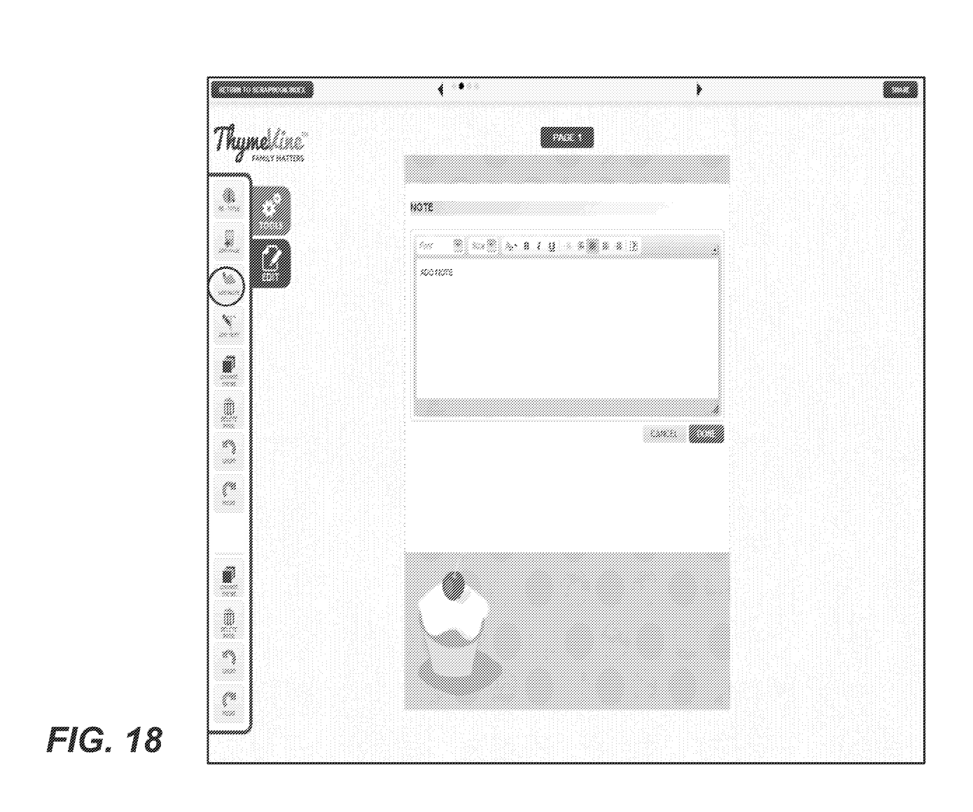

FIG. 18 depicts an exemplary graphical interface for an add a note feature of scrapbooking, in accordance with the principles of the present invention.

In particular, to add a yellow post-it note to a scrapbook page, a user must click on the ‘add note’ tool on the edit toolbar, insert desired text into a text editor, and click a ‘done’ button on an add note popup textbox to save changes. In accordance with the principles of the present invention, note content is limited to a maximum of 300 characters (character limit may vary when note text is customized). A note is not resizable.

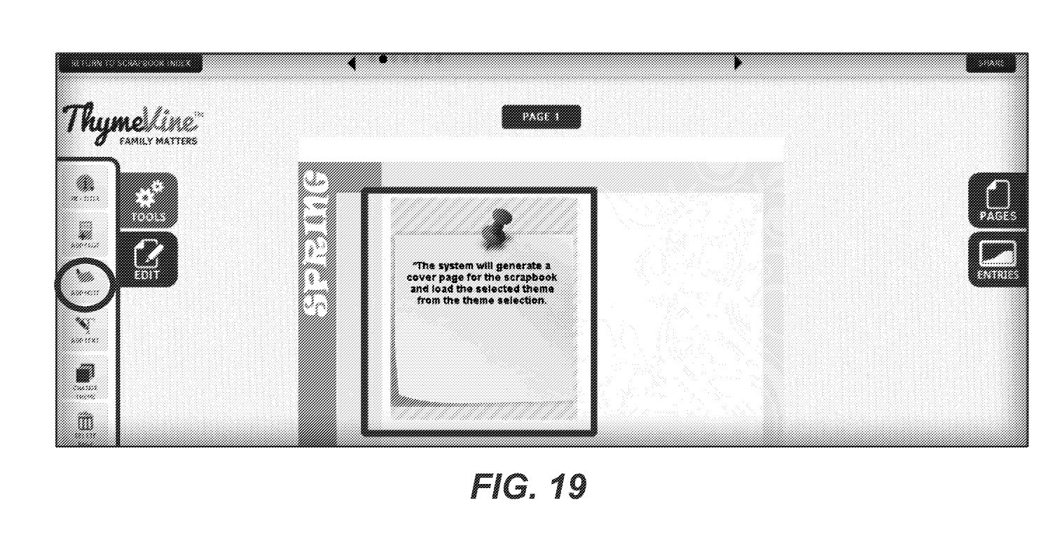

FIG. 19 depicts an exemplary note on a scrapbook page, in accordance with the principles of the present invention.

The ‘add text’ tool on the edit toolbar allows a user to add text to a scrapbook page.

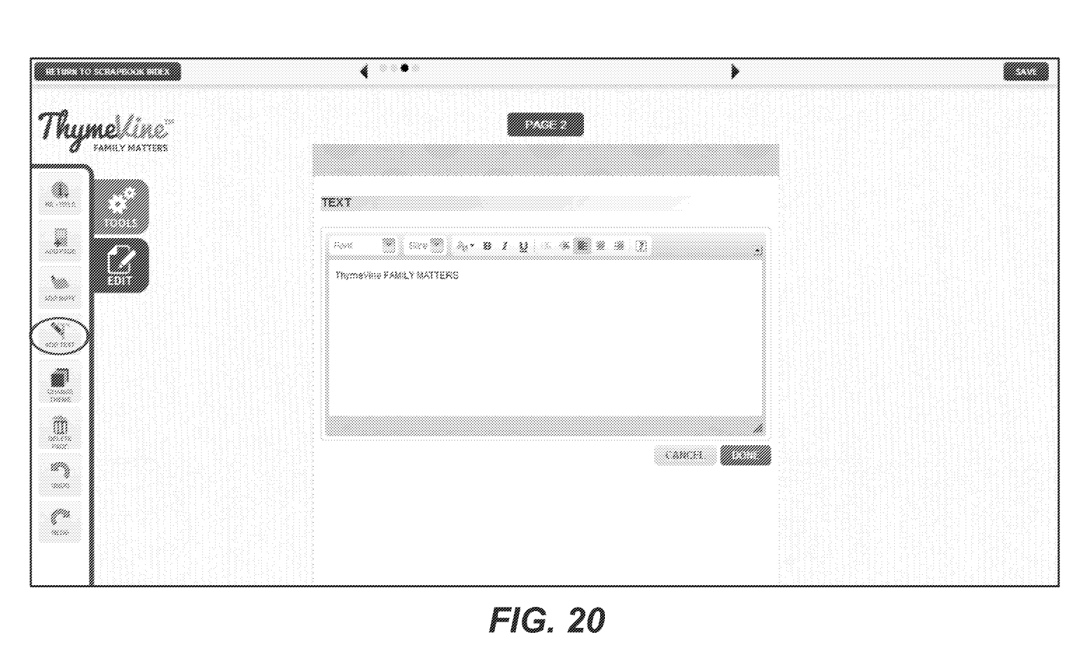

FIG. 20 depicts an exemplary graphical user interface for an add text feature of scrapbooking, in accordance with the principles of the present invention.

In particular, to add text to a scrapbook page, a user must click on the ‘add text’ icon on the edit toolbar, insert desired text into a popup text editor, and click ‘done’ on an add text popup textbox to save changes. If a user selects a ‘close’ button on the add text textbox instead of the ‘done’ button, the pop up text editor closes and text is not added to the scrapbook page.

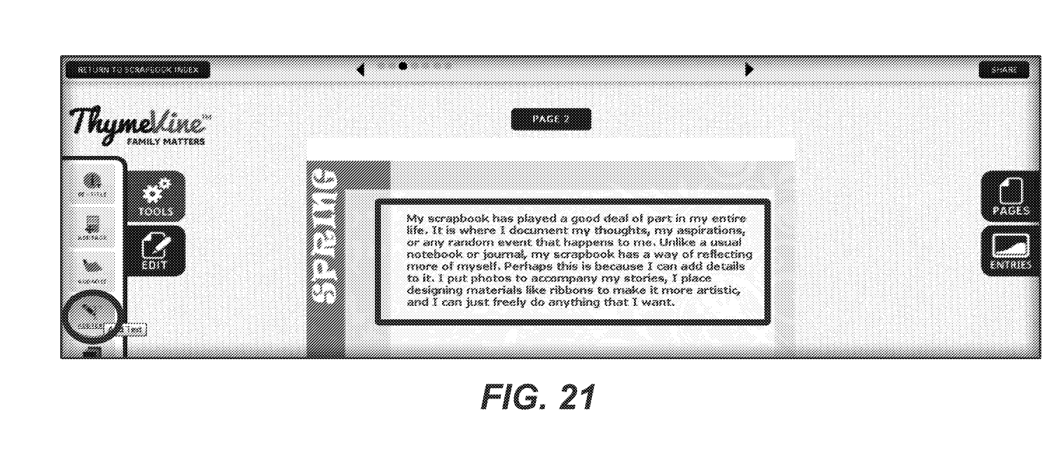

FIG. 21 depicts exemplary text on a scrapbook page, in accordance with the principles of the present invention.

In accordance with the principles of the present invention, the ‘change theme’ tool on the edit toolbar can be used to change the theme of an entire scrapbook or the theme of an individual scrapbook page.

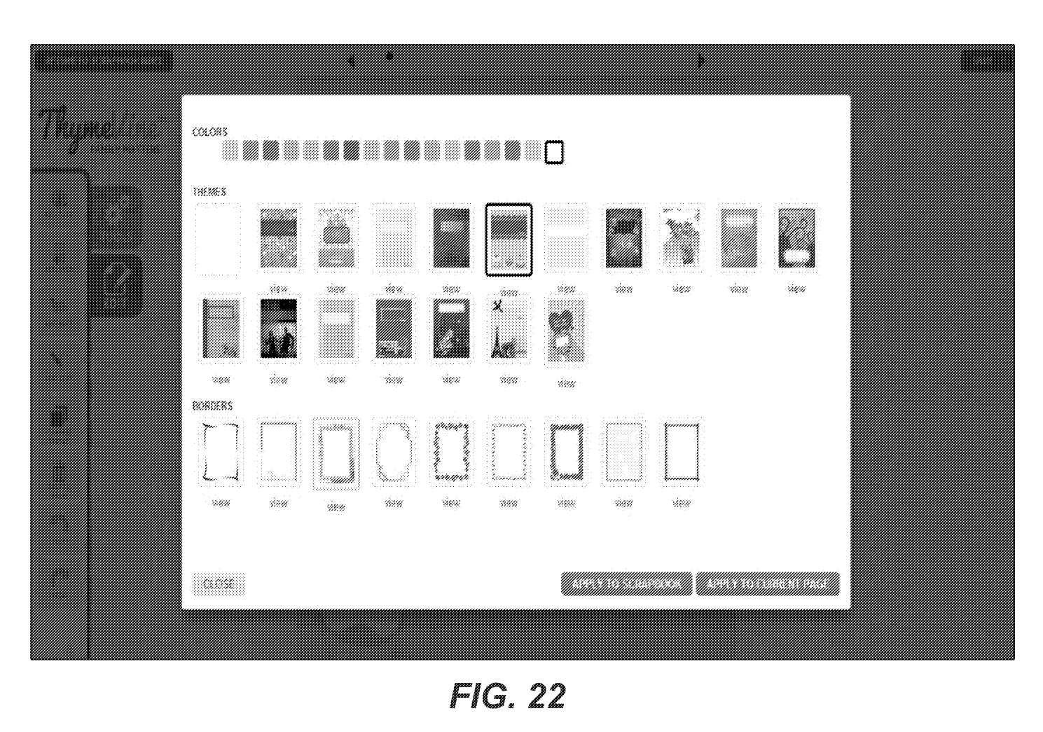

FIG. 22 depicts an exemplary graphical user interface for a change theme feature of a scrapbooking, in accordance with the principles of the present invention.

As depicted in FIG. 22, selecting the ‘change theme’ tool on the edit toolbar causes a background customization popup box to appear on the user device interface. To change the theme of a scrapbook page, a user must select a desired theme, color, and/or border from the background customization popup box and click an ‘apply to current page’ button. To change the theme of an entire scrapbook, a user must select a desired theme, color, and/or border from the background customization popup box and click an ‘apply to scrapbook’ button. Only one theme or border may be selected for a given scrapbook/scrapbook page. Likewise, only one color may be selected for a given scrapbook/scrapbook page.

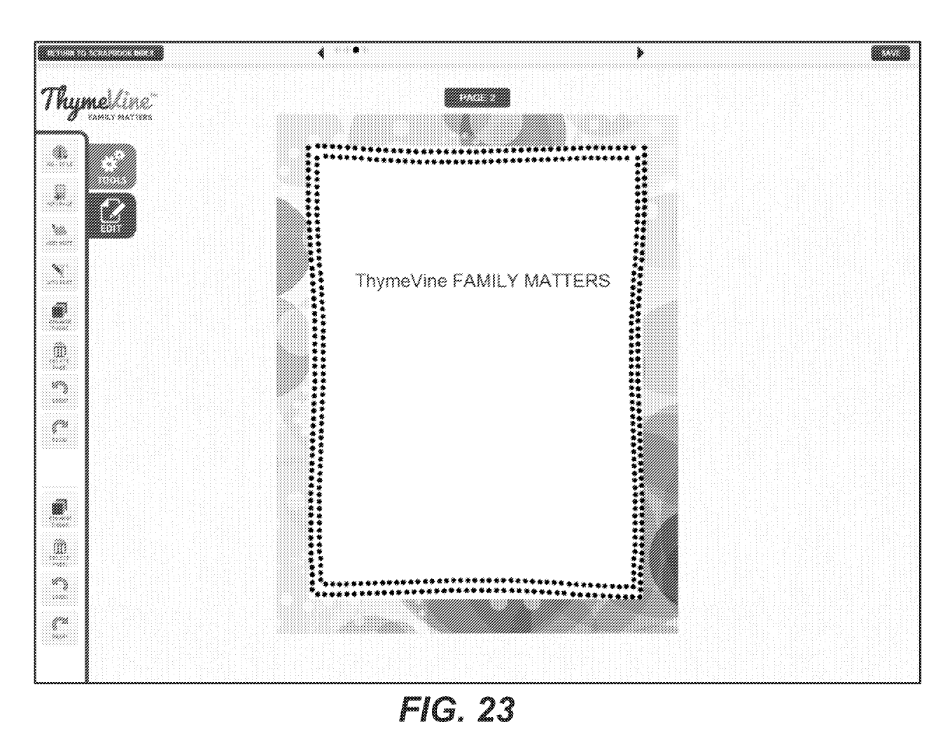

FIG. 23 depicts an exemplary border applied to a page of a scrapbook, in accordance with the principles of the present invention.

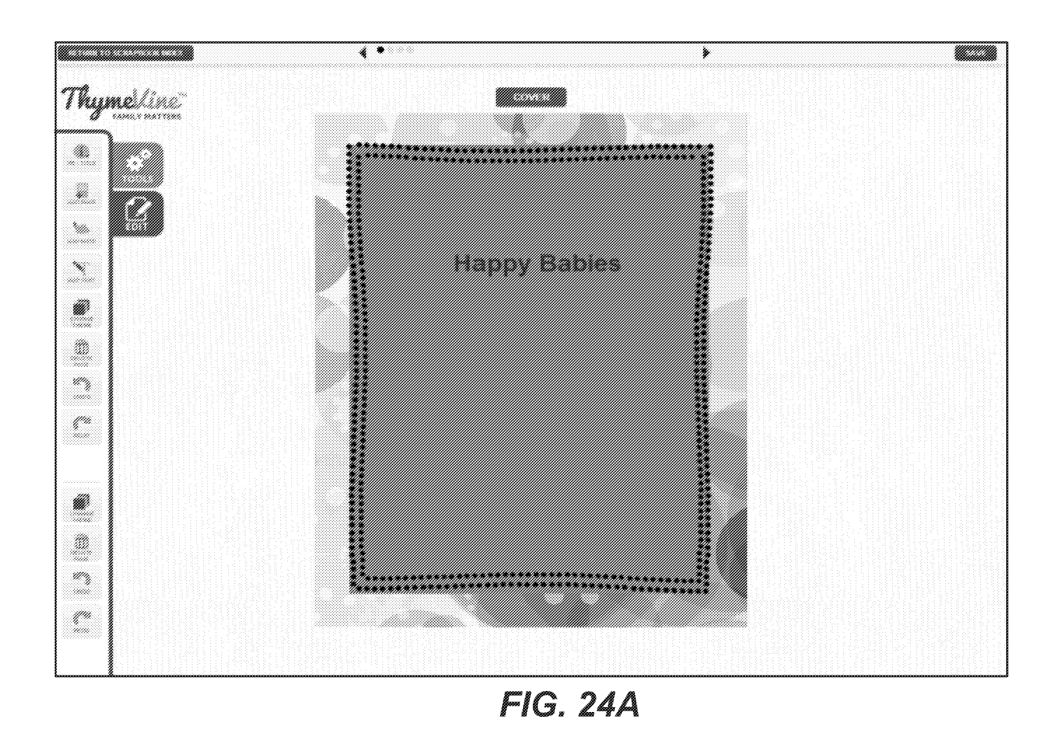

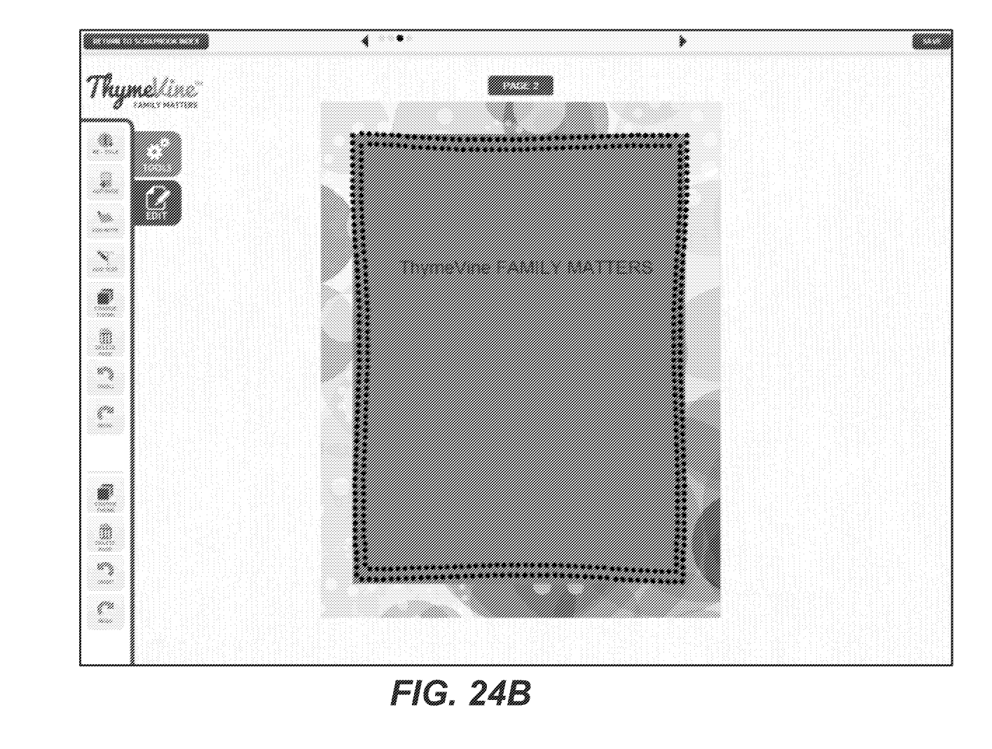

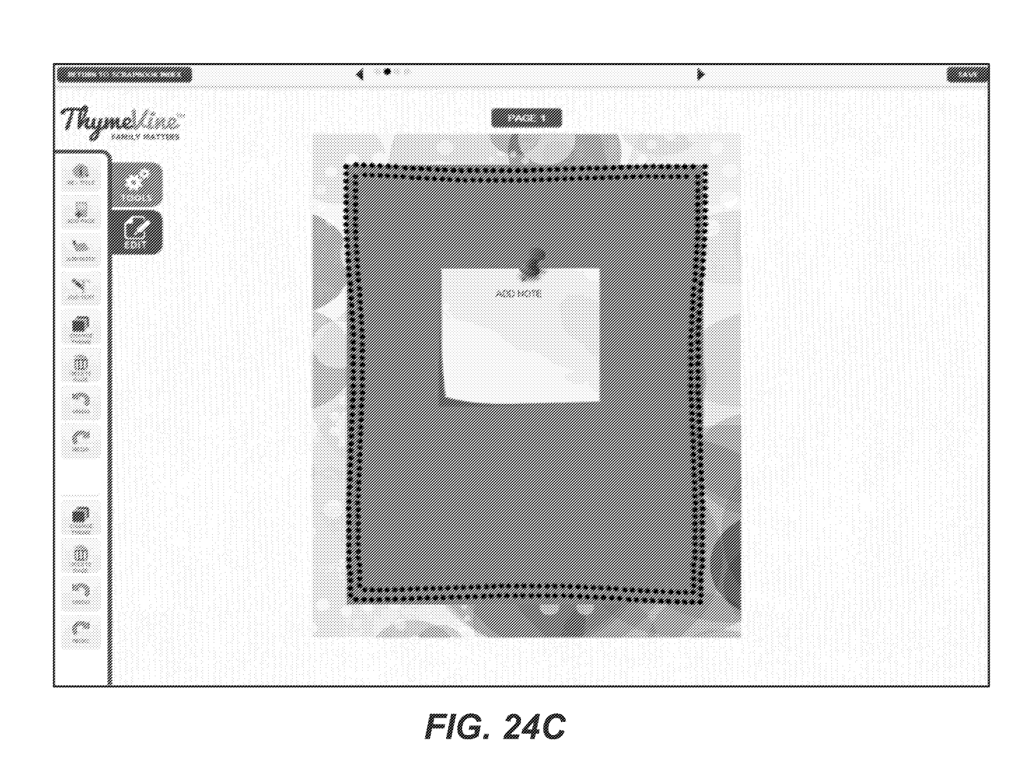

FIGS. 24A to 24C depict an exemplary color applied to an entire scrapbook, in accordance with the principles of the present invention.

The ‘delete page’ button on the edit toolbar can be used to delete or remove a page of a scrapbook.

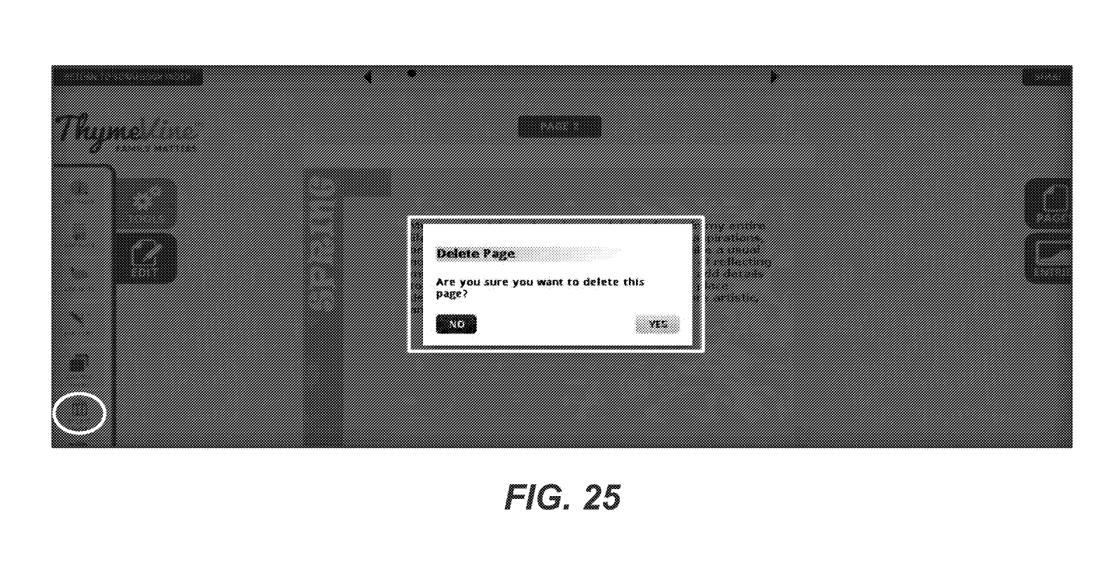

FIG. 25 depicts an exemplary graphical user interface for a deleting page of scrapbooking, in accordance with the principles of the present invention.

In particular, to delete a page of a scrapbook, a user must navigate to a page that they wish to delete, and click the ‘delete page’ tool on the edit toolbar. When the ‘delete page’ tool is selected, a popup message appears on the user device interface, and prompts the user to confirm the page deletion. If the user selects a ‘yes’ button to confirm page deletion, the scrapbook page is deleted.

The ‘undo’ tool on the edit toolbar can be used to reload a previous activity or modification made to a scrapbook page. Likewise, the ‘redo’ tool on the edit toolbar can be used to reload changes made with the ‘undo’ tool (i.e. redo reloads changes on the state from the point when the undo button is clicked). ‘Undo’ and ‘redo’ tools support the following activities: item reposition (including set to front, set to back, and rotate), item resize, item modification of content, item order, and item trash. Alternatively, ‘undo’ and ‘redo’ tools do not support the following activities: change scrapbook theme/color/border, change scrapbook page theme/color/border, page deletion, item drop, and item clone. For system optimization, undo and redo queues are cleared every time a user navigates to a new scrapbook page.

In accordance with the principles of the present invention, a user may click on a ‘tools’ icon on the user device interface to access a customization toolbar. A customization toolbar comprises the following customization tools: ‘gallery’, ‘storythyme’, ‘calendar’, ‘vault’, and ‘clipart’.

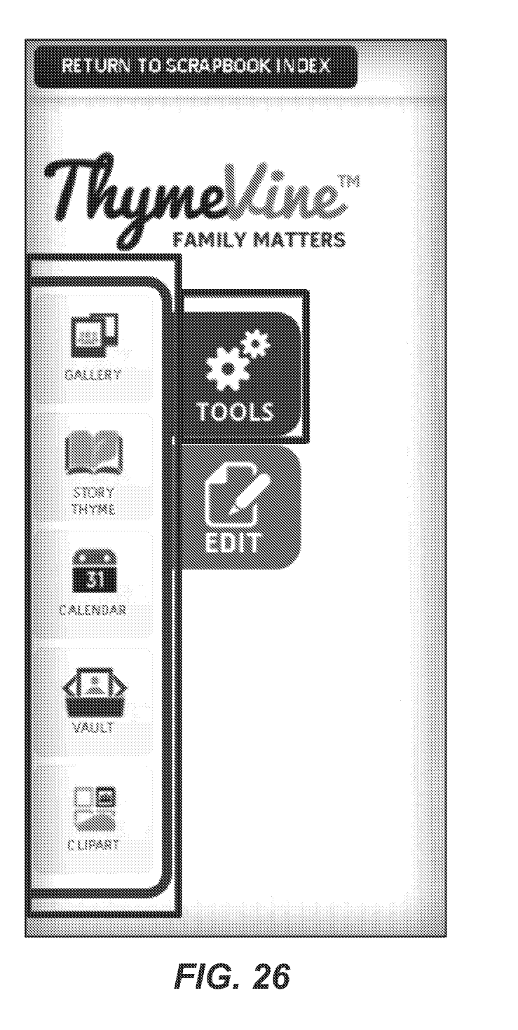

FIG. 26 depicts an exemplary graphical user interface for a customization toolbox for scrapbooking, in accordance with the principles of the present invention.

The ‘gallery’ tool on the customization toolbox can be used to insert gallery images onto a scrapbook page. In particular, a user can load images into an image gallery on the inventive software system, and then access gallery images during scrapbook customization.

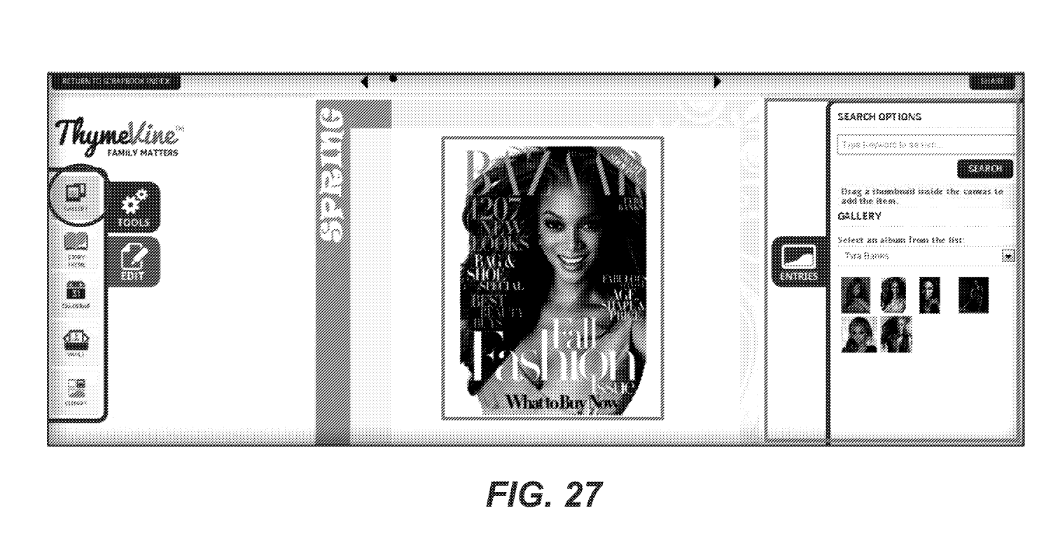

FIG. 27 depicts an exemplary graphical user interface for an add a gallery image feature of scrapbooking, in accordance with the principles of the present invention.

As depicted in Fig. x, to add a stored gallery image to a scrapbook page, a user must click the ‘gallery’ tool on the customization toolbar and select a desired album title from a gallery album dropdown list. Image thumbnails of images stored in a selected gallery album are displayed on the user device interface.

In accordance with the principles of the present invention, a user must drag and drop a desired image thumbnail onto a scrapbook page to insert the full-size image thereon. A user may use a search field to search gallery images by filename, words/tags, and/or description. For example, search term ‘elise’ returns filename ‘elise.jpg’.

The ‘storythyme’ tool on the customization toolbar can be used to insert stored storythyme entries (with title, post date, and content) onto a scrapbook page. In particular, a user may load storythyme entries onto the inventive software system to enable storythyme entries to be accessed and used during scrapbook entry customization.

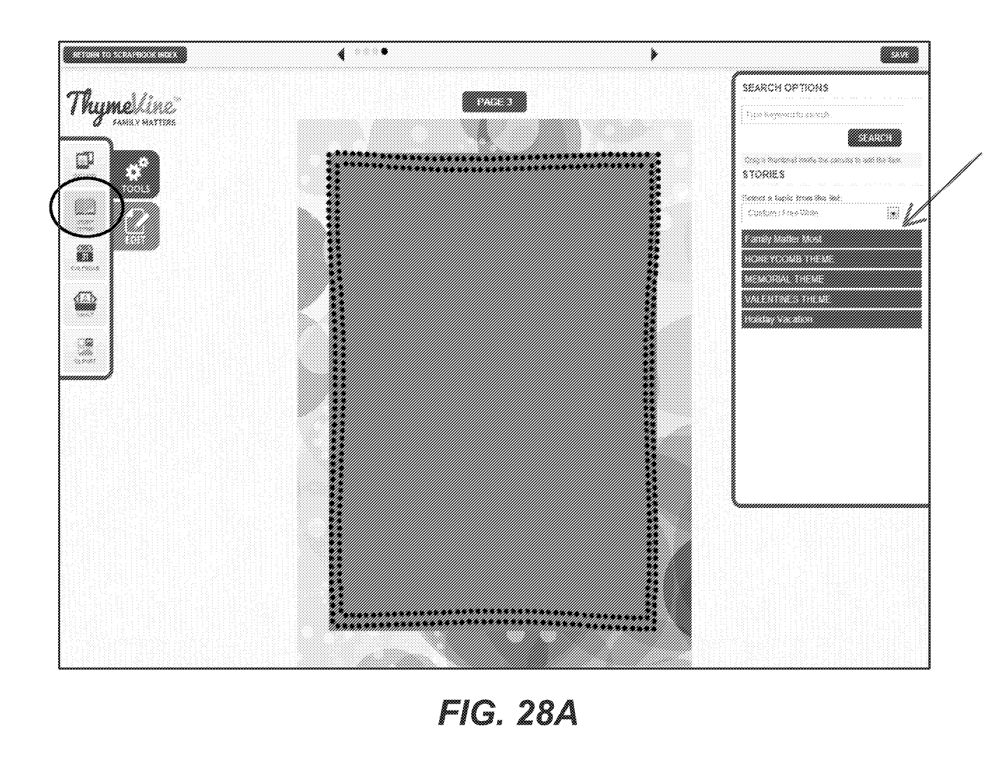

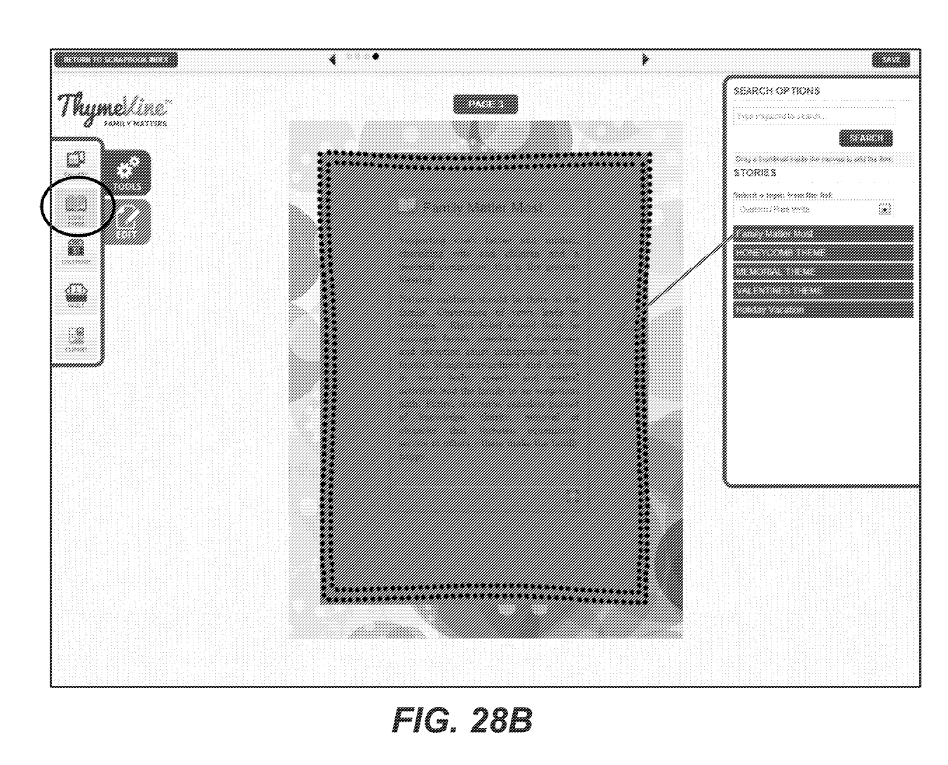

FIGS. 28A and 28B depict an exemplary graphical user interface for an add a storythyme entry feature of scrapbooking, in accordance with the principles of the present invention.

In particular, to add a storythyme entry to a scrapbook page, a user must click the ‘storythyme’ tool on the customization toolbar and select a desired storythyme topic from a storythyme drop down list. Once a storythyme topic is selected, storythyme entries stored under that storythyme topic appear on the user device interface. A user must drag and drop a desired storythyme entry onto the scrapbook page to insert the storythyme entry thereon. A user may search stored storythyme entries by title.

The ‘calendar’ tool on the customization toolbar can be used to insert a calendar icon onto a scrapbook page.

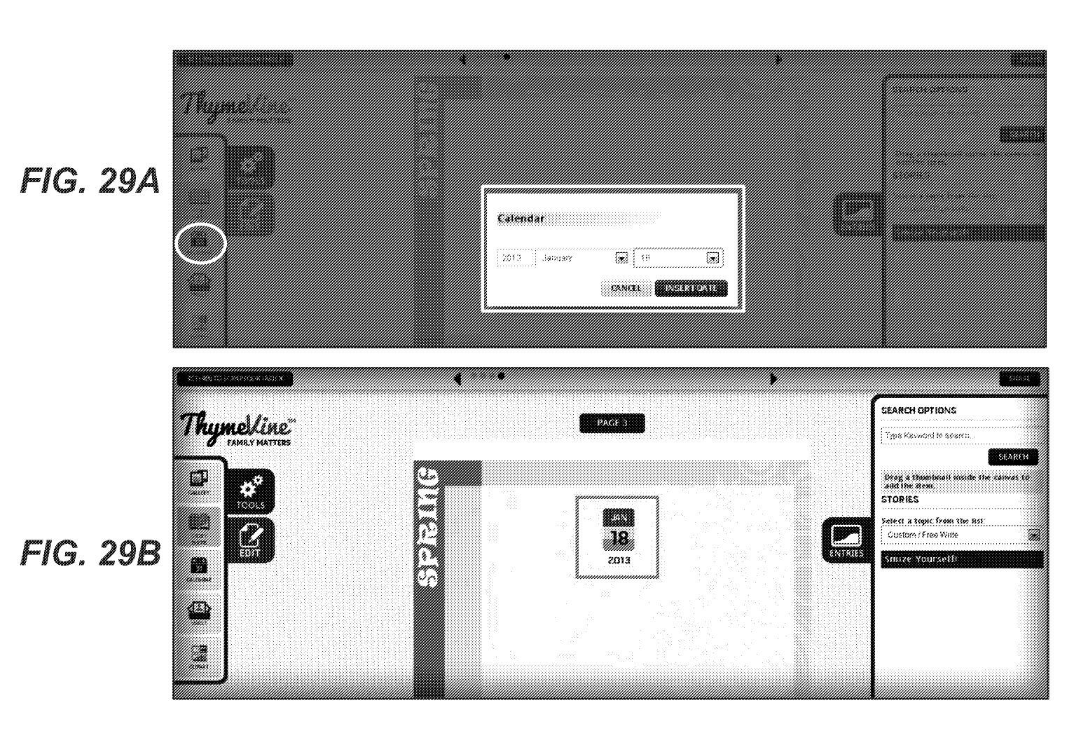

FIGS. 29A and 29B depict an exemplary graphical user interface for an add a calendar icon feature of scrapbooking, in accordance with the principles of the present invention.

In particular, to add a calendar icon to a scrapbook page, a user must select the ‘calendar’ tool from the customization toolbar and enter a year, month and/or day via use of a calendar popup message. The user must then click an ‘insert date’ button on the calendar popup message to insert the calendar icon onto the scrapbook page.

A calendar icon may contain a year only, a year and month, or a year and day.

The ‘vault’ tool on the customization toolbar can be used to insert stored vault images onto a scrapbook page.

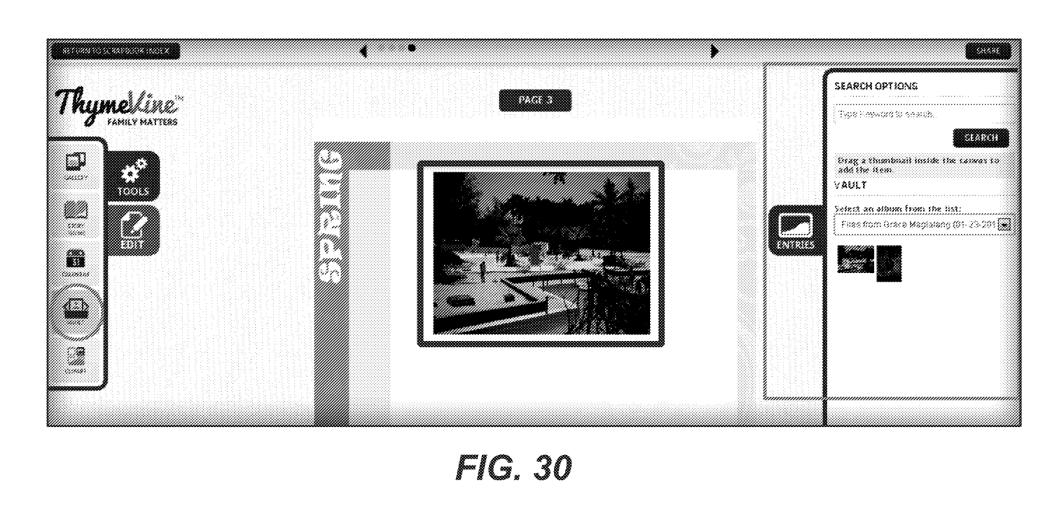

FIG. 30 depicts an exemplary graphical user interface for an add a vault image feature of scrapbooking, in accordance with the principles of the present invention.

In particular, to add a vault image to a scrapbook page, a user must click the ‘vault’ tool on the customization toolbar and select a desired vault album title from an album drop down list. When a vault album is selected, image thumbnails of images stored in that selected vault album appear on the user device interface. The user must drag and drop a desired image thumbnail onto a scrapbook page to insert the full-size vault image thereon. A user can search vault images by filename, words/tags, and/or description.

The ‘clipart’ tool on the customization toolbar can be used to add high quality clipart images to a scrapbook page.

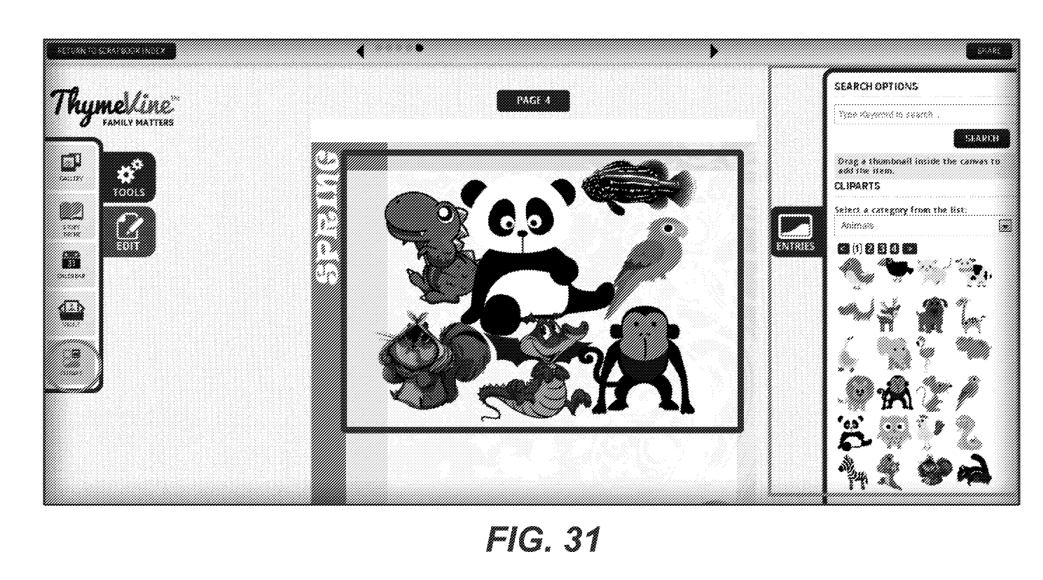

FIG. 31 depicts an exemplary graphical user interface for an add a clipart image feature of scrapbooking, in accordance with the principles of the present invention.

In particular, to add a clipart image to a scrapbook page, a user must click the ‘clipart’ tool on the customization toolbar and select a desired clipart category from a category dropdown list. Once a clipart category is selected, image thumbnails of images stored in the selected clipart category are displayed on the user device interface. A user must drag and drop a clipart image thumbnail onto a scrapbook page to insert the full-size clipart image thereon. A user may search clipart images by filename, words/tags, and or description.

In accordance with the principles of the present invention, the following item edit options appear on the user device interface after double clicking on an image, note, or text item on a scrapbook page: edit, clone, rotate, resize, front, back, and trash.

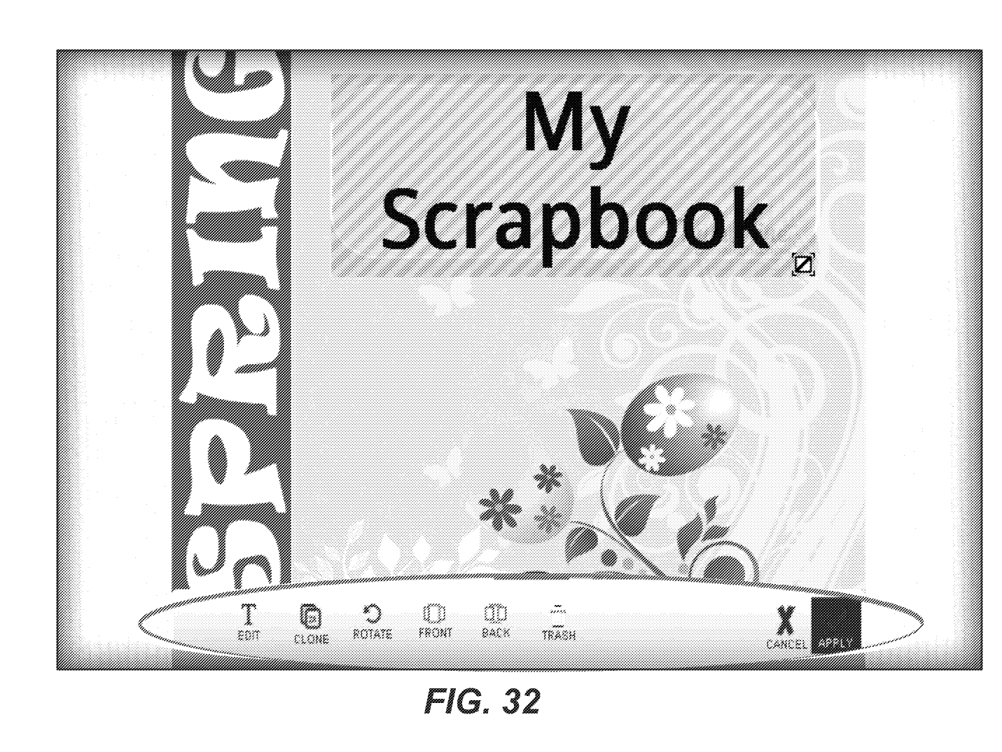

FIG. 32 depicts an exemplary graphical interface for an item edit toolbar, in accordance with the principles of the present invention.

The edit tool on the item edit toolbar can be used to customize text with a font style and/or text color. The clone tool on the edit toolbar can be used to copy a selected item. The rotate tool can be used to rotate a selected item around a fixed point (which can be designated using a slider). The resize tool can be used to resize a selected image or text container. Front and back tools can be used to set an item to the front or back of an overlapping item. The trash tool deletes a selected item from a scrapbook page.

The following item edit tools are available when a text container, a text title, a clipart image, vault image, or a gallery image is selected: edit, clone, rotate, resize, front, back, and trash. The following item edit tools are available when a note is selected: edit, clone, rotate, front, back, and trash. The following item edit tools are available when a storythyme entry is selected: clone, front, back, trash, and view full post. The following item edit tools are available when a calendar item is selected: clone, front, back, and trash.

The inventive scrapbook feature also encompasses an ‘arrange pages’ tool to allow users to preview scrapbook pages and rearrange page order.

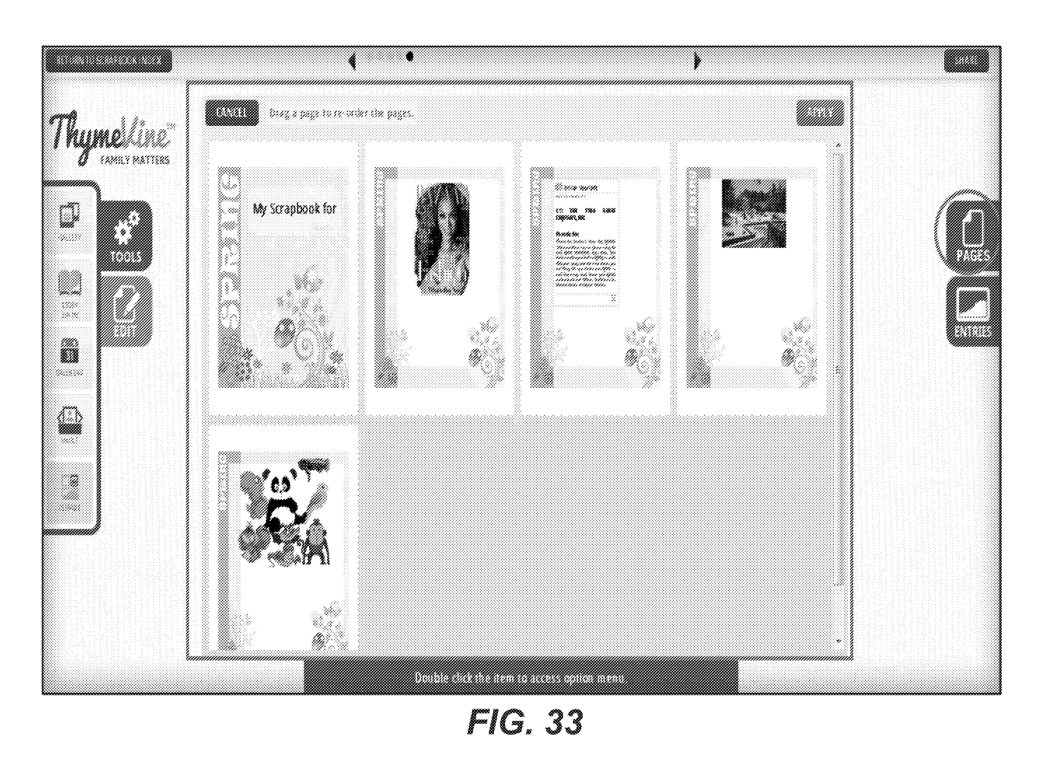

FIG. 33 depicts an exemplary graphical user interface for a preview and arrange feature of scrapbooking, in accordance with the principles of the present invention.

In particular, to rearrange the order of scrapbook pages, a user must select an ‘arrange pages’ tool on the user device interface. When an ‘arrange pages’ tool is selected, all scrapbook pages are displayed on the user device interface, so that a user may drag and drop pages to desired positions. An ‘apply’ button on an arrange pages popup screen must be selected to save changes.

A scrapbook entry is automatically saved every one minute. Thus, to prevent loss of data, a user must wait for the inventive software system to automatically save before leaving a scrapbook page.

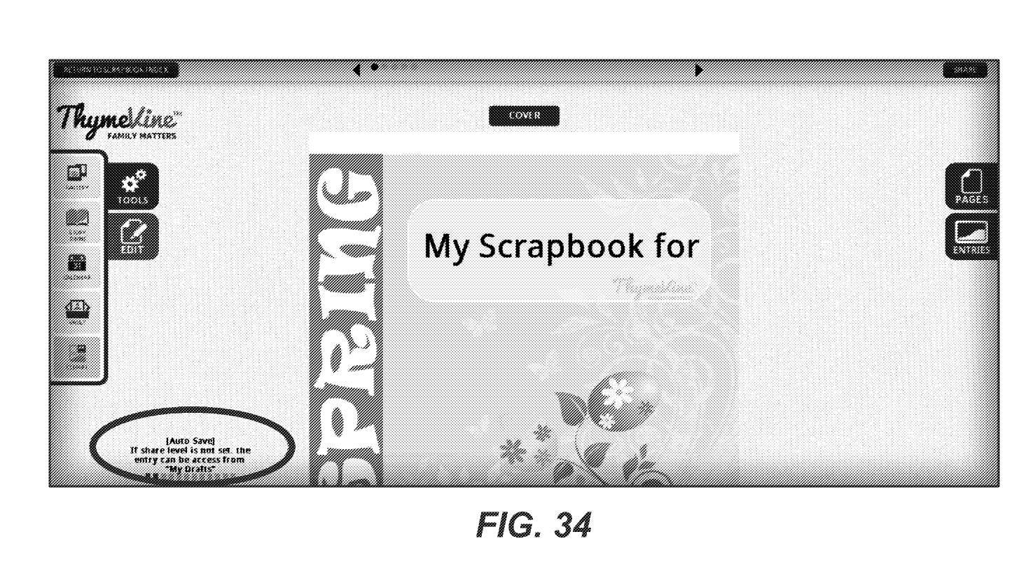

FIG. 34 depicts an exemplary auto-save message displayed on a scrapbook user device interface, in accordance with the principles of the present invention.

Once a scrapbook entry is complete, the final step is to share the entry with connected friends and/or family members. In accordance with the principles of the present invention, a user may automatically share a scrapbook entry with connected family members and/or friends based on a current share setting. A share tool on the inventive software system can be used to set a share setting for a given scrapbook entry or scrapbook post, based on the privacy and sensitivity of content embedded therein.

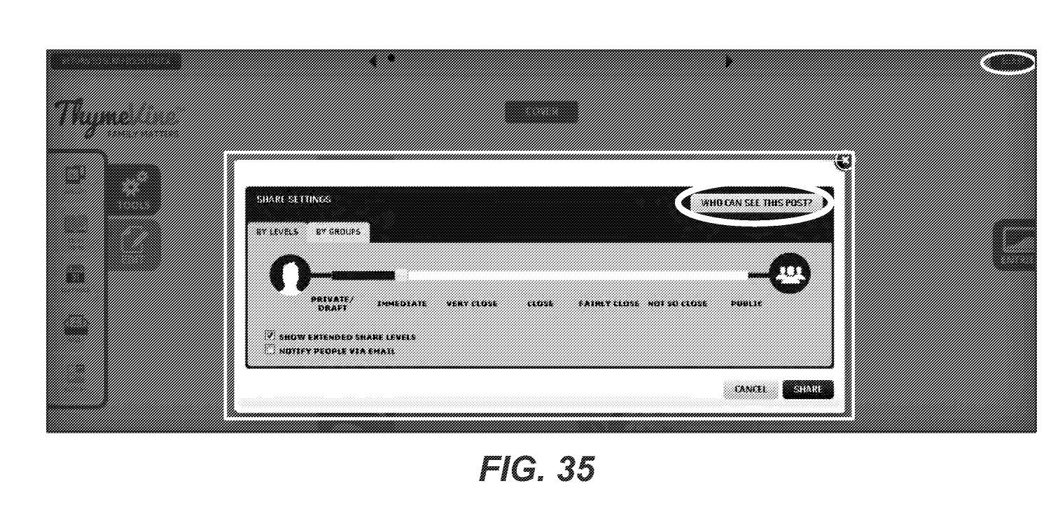

FIG. 35 depicts an exemplary graphical user interface for an assign a share level setting feature of scrapbooking, in accordance with the principles of the present invention.

In particular, to select a share setting for a given scrapbook post or entry, a user must click on a save button on the user device interface and select a desired share setting from a sliding share setting popup menu. A user can tick a ‘show extended share levels’ checkbox to access additional share level options. Possible share level options include: private/draft (i.e. post is only visible to the creator), immediate (i.e. only nuclear/immediate family members and closest friends can view the post), very close (i.e. 1^{st} degree of closeness), close (i.e. 2^{nd} degree of closeness), fairly close (i.e. 3^{rd} degree of closeness), not so close (i.e. 4^{th} degree of closeness), and public (i.e. anyone in the ThymeVine™ network, including non-paying accounts can view the post). Immediate is the default share setting. Family members/friends with an equal or closer share level setting than that assigned to a scrapbook entry/post, are granted permission to view that scrapbook entry/post. Posts set to private are stored as drafts and are only visible to the scrapbook creator.

A user can alternatively select a specific group of members to share a scrapbook entry with. In particular, a user can compile groups of specific family members and/or friends and then search stored member groups by name.

A ‘who can view this post’ button on a share setting popup message may be used to view members that may view a scrapbook post/entry.

When a user is not yet ready to share a scrapbook entry, the user can save the scrapbook as a draft by clicking a ‘save as draft’ button on the user device interface.

In accordance with the principles of the present invention, once a share button on a share settings popup message is selected, a user is prompted to enter an event date (default date is the present date) and an event description (i.e. a description of the scrapbook post/entry) (though these fields are not required). A user then selects a ‘save’ button and the scrapbook entry is posted to recent activity.

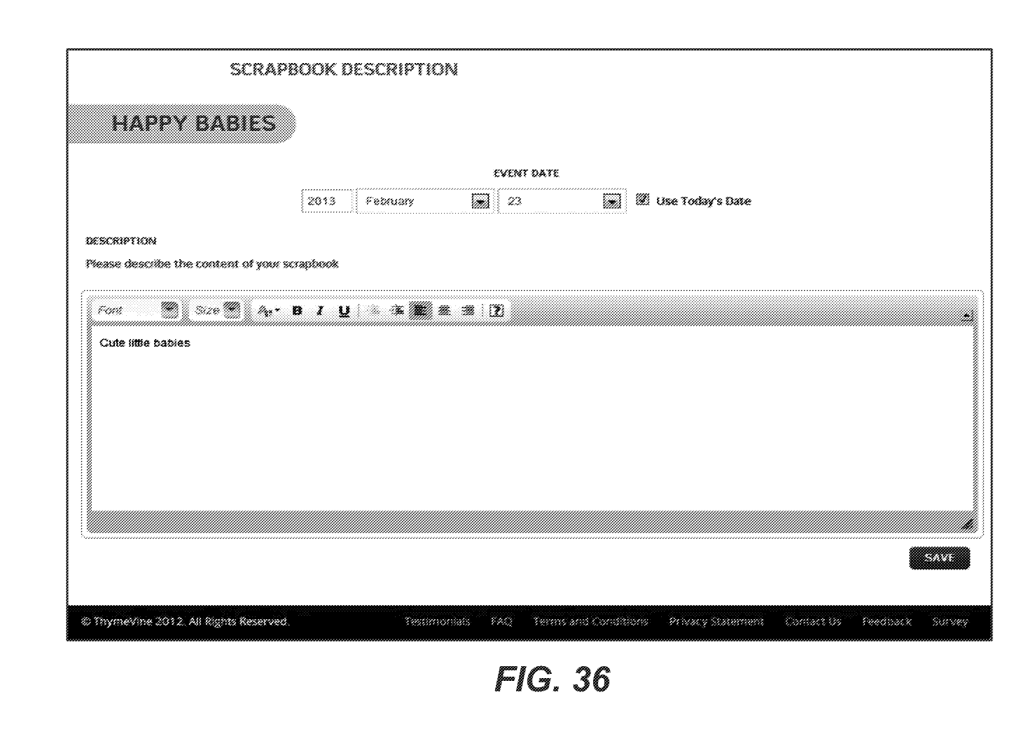

FIG. 36 shows an exemplary graphical user interface for an add a description feature for scrapbooking, in accordance with the principles of the present invention.

Alternatively, if a user selects a ‘cancel’ button on a share setting popup message, a popup message reading, “Do you want to cancel this scrapbook entry?”, is displayed on the user device interface. If the user selects ‘yes’ button to confirm entry deletion, the user device interface is redirected to a scrapbook index page. Alternatively, if the user selects ‘no’ on the confirmation popup message, the popup message is closed.

A user can also select a ‘notify friends via email’ option on a share settings popup message to send a scrapbook entry to connected friends/family members via email.

Once a scrapbook entry has been posted (i.e. shared) a user with permission to access that scrapbook entry can click on the title of the scrapbook entry to view the entire post.

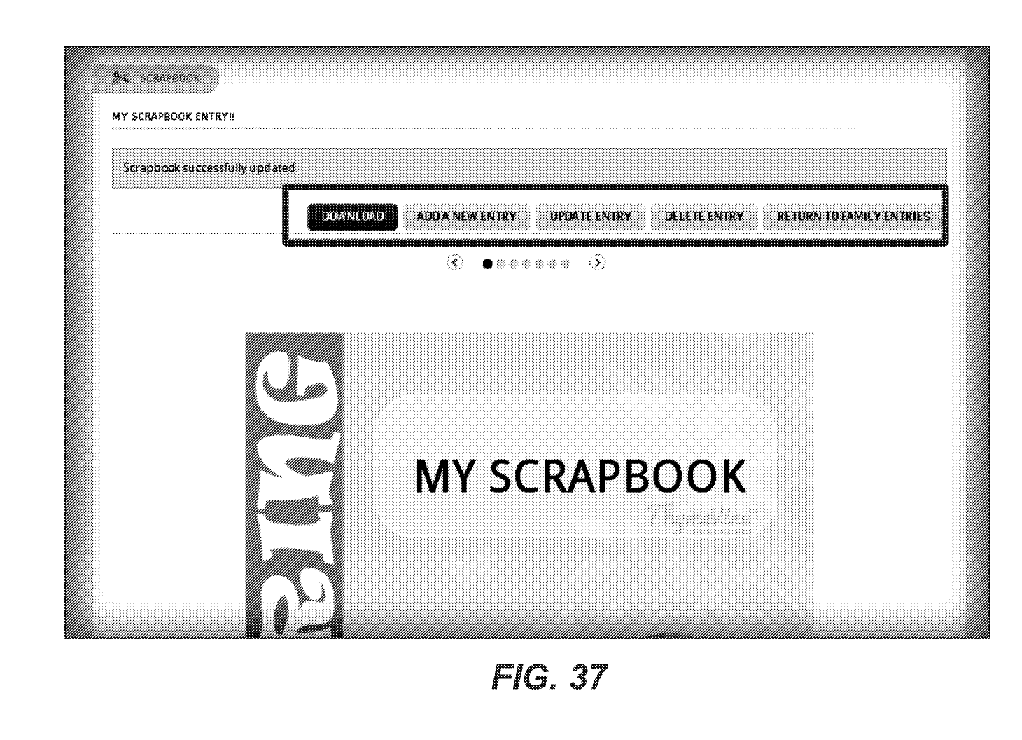

FIG. 37 shows an exemplary graphical user interface for a view full post feature of scrapbooking, in accordance with the principles of the present invention.

Moreover, a scrapbook creator can select a download/print option displayed under a posted scrapbook entry to download and/or print the entire post. A user device can not download/print a scrapbook entry that has been posted by others. The following quick menu options are preferably presented on the user device interface once a scrapbook entry has been posted by a user: ‘add a new entry’, ‘update entry’, ‘delete entry’, and ‘return to family entries’.

A user must have a full subscription to ThymeVine™ to attain full access to the inventive scrapbook feature.

In accordance with the principles of the present invention, a user can search, share, edit, view, delete, and/or update the status (e.g. shared, draft, delete) of a published/draft scrapbook entry from a scrapbook index page. In particular, a user can enter a title of an entry/draft into a search field on a scrapbook index page to search for that particular scrapbook entry/draft.

To update the status of a scrapbook entry/draft, a user can select a scrapbook entry (multiple scrapbook entries can be selected) on a scrapbook index page and then select a share, draft, or delete status from a status dropdown menu. If a user selects a share status, the selected scrapbook entry is posted as recent activity, and the status of the entry is changed to ‘shared’. If a user selects a ‘draft’ status, the selected scrapbook entry is stored as drafts, and the status of the entry is changed to ‘draft’. Alternatively, if a user selects a ‘delete’ status, the selected scrapbook entry is deleted.

Scrapbook entries/drafts can also be viewed or edited from a scrapbook index page. In particular, a user can select a scrapbook draft/entry and then click a ‘view’ option to view the entire entry/draft. Moreover, a user can select a scrapbook draft/entry and then click an ‘edit’ option to view the entire draft/entry and edit options.

In accordance with the principles of the present invention, shared scrapbook entries may be sorted by: post date (i.e. entries are sorted based on latest post date), event date (i.e. entries are sorted based on latest event date), scrapbook entries posted by you (i.e. page is redirected to users' personal shared entries), or scrapbook entries posted by others (i.e. page is redirected to a list of entries posted by others). Options for a shared scrapbook entry listed on a scrapbook index page include: edit, print, leave a comment, and view full post.

To leave a comment on a shared scrapbook entry, a user enters text into a comment text field displayed under the shared scrapbook entry, and then clicks a ‘comment’ button. A comment is subsequently posted under the shared scrapbook entry. A user can edit or delete any comments they have posted.

Other options for shared scrapbook entries include: view full post (page is redirected to a full post of the entry), share this on Facebook™ (i.e. scrapbook entry is posted on the users' Facebook™ account), and share this on Twitter™ (i.e. scrapbook entry is posted on the users' Twitter™ account). A ‘return to scrapbook index’ button redirects a user to the scrapbook index page.

The table below shows the definition and functionality of each scrapbook feature.

While the invention has been described with reference to the exemplary embodiments thereof, those skilled in the art will be able to make various modifications to the described embodiments of the invention without departing from the true spirit and scope of the invention.

What is claimed is:

1. A method of implementing a scrapbook social network, comprising:
accepting a closeness rating assigned via a posting device for each of a plurality of social network user devices to which said posting device has a pre-defined relationship;
accepting a scrapbook post from said posting device;
accepting an assigned share level setting with said post;
sharing said scrapbook post from said posting device with only those of said plurality of social network user devices that have a closeness rating at or above said assigned share level.

2. The method of implementing a scrapbook social network according to claim 1, wherein:
said posting device can collaborate to create a scrapbook entry with those of said plurality of social network user devices that have a closeness rating at or above said assigned share level.

3. The method of implementing a scrapbook social network according to claim 1, wherein:
said scrapbook is a digital scrapbook for documenting cherished family moments and significant life events.

4. The method of implementing a scrapbook social network according to claim 1, wherein:
said scrapbook post can be shared instantaneously over a shared network connection with those of said plurality of social network user devices that have a closeness rating at or above said assigned share level.

5. The method of implementing a scrapbook social network according to claim 1, wherein:
those of said plurality of social network user devices that have a closeness rating at or above said share level can contribute independently and simultaneously to a scrapbook entry.

6. The method of implementing a scrapbook social network according to claim 1, wherein:
said share level setting is assigned to said scrapbook post based on the sensitivity and privacy of content in said post.

7. The method of implementing a scrapbook social network according to claim 1, wherein:
said posting device can assign a share group to a scrapbook post wherein only said social network user devices defined in said share group can access said scrapbook post irrespective of closeness rating.

8. The method of implementing a scrapbook social network according to claim 1, wherein:
said share level is any one of six possible discrete share levels.

9. The method of implementing a scrapbook social network according to claim 8, wherein said six possible discrete share levels comprise:
immediate representing an immediate relationship between said posting device and a respective social network user device;
very close representing a very close relationship between said posting device and a respective social network user device;
close representing a close relationship between said posting device and a respective social network user device;
fairly close representing a fairly close relationship between said posting device and a respective social network user device;
not so close representing a not-so-close relationship between said posting device and a respective social network user device; and
public.

10. The method of implementing a social scrapbook network according to claim 1, wherein said share level comprises:
an integer.

11. The method of implementing a social scrapbook network according to claim 1, wherein:
there are a virtually infinite number of share levels between immediate and public which may be defined by said posting device for any given scrapbook post.

12. The method of implementing a scrapbook social network according to claim 11, wherein said share level comprises:
a fractional real number.

13. The method of implementing a social scrapbook network according to claim 1, wherein said scrapbook post comprises:
a photo.

14. The method of implementing a social scrapbook network according to claim 1, wherein said scrapbook post comprises:
a video.

15. The method of implementing a social scrapbook network according to claim 1, wherein said scrapbook post comprises:
a document.

16. The method of implementing a scrapbook social network according to claim 1, wherein:
said closeness rating of any of said plurality of social network user devices can be changed at any time by said posting user device.

17. The method of implementing a scrapbook social network according to claim 1, wherein:
said scrapbook can be printed to hard copy only by said plurality of social network user devices having a suitable closeness rating that permits hardcopy printing.

18. The method of implementing a scrapbook social network according to claim 1, wherein:
said scrapbook can be copied only by said plurality of social network user devices having a suitable closeness rating.

19. The method of implementing a scrapbook social network according to claim 1, wherein:
said closeness rating assigned by said posting device to said plurality of social network user devices is not disclosed to said plurality of social network devices.

20. A scrapbook social network, comprising:
means for accepting a closeness rating assigned via said posting device for each of a plurality of social network user devices to which said posting device has a pre-defined relationship;
means for accepting a scrapbook post from said posting device;
means for accepting an assigned share level with said scrapbook post;
means for sharing said scrapbook post from said posting device with only those of said plurality of social network user devices that have a closeness rating at or above said assigned share level; and
means for allowing said posting device and said plurality of those of said social network user devices that have a closeness rating at or above said assigned share level to simultaneously collaborate on a scrapbook entry.
